(19) United States
(12) Patent Application Publication
(10) Pub. No.: US 2026/0322219 A1
(43) Pub. Date: Oct. 15, 2026

(54) ELECTRICAL ENERGY-MECHANICAL ENERGY CONVERTER

(71) Applicant: ELEMEC Co., Ltd., Kawasaki-shi (JP)

(72) Inventor: Yuta MIZUTANI, Kawasaki-shi (JP)

(21) Appl. No.: 19/464,604

(22) Filed: Jan. 30, 2026

Related U.S. Application Data
(63) Continuation of application No. PCT/JP2024/020498, filed on Jun. 5, 2024.

(30) Foreign Application Priority Data
Aug. 2, 2023 (JP) 2023-126263

(51) Int. Cl. H02K 9/193; H02K 9/22

(52) U.S. Cl. CPC H02K 9/193; H02K 9/225

(57) ABSTRACT

Provided with a stator core 20 having a plurality of teeth protruded from a base portion; U-phase conductive tubes 111, 112, —and V-phase conductive tubes 121, 122, —and W-phase conductive tubes 131, 132, —which are arranged in a space between the plurality of teeth; one heat medium flow member 310 arranged on one side of the stator core 20 for preventing the heat medium flowing through the U-phase conductive tubes 111, 112, —and the V-phase conductive tubes 121, 122, —and W-phase conductive tubes 131, 132, —from leaking to the outside; and the other heat medium flow member 320 arranged on the other side of the stator core 20 for preventing the heat medium flowing through the U-phase conductive tubes 111, 112, —and the V-phase conductive tubes 121, 122, —and the W-phase conductive tubes 131, 132, —from leaking to the outside.

### CROSS-REFERENCE TO RELATED APPLICATIONS

This Application claims the benefit of priority and is a Continuation application of the prior International Patent Application No. PCT/JP2024/020498, with an international filing date of Jun. 5, 2024, which designated the United States, and is related to the Japanese Patent Application No. 2023-126263, filed Aug. 2, 2023, the entire disclosures of all applications are expressly incorporated by reference in their entirety herein.

### TECHNICAL FIELD

The present invention relates to a converter that converts electrical energy into mechanical energy or mechanical energy into electrical energy.

### BACKGROUND OF THE INVENTION

As a converter that converts electrical energy into mechanical energy or mechanical energy into electrical energy, there are a rotating electrical machine that functions as an electric motor or a generator, a linear motor and the like. In the above described converter, it is important to suppress temperature rise.

Japanese Patent Application Publication No. 2004-135386 discloses an electric machine that suppresses temperature rise by forming a stator coil by folding back a hollow conductor midway to double the hollow conductor and winding the hollow conductor around a stator core, and flowing heat medium through the hollow conductor.

### SUMMARY OF THE INVENTION

However, the conventional electric machine described above requires the hollow conductor to be wound into a coil shape. Thus, the productivity is poor.

The present invention is made in view of the conventional problem described above. An object of the present invention is to provide an electrical energy-mechanical energy converter that has high cooling performance, high output, is compact and lightweight and has excellent productivity.

The present invention solves the above described problem by the following means. The reference numerals corresponding to embodiments of the present invention are shown in parentheses for facilitating the understanding. However, the present invention is not limited thereto. The configurations described with the reference numerals may be appropriately replaced or improved.

One aspect is an electrical energy-mechanical energy converter including:
a stator core (20) having a plurality of teeth protruded from a base portion;
a first U-phase conductive tube (111) that is electrically conductive so that a heat medium can flow through the first U-phase conductive tube (111), the first U-phase conductive tube (111) being arranged in a space between the plurality of teeth and being longer than a thickness of the stator core (20) and protruding on both sides of the stator core (20);
a second U-phase conductive tube (112) that is electrically conductive so that the heat medium can flow through the second U-phase conductive tube (112), the second U-phase conductive tube (112) being arranged in the space between the plurality of teeth and being longer than the thickness of the stator core (20) and protruding on the both sides of the stator core (20);
a U-phase line (11) that is electrically conductive and is connected to one end side of the first U-phase conductive tube (111) protruding from the stator core (20);
a U-phase connector (210) that is electrically conductive and is connected to the other end side of the first U-phase conductive tube (111) protruding from the stator core (20) and to the other end side of the second U-phase conductive tube (112) protruding from the stator core (20);
a first V-phase conductive tube (121) that is electrically conductive so that the heat medium can flow through the first V-phase conductive tube (121), the first V-phase conductive tube (121) being arranged in the space between the plurality of teeth and being longer than the thickness of the stator core (20) and protruding on the both sides of the stator core (20);
a second V-phase conductive tube (122) that is electrically conductive so that the heat medium can flow through the second V-phase conductive tube (122), the second V-phase conductive tube (122) being arranged in the space between the plurality of teeth and being longer than the thickness of the stator core (20) and protruding on the both sides of the stator core (20);
a V-phase line (12) that is electrically conductive and is connected to one end side of the first V-phase conductive tube (121) protruding from the stator core (20);
a V-phase connector (220) that is electrically conductive and is connected to the other end side of the first V-phase conductive tube (121) protruding from the stator core (20) and to the other end side of the second V-phase conductive tube (122) protruding from the stator core (20);
a first W-phase conductive tube (131) that is electrically conductive so that the heat medium can flow through the first W-phase conductive tube (131), the first W-phase conductive tube (131) being arranged in the space between the plurality of teeth and being longer than the thickness of the stator core (20) and protruding on both sides of the stator core (20);
a second W-phase conductive tube (132) that is electrically conductive so that the heat medium can flow through the second W-phase conductive tube (132), the second W-phase conductive tube (132) being arranged in the space between the plurality of teeth and being longer than the thickness of the stator core (20) and protruding on both sides of the stator core (20);
a W-phase line (13) that is electrically conductive and is connected to one end side of the first W-phase conductive tube (131) protruding from the stator core (20);
a W-phase connector (230) that is electrically conductive and is connected to the other end side of the first W-phase conductive tube (131) protruding from the stator core (20) and to the other end side of the second W-phase conductive tube (132) protruding from the stator core (20);
a neutral line (240) that is electrically conductive and is connected to one end side of the second U-phase conductive tube (112) protruding from the stator core (20), one end side of the second V-phase conductive tube (122) and one end side of the second W-phase conductive tube (132);
one heat medium flow member (310) that is arranged on one side of the stator core (20) so that the heat medium can flow inside the one heat medium flow member (310) while preventing the heat medium flowing through the first U-phase conductive tube (111), the second U-phase conductive tube (112), the first V-phase conductive tube (121), the second V-phase conductive tube (122), the first W-phase conductive tube (131) and the second W-phase conductive tube (132) from leaking to the outside from locations contacting the stator core (20); and
the other heat medium flow member (320) that is arranged on the other side of the stator core (20) so that the heat medium can flow inside the other heat medium flow member (320) while preventing the heat medium flowing through the first U-phase conductive tube (111), the second U-phase conductive tube (112), the first V-phase conductive tube (121), the second V-phase conductive tube (122), the first W-phase conductive tube (131), and the second W-phase conductive tube (132) from leaking to the outside from the locations contacting the stator core (20).

Another aspect is an electrical energy-mechanical energy converter including:
a stator core (20);
a first U-phase conductive tube (111) that is electrically conductive so that a heat medium can flow through the first U-phase conductive tube (111), the first U-phase conductive tube (111) being arranged in the stator core (20) and being longer than a thickness of the stator core (20) and protruding on both sides of the stator core (20);
a second U-phase conductive tube (112) that is electrically conductive so that the heat medium can flow through the second U-phase conductive tube (112), the second U-phase conductive tube (112) being arranged in the space between the plurality of teeth and being longer than the thickness of the stator core (20) and protruding on the both sides of the stator core (20);
a U-phase line (11) that is electrically conductive and is connected to one end side of the first U-phase conductive tube (111) protruding from the stator core (20);
a U-phase connector (210) that is electrically conductive and is connected to the other end side of the first U-phase conductive tube (111) protruding from the stator core (20) and to the other end side of the second U-phase conductive tube (112) protruding from the stator core (20);
a first V-phase conductive tube (121) that is electrically conductive so that the heat medium can flow through the first V-phase conductive tube (121), the first V-phase conductive tube (121) being arranged in the stator core (20) and being longer than the thickness of the stator core (20) and protruding on the both sides of the stator core (20);
a second V-phase conductive tube (122) that is electrically conductive so that the heat medium can flow through the second V-phase conductive tube (122), the second V-phase conductive tube (122) being arranged in the stator core (20) and being longer than the thickness of the stator core (20) and protruding on the both sides of the stator core (20);
a V-phase line (12) that is electrically conductive and is connected to one end side of the first V-phase conductive tube (121) protruding from the stator core (20);
a V-phase connector (220) that is electrically conductive and is connected to the other end side of the first V-phase conductive tube (121) protruding from the stator core (20) and to the other end side of the second V-phase conductive tube (122) protruding from the stator core (20);
a first W-phase conductive tube (131) that is electrically conductive so that the heat medium can flow through the first W-phase conductive tube (131), the first W-phase conductive tube (131) being arranged in the stator core (20) and being longer than the thickness of the stator core (20) and protruding on both sides of the stator core (20);
a second W-phase conductive tube (132) that is electrically conductive so that the heat medium can flow through the second W-phase conductive tube (132), the second W-phase conductive tube (132) being arranged in the stator core (20) and being longer than the thickness of the stator core (20) and protruding on both sides of the stator core (20);
a W-phase line (13) that is electrically conductive and is connected to one end side of the first W-phase conductive tube (131) protruding from the stator core (20);
a W-phase connector (230) that is electrically conductive and is connected to the other end side of the first W-phase conductive tube (131) protruding from the stator core (20) and to the other end side of the second W-phase conductive tube (132) protruding from the stator core (20);
a neutral line (240) that is electrically conductive and is connected to one end side of the second U-phase conductive tube (112), one end side of the second V-phase conductive tube (122) and one end side of the second W-phase conductive tube (132) protruding from the stator core (20);
one heat medium flow member (310) that is arranged on one end side of the stator core (20) so that the heat medium can flow inside the one heat medium flow member (310) while preventing the heat medium flowing through the first U-phase conductive tube (111), the second U-phase conductive tube (112), the first V-phase conductive tube (121), the second V-phase conductive tube (122), the first W-phase conductive tube (131) and the second W-phase conductive tube (132) from leaking to the outside from locations contacting the stator core (20); and
the other heat medium flow member (320) that is arranged on the other side of the stator core (20) so that the heat medium can flow inside the other heat medium flow member (320) while preventing the heat medium flowing through the first U-phase conductive tube (111), the second U-phase conductive tube (112), the first V-phase conductive tube (121), the second V-phase conductive tube (122), the first W-phase conductive tube (131), and the second W-phase conductive tube (132) from leaking to the outside from the locations contacting the stator core (20).

Another aspect is an electrical energy-mechanical energy converter including:
a stator core (20) having a plurality of teeth protruded from a base portion;
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in a space between the plurality of teeth and being longer than a thickness of the stator core (20) and protruding on both sides of the stator core (20);
a plurality of U-phase connectors (211, 2121, 2122) that is electrically conductive and is connected between one end sides of the plurality of U-phase conductive tubes (111, 112, . . . ) protruding from the stator core (20) or between other end sides of the plurality of U-phase conductive tubes (111, 112, . . . );
a U-phase line (11) that is electrically conductive and is connected to one end side of one of the plurality of U-phase conductive tubes (111, 112, . . . ) to which the plurality of U-phase connectors is not connected at one end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in a plurality of spaces between the plurality of teeth and being longer than the thickness of the stator core (20) and protruding on both sides of the stator core (20);
a plurality of V-phase connectors (221, 2221, 2222) that is electrically conductive and is connected between one end sides of the plurality of V-phase conductive tubes (121, 122, . . . ) protruding from the stator core (20) or between other end sides of the plurality of V-phase conductive tubes (121, 122, . . . );
a V-phase line (12) that is electrically conductive and is connected to one end side of one of the plurality of V-phase conductive tubes (121, 122, . . . ) to which the plurality of V-phase connectors is not connected at one end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the plurality of spaces between the plurality of teeth and being longer than the thickness of the stator core (20) and protruding on both sides of the stator core (20);
a plurality of W-phase connectors (231, 2321, 2322) that is electrically conductive and is connected between one end sides of the plurality of W-phase conductive tubes (131, 132, . . . ) protruding from the stator core (20) or between other end sides of the plurality of W-phase conductive tubes (131, 132, . . . );
a W-phase line (13) that is electrically conductive and is connected to one end side of one of the plurality of W-phase conductive tubes (131, 132, . . . ) to which the plurality of W-phase connectors is not connected at one end side;
a neutral line (240) that is electrically conductive and is connected to one end side of the plurality of U-phase conductive tubes (111,112,. . . ) to which neither the plurality of U-phase connectors nor the plurality of U-phase lines (11) is connected at one end side, one end side of the plurality of V-phase conductive tubes (121, 122, . . . ) to which neither the plurality of V-phase connectors nor the plurality of V-phase lines (12) is connected at one end side and one end side of the plurality of W-phase conductive tubes (131, 132, . . . ) to which neither the plurality of W-phase connectors nor the plurality of W-phase lines (13) is connected at one end side;
one heat medium flow member (310) arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from locations contacting the stator core (20); and
the other heat medium flow member (320) arranged on the other side of the stator core (20) so that the heat medium can flow inside the other heat medium flow member (320) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from the locations contacting the stator core (20).

Another aspect is an electrical energy-mechanical energy converter including:
a stator core (20) having a plurality of teeth protruded from a base portion;
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in a space between the plurality of teeth and being longer than a thickness of the stator core (20) and protruding on both sides of the stator core (20);
a plurality of U-phase connectors (211, 2121, 2122) that is electrically conductive and is connected between one end sides of the plurality of U-phase conductive tubes (111, 112, . . . ) protruding from the stator core (20) or between other end sides of the plurality of U-phase conductive tubes (111, 112, . . . );
a U-phase line (11) that is electrically conductive and is connected to one end side of one of the plurality of U-phase conductive tubes (111, 112, . . . ) to which the plurality of U-phase connectors is connected at both one end side and the other end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in a plurality of spaces between the plurality of teeth and being longer than the thickness of the stator core (20) and protruding on both sides of the stator core (20);
a plurality of V-phase connectors (221, 2221, 2222) that is electrically conductive and is connected between one end sides of the plurality of V-phase conductive tubes (121, 122, . . . ) protruding from the stator core (20) or between other end sides of the plurality of V-phase conductive tubes (121, 122, . . . );
a V-phase line (12) that is electrically conductive and is connected to one end side of one of the plurality of V-phase conductive tubes (121, 122, . . . ) to which the plurality of V-phase connectors is connected at both one end side and the other end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the plurality of spaces between the plurality of teeth and being longer than the thickness of the stator core (20) and protruding on both sides of the stator core (20);
a plurality of W-phase connectors (231, 2321, 2322) that is electrically conductive and is connected between one end sides of the plurality of W-phase conductive tubes (131, 132, . . . ) protruding from the stator core (20) or between other end sides of the plurality of W-phase conductive tubes (131, 132, . . . );
a W-phase line (13) that is electrically conductive and is connected to one end side of one of the plurality of W-phase conductive tubes (131, 132, . . . ) to which the plurality of W-phase connectors is connected at both one end side and the other end side;
a neutral line (240) that is electrically conductive and is connected to one end side of the plurality of U-phase conductive tubes (111, 112, . . . ) to which the plurality of U-phase connectors is connected only at the other end side, one end side of the plurality of V-phase conductive tubes (121, 122, . . . ) to which the plurality of V-phase connectors is connected only at the other end side and one end side of the plurality of W-phase conductive tubes (131, 132, . . . ) to which the W-phase connector is connected only at the other end side;
one heat medium flow member (310) arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from locations contacting the stator core (20); and
the other heat medium flow member (320) arranged on the other side of the stator core (20) so that the heat medium can flow inside the other heat medium flow member (320) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from the locations contacting the stator core (20).

Another aspect is an electrical energy-mechanical energy converter including:
a stator core (20);
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in the stator core (20) and being longer than a thickness of the stator core (20) and protruding on both sides of the stator core (20);
a plurality of U-phase connectors (211, 2121, 2122) that is electrically conductive and is connected between one end sides of the plurality of U-phase conductive tubes (111, 112, . . . ) protruding from the stator core (20) or between other end sides of the plurality of U-phase conductive tubes (111, 112, . . . );
a U-phase line (11) that is electrically conductive and is connected to one end side of one of the plurality of U-phase conductive tubes (111, 112, . . . ) to which the plurality of U-phase connectors is not connected at one end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the stator core (20) and being longer than the thickness of the stator core (20) and protruding on both sides of the stator core (20);
a plurality of V-phase connectors (221, 2221, 2222) that is electrically conductive and is connected between one end sides of the plurality of V-phase conductive tubes (121, 122, . . . ) protruding from the stator core (20) or between other end sides of the plurality of V-phase conductive tubes (121, 122, . . . );
a V-phase line (12) that is electrically conductive and is connected to one end side of one of the plurality of V-phase conductive tubes (121, 122, . . . ) to which the plurality of V-phase connectors is not connected at one end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the stator core (20) and being longer than the thickness of the stator core (20) and protruding on both sides of the stator core (20);
a plurality of W-phase connectors (231, 2321, 2322) that is electrically conductive and is connected between one end sides of the plurality of W-phase conductive tubes (131, 132, . . . ) protruding from the stator core (20) or between other end sides of the plurality of W-phase conductive tubes (131, 132, . . . );
a W-phase line (13) that is electrically conductive and is connected to one end side of one of the plurality of W-phase conductive tubes (131, 132, . . . ) to which the plurality of W-phase connectors is not connected at one end side;
a neutral line (240) that is electrically conductive and is connected to one end side of the plurality of U-phase conductive tubes (111,112, . . . ) to which neither the plurality of U-phase connectors nor the plurality of U-phase lines (11) is connected at one end side, one end side of the plurality of V-phase conductive tubes (121, 122, . . . ) to which neither the plurality of V-phase connectors nor the plurality of V-phase lines (12) is connected at one end side and one end side of the plurality of W-phase conductive tubes (131, 132, . . . ) to which neither the plurality of W-phase connectors nor the plurality of W-phase lines (13) is connected at one end side;
one heat medium flow member (310) arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from locations contacting the stator core (20); and
the other heat medium flow member (320) arranged on the other side of the stator core (20) so that the heat medium can flow inside the other heat medium flow member (320) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from the locations contacting the stator core (20).

Another aspect is an electrical energy-mechanical energy converter including:
a stator core (20);
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in the stator core (20) and being longer than a thickness of the stator core (20) and protruding on both sides of the stator core (20);
a plurality of U-phase connectors (211, 2121, 2122) that is electrically conductive and is connected between one end sides of the plurality of U-phase conductive tubes (111, 112, . . . ) protruding from the stator core (20) or between other end sides of the plurality of U-phase conductive tubes (111, 112, . . . );
a U-phase line (11) that is electrically conductive and is connected to one end side of one of the plurality of U-phase conductive tubes (111, 112, . . . ) to which the plurality of U-phase connector is connected at both one end side and the other end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the stator core (20) and being longer than the thickness of the stator core (20) and protruding on both sides of the stator core (20);
a plurality of V-phase connectors (221, 2221, 2222) that is electrically conductive and is connected between one end sides of the plurality of V-phase conductive tubes (121, 122, . . . ) protruding from the stator core (20) or between other end sides of the plurality of V-phase conductive tubes (121, 122, . . . );
a V-phase line (12) that is electrically conductive and is connected to one end side of one of the plurality of V-phase conductive tubes (121, 122, . . . ) to which the plurality of V-phase connectors is connected at both one end side and the other end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the stator core (20) and being longer than the thickness of the stator core (20) and protruding on both sides of the stator core (20);
a plurality of W-phase connectors (231, 2321, 2322) that is electrically conductive and is connected between one end sides of the plurality of W-phase conductive tubes (131, 132, . . . ) protruding from the stator core (20) or between other end sides of the plurality of W-phase conductive tubes (131, 132, . . . );
a W-phase line (13) that is electrically conductive and is connected to one end side of one of the plurality of W-phase conductive tubes (131, 132, . . . ) to which the plurality of W-phase connectors is connected at both one end side and the other end side;
a neutral line (240) that is electrically conductive and is connected to one end side of the plurality of U-phase conductive tubes (111, 112, . . . ) to which the plurality of U-phase connectors is connected only at the other end side, one end side of the plurality of V-phase conductive tubes (121, 122, . . . ) to which the plurality of V-phase connectors is connected only at the other end side and one end side of the plurality of W-phase conductive tubes (131, 132, . . . ) to which the W-phase connector is connected only at the other end side;
one heat medium flow member (310) arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from locations contacting the stator core (20); and
the other heat medium flow member (320) arranged on the other side of the stator core (20) so that the heat medium can flow inside the other heat medium flow member (320) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from the locations contacting the stator core (20).

Another aspect is an electrical energy-mechanical energy converter including:
a stator core (20) having a plurality of teeth protruded from a base portion;
a first U-phase conductive tube (111) that is electrically conductive so that a heat medium can flow through the first U-phase conductive tube (111), the first U-phase conductive tube (111) being arranged in a space between the plurality of teeth and being longer than a thickness of the stator core (20) and protruding on both sides of the stator core (20);
a second U-phase conductive tube (112) that is electrically conductive so that the heat medium can flow through the second U-phase conductive tube (112), the second U-phase conductive tube (112) being arranged in the space between the plurality of teeth and being longer than the thickness of the stator core (20) and protruding on the both sides of the stator core (20);
a U-phase line (11) that is electrically conductive and is connected to one end side of one of the first U-phase conductive tube (111) protruding from the stator core (20);
a plurality of U-phase connector tubes (2131) that is electrically conductive so that the heat medium can flow through the plurality of U-phase connector tubes (2131) and is connected to the other end of the first U-phase conductive tube (111) protruding from the stator core (20) and the other end of the second U-phase conductive tube (112) protruding from the stator core (20);
a first V-phase conductive tube (121) that is electrically conductive so that the heat medium can flow through the first V-phase conductive tube (121), the first V-phase conductive tube (121) being arranged in the space between the plurality of teeth and being longer than the thickness of the stator core (20) and protruding on the both sides of the stator core (20);
a second V-phase conductive tube (122) that is electrically conductive so that the heat medium can flow through the second V-phase conductive tube (122), the second V-phase conductive tube (122) being arranged in the space between the plurality of teeth and being longer than the thickness of the stator core (20) and protruding on the both sides of the stator core (20);
a V-phase line (12) that is electrically conductive and is connected to one end side of the first V-phase conductive tube (121) protruding from the stator core (20);
a V-phase connector tube (2231) that is electrically conductive so that the heat medium can flow through the V-phase connector tube (2231) and is connected to the other end of the first V-phase conductive tube (121) protruding from the stator core (20) and the other end of the second V-phase conductive tube (122) protruding from the stator core (20);
a first W-phase conductive tube (131) that is electrically conductive so that the heat medium can flow through the first W-phase conductive tube (131), the first W-phase conductive tube (131) being arranged in the space between the plurality of teeth and being longer than the thickness of the stator core (20) and protruding on both sides of the stator core (20);
a second W-phase conductive tube (132) that is electrically conductive so that the heat medium can flow through the second W-phase conductive tube (132), the second W-phase conductive tube (132) being arranged in the space between the plurality of teeth and being longer than the thickness of the stator core (20) and protruding on both sides of the stator core (20);
a W-phase line (13) that is electrically conductive and is connected to one end side of the first W-phase conductive tube (131) protruding from the stator core (20);
a W-phase connector tube (2331) that is electrically conductive so that the heat medium can flow through the W-phase connector tube (2331) and is connected to the other end of the first W-phase conductive tube (131) protruding from the stator core (20) and the other end of the second W-phase conductive tube (132) protruding from the stator core (20);
a neutral line (240) that is electrically conductive and is connected to one end side of the second U-phase conductive tube (112) protruding from the stator core (20), one end side of the second V-phase conductive tube (122) and one end side of the second W-phase conductive tube (132); and
a heat medium flow member (310) arranged on one side of the stator core (20) so that the heat medium can flow through the heat medium flow member (310) while preventing the heat medium flowing through the first U-phase conductive tube (111), the second U-phase conductive tube (112), the first V-phase conductive tube (121), the second V-phase conductive tube (122), the first W-phase conductive tube (131) and the second W-phase conductive tube (132) from leaking to the outside from locations contacting the stator core (20).

Another aspect is an electrical energy-mechanical energy converter including:
a stator core (20);
a first U-phase conductive tube (111) that is electrically conductive so that a heat medium can flow through the first U-phase conductive tube (111), the first U-phase conductive tube (111) being arranged in the stator core (20) and being longer than a thickness of the stator core (20) and protruding on both sides of the stator core (20);
a second U-phase conductive tube (112) that is electrically conductive so that the heat medium can flow through the second U-phase conductive tube (112), the second U-phase conductive tube (112) being arranged in the stator core (20) and being longer than the thickness of the stator core (20) and protruding on the both sides of the stator core (20);
a U-phase line (11) that is electrically conductive and is connected to one end side of one of the first U-phase conductive tube (111) protruding from the stator core (20);
a plurality of U-phase connector tubes (2131) that is electrically conductive so that the heat medium can flow through the plurality of U-phase connector tubes (2131) and is connected to the other end of the first U-phase conductive tube (111) protruding from the stator core (20) and the other end of the second U-phase conductive tube(112) protruding from the stator core (20);
a first V-phase conductive tube (121) that is electrically conductive so that the heat medium can flow through the first V-phase conductive tube (121), the first V-phase conductive tube (121) being arranged in the stator core (20) and being longer than the thickness of the stator core (20) and protruding on the both sides of the stator core (20);
a second V-phase conductive tube (122) that is electrically conductive so that the heat medium can flow through the second V-phase conductive tube (122), the second V-phase conductive tube (122) being arranged in the stator core (20) and being longer than the thickness of the stator core (20) and protruding on the both sides of the stator core (20);
a V-phase line (12) that is electrically conductive and is connected to one end side of the first V-phase conductive tube (121) protruding from the stator core (20);
a V-phase connector tube (2231) that is electrically conductive so that the heat medium can flow through the V-phase connector tube (2231) and is connected to the other end of the first V-phase conductive tube (121) protruding from the stator core (20) and the other end of the second V-phase conductive tube (122) protruding from the stator core (20);
a first W-phase conductive tube (131) that is electrically conductive so that the heat medium can flow through the first W-phase conductive tube (131), the first W-phase conductive tube (131) being arranged in the stator core (20) and being longer than the thickness of the stator core (20) and protruding on both sides of the stator core (20);
a second W-phase conductive tube (132) that is electrically conductive so that the heat medium can flow through the second W-phase conductive tube (132), the second W-phase conductive tube (132) being arranged in the stator core (20) and being longer than the thickness of the stator core (20) and protruding on both sides of the stator core (20);
a W-phase line (13) that is electrically conductive and is connected to one end side of the first W-phase conductive tube (131) protruding from the stator core (20);
a W-phase connector tube (2331) that is electrically conductive so that the heat medium can flow through the W-phase connector tube (2331) and is connected to the other end of the first W-phase conductive tube (131) protruding from the stator core (20) and the other end of the second W-phase conductive tube (132) protruding from the stator core (20);
a neutral line (240) that is electrically conductive and is connected to one end side of the second U-phase conductive tube (112), one end side of the second V-phase conductive tube (122) and one end side of the second W-phase conductive tube (132) protruding from the stator core (20); and
a heat medium flow member (310) that is arranged on one side of the stator core (20) so that the heat medium can flow inside the one heat medium flow member (310) while preventing the heat medium flowing through the first U-phase conductive tube (111), the second U-phase conductive tube (112), the first V-phase conductive tube (121), the second V-phase conductive tube (122), the first W-phase conductive tube (131) and the second W-phase conductive tube (132) from leaking to the outside from locations contacting the stator core (20).

Another aspect is an electrical energy-mechanical energy converter including:
a stator core (20) having a plurality of teeth protruded from a base portion;
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in a different space between the plurality of teeth and being longer than a thickness of the stator core (20) and protruding on both sides of the stator core (20);
at least one U-phase connector (211) that is electrically conductive and is connected between one end sides of the plurality of U-phase conductive tubes (111, 112, . . . ) protruding from the stator core (20);
a plurality of U-phase connector tubes (2131, 2132) that is electrically conductive so that the heat medium can flow through the plurality of U-phase connector tubes (2131, 2132) and is connected between the other end sides of the plurality of U-phase conductive tubes (111, 112, . . . ) protruding from the stator core (20);
a U-phase line (11) that is electrically conductive and is connected to one end side of one (the U-phase conductive tube 111) of the plurality of U-phase conductive tubes (111, 112, . . . ) to which the U-phase connector (211) is not connected at one end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the different space between the plurality of teeth and being longer than the thickness of the stator core (20) and protruding on both sides of the stator core (20);
at least one V-phase connector (221) that is electrically conductive and is connected between one end sides of the plurality of V-phase conductive tubes (121, 122, . . . ) protruding from the stator core (20);
a plurality of V-phase connector tubes (2231, 2232) that is electrically conductive so that the heat medium can flow through the plurality of V-phase connector tubes (2231, 2232), the plurality of V-phase connector tubes (2231, 2232) being connected between the other end sides of the plurality of V-phase conductive tubes (121, 122, . . . ) protruding from the stator core (20);
a V-phase line (12) that is electrically conductive and is connected to one end side of the plurality of V-phase conductive tubes (121, 122, . . . ) to which the V-phase connector (221) is not connected at one end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the different space between the plurality of teeth and being longer than the thickness of the stator core (20) and protruding on both sides of the stator core (20);
at least one W-phase connector (231) that is electrically conductive and is connected between one end sides of the plurality of W-phase conductive tubes (131, 132, . . . ) protruding from the stator core (20);
a plurality of W-phase connector tubes (2331, 2332) that is electrically conductive so that the heat medium can flow through the plurality of W-phase connector tubes (2331, 2332), the plurality of W-phase connector tubes (2331, 2332) being connected between the other end sides of the plurality of W-phase conductive tubes (131, 132, . . . ) protruding from the stator core (20);
a W phase line (13) that is electrically conductive and is connected to one end side of one of the plurality of W-phase conductive tubes (131, 132) to which the plurality of W-phase connectors (231) is not connected at one end side;
a neutral line (240) that is electrically conductive and is connected to one end side of the plurality of U-phase conductive tubes (111, 112, . . . ) to which neither the plurality of U-phase connectors nor the plurality of U-phase lines (11) is connected at one end side, one end side of the plurality of V-phase conductive tubes (121, 122, . . . ) to which neither the plurality of V-phase connectors nor the plurality of V-phase lines (12) is connected at one end side and one end side of the plurality of W-phase conductive tubes (131, 132, . . . ) to which neither the plurality of W-phase connectors nor the plurality of W-phase lines (13) is connected at one end side; and
a heat medium flow member (310) that is arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121, 122, . . . ) and the plurality of W-phase conductive tubes (131, 132, . . . ) from leaking to the outside from locations contacting the stator core (20).

Another aspect is an electrical energy-mechanical energy converter including:
a stator core (20) having a plurality of teeth protruded from a base portion;
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in a different space between the plurality of teeth and being longer than a thickness of the stator core (20) and protruding on both sides of the stator core (20);
at least one U-phase connector (211) that is electrically conductive and is connected between one end sides of the plurality of U-phase conductive tubes (111, 112, . . . ) protruding from the stator core (20);
a plurality of U-phase connector tubes (2131, 2132) that is electrically conductive so that the heat medium can flow through the plurality of U-phase connector tubes (2131, 2132) and is connected between the other end sides of the plurality of U-phase conductive tubes (111, 112, . . . ) protruding from the stator core (20);
a U phase line (11) that is electrically conductive and is connected to one end side of one of the plurality of U-phase conductive tubes (111, 112, . . . ) to which the U-phase connector (211) is connected at one end side and the plurality of U-phase connector tubes (2131) is connected at the other end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the different space between the plurality of teeth and being longer than the thickness of the stator core (20) and protruding on both sides of the stator core (20);
at least one V-phase connector (221) that is electrically conductive and is connected between one end sides of the plurality of V-phase conductive tubes (121, 122, . . . ) protruding from the stator core (20);
a plurality of V-phase connector tubes (2231, 2232) that is electrically conductive so that the heat medium can flow through the plurality of V-phase connector tubes (2231, 2232), the plurality of V-phase connector tubes (2231, 2232) being connected between the other end sides of the plurality of V-phase conductive tubes (121, 122,. . . ) protruding from the stator core (20);
a V-phase line (12) that is electrically conductive and is connected to one end side of one of the plurality of V-phase conductive tubes (121) to which the V-phase connector (221) is connected at one end side and the V-phase connector tube (2231) is connected at the other end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the different space between the plurality of teeth and being longer than the thickness of the stator core (20) and protruding on both sides of the stator core (20);
at least one W-phase connector (231) that is electrically conductive and is connected between one end sides of the plurality of W-phase conductive tubes (131, 132, . . . ) protruding from the stator core (20);
a plurality of W-phase connector tubes (2331, 2332) that is electrically conductive so that the heat medium can flow through the plurality of W-phase connector tubes (2331, 2332), the plurality of W-phase connector tubes (2331, 2332) being connected between the other end sides of the plurality of W-phase conductive tubes(131,132,. . . ) protruding from the stator core (20);
a W phase line (13) that is electrically conductive and is connected to the W-phase conductive tube (231) at one end side and connected to the W-phase connector tube (2331) at the other end side;
a neutral line (240) that is electrically conductive and is connected to one end side of the plurality of U-phase conductive tubes (111, 112, . . . ) to which the plurality of U-phase connectors is connected only at the other end side, one end side of the plurality of V-phase conductive tubes (121, 122, . . . ) to which the plurality of V-phase connectors is connected only at the other end side and one end side of the plurality of W-phase conductive tubes (131, 132, . . . ) to which the W-phase connector is connected only at the other end side; and
a heat medium flow member (310) that is arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121,122, . . . ) and the plurality of W-phase conductive tubes (131, 132, . . . ) from leaking to the outside from locations contacting the stator core (20).

Another aspect is an electrical energy-mechanical energy converter including:
a stator core (20);
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in the stator core (20) and being longer than a thickness of the stator core (20) and protruding on both sides of the stator core (20);
at least one U-phase connector (211) that is electrically conductive and is connected between one end sides of the plurality of U-phase conductive tubes (111, 112, . . . ) protruding from the stator core (20);
a plurality of U-phase connector tubes (2131, 2132) that is electrically conductive so that the heat medium can flow through the plurality of U-phase connector tubes (2131, 2132) and is connected between the other end sides of the plurality of U-phase conductive tubes (111, 112, . . . ) protruding from the stator core (20);
a U-phase line (11) that is electrically conductive and is connected to one end side of one of the plurality of U-phase conductive tubes (111, 112, . . . ) to which the U-phase connector (211) is not connected at one end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the stator core (20) and being longer than the thickness of the stator core (20) and protruding on both sides of the stator core (20);
at least one V-phase connector (221) that is electrically conductive and is connected between one end sides of the plurality of V-phase conductive tubes (121, 122, . . . ) protruding from the stator core (20);
a plurality of V-phase connector tubes (2231, 2232) that is electrically conductive so that the heat medium can flow through the plurality of V-phase connector tubes (2231, 2232), the plurality of V-phase connector tubes (2231, 2232) being connected between the other end sides of the plurality of V-phase conductive tubes (121, 122, . . . ) protruding from the stator core (20);
a V phase line (12) that is electrically conductive and is connected to one end side of one of the plurality of V-phase conductive tubes (121, 122, . . . ) to which the V-phase connector (211) is not connected at one end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the stator core (20) and being longer than the thickness of the stator core (20) and protruding on both sides of the stator core (20);
at least one W-phase connector (231) that is electrically conductive and is connected between one end sides of the plurality of W-phase conductive tubes (131, 132, . . . ) protruding from the stator core (20);
a plurality of W-phase connector tubes (2331, 2332) that is electrically conductive so that the heat medium can flow through the plurality of W-phase connector tubes (2331, 2332), the plurality of W-phase connector tubes (2331, 2332) being connected between the other end sides of the plurality of W-phase conductive tubes (131,132, . . . ) protruding from the stator core (20);
a W phase line (13) that is electrically conductive and is connected to one end side of one of the plurality of W-phase conductive tubes to which the W-phase connector (231) is not connected at one end side;
a neutral line (240) that is electrically conductive and connected to one end side of the plurality of U-phase conductive tubes (111, 112, . . . ) to which the U-phase connector (211) nor the U-phase line (11) is connected, one end side of the plurality of V-phase conductive tubes (121,122, . . . ) to which neither the V-phase connector (221) nor the V phase line (12) is connected and one end side of the plurality of W-phase conductive tubes (131, 132, . . . ) to which the W-phase connector (231) nor the W phase line (13) is connected; and
a heat medium flow member (310) that is arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121,122, . . . ) and the plurality of W-phase conductive tubes (131, 132, . . . ) from leaking to the outside from locations contacting the stator core (20).

Another aspect is an electrical energy-mechanical energy converter including:
a stator core (20);
a plurality of U-phase conductive tubes (111, 112, . . . ) that is electrically conductive so that a heat medium can flow through the plurality of U-phase conductive tubes (111, 112, . . . ), the plurality of U-phase conductive tubes (111, 112, . . . ) being arranged in the stator core (20) and being longer than a thickness of the stator core (20) and protruding on both sides of the stator core (20);
at least one U-phase connector (211) that is electrically conductive and is connected between one end sides of the plurality of U-phase conductive tubes (111, 112, . . . ) protruding from the stator core (20);
a plurality of U-phase connector tubes (2131, 2132) that is electrically conductive so that the heat medium can flow through the plurality of U-phase connector tubes (2131, 2132) and is connected between the other end sides of the plurality of U-phase conductive tubes (111,112, . . . ) protruding from the stator core (20);
a U-phase line (11) that is electrically conductive and is connected to one end side of one of the plurality of U-phase conductive tubes (111, 112, . . . ) to which the plurality of U-phase connectors is connected at one end side and the plurality of U-phase connector tubes is connected at the other end side;
a plurality of V-phase conductive tubes (121, 122, . . . ) that is electrically conductive so that the heat medium can flow through the plurality of V-phase conductive tubes (121, 122, . . . ), the plurality of V-phase conductive tubes (121, 122, . . . ) being arranged in the stator core (20) and being longer than the thickness of the stator core (20) and protruding on both sides of the stator core (20);
at least one V-phase connector (221) that is electrically conductive and is connected between one end sides of the plurality of V-phase conductive tubes (121, 122, . . . ) protruding from the stator core (20);
a plurality of V-phase connector tubes (2231, 2232) that is electrically conductive so that the heat medium can flow through the plurality of V-phase connector tubes (2231, 2232), the plurality of V-phase connector tubes (2231, 2232) being connected between the other end sides of the plurality of V-phase conductive tubes (121, 122, . . . ) protruding from the stator core (20);
a V phase line (12) that is electrically conductive and is connected to one end side of one of the plurality of V-phase conductive tubes (111, 112, . . . ) to which the V-phase connector is connected at one end side and the plurality of V-phase connector tubes is connected at the other end side;
a plurality of W-phase conductive tubes (131, 132, . . . ) that is electrically conductive so that the heat medium can flow through the plurality of W-phase conductive tubes (131, 132, . . . ), the plurality of W-phase conductive tubes (131, 132, . . . ) being arranged in the stator core (20) and being longer than the thickness of the stator core (20) and protruding on both sides of the stator core (20);
at least one W-phase connector (231) that is electrically conductive and is connected between one end sides of the plurality of W-phase conductive tubes (131, 132, . . . ) protruding from the stator core (20);
a plurality of W-phase connector tubes (2331, 2332) that is electrically conductive so that the heat medium can flow through the plurality of W-phase connector tubes (2331, 2332), the plurality of W-phase connector tubes (2331, 2332) being connected between the other end sides of the plurality of W-phase conductive tubes (131,132, . . . ) protruding from the stator core (20);
a W phase line (13) that is electrically conductive and is connected to one end side of one of the plurality of W-phase conductive tubes (131, 132, . . . ) to which the W-phase connector is connected at one end side and the W-phase connector tube is connected at the other end side;
a neutral line (240) that is electrically conductive and is connected to one end side of the plurality of U-phase conductive tubes (111, 112, . . . ) to which the plurality of U-phase connectors is connected only at the other end side, one end side of the plurality of V-phase conductive tubes (121, 122, . . . ) to which the plurality of V-phase connectors is connected only at the other end side and one end side of the plurality of W-phase conductive tubes (131, 132, . . . ) to which the W-phase connector is connected only at the other end side; and
a heat medium flow member (310) that is arranged on one side of the stator core (20) so that the heat medium can flow inside the one heat medium flow member (310) while preventing the heat medium flowing through the plurality of U-phase conductive tubes (111, 112, . . . ), the plurality of V-phase conductive tubes (121,122,. . . ) and the plurality of W-phase conductive tubes (131, 132, . . . ) from leaking to the outside from locations contacting the stator core (20).

### BRIEF DESCRIPTION OF DRAWINGS

FIG. 1 is a drawing showing a stator of an electrical energy-mechanical energy converter prototyped this time.

FIG. 2 is a drawing showing an example of a conductive tube.

FIG. 3 is a drawing showing an example of a connector.

FIG. 4 is a drawing of the stator in side view.

FIG. 5 is a drawing of the stator viewed obliquely from above.

FIG. 6 is an enlarged view of the vicinity of a heat medium flow member arranged above the stator core viewed obliquely from above.

FIG. 7 is an exploded view showing an example of a rotating electrical machine.

FIG. 8A is an assembly drawing of the rotating electrical machine shown in FIG. 7 viewed obliquely from the left. FIG. 8B is an assembly drawing viewed obliquely from the right.

FIG. 9 is a development drawing modeled on the rotating electrical machine shown in FIG. 7.

FIG. 10 is a drawing for explaining a flow of a heat medium in the model developed drawing shown in FIG. 9.

FIG. 11 is a drawing for explaining a flow of electricity from a U-phase line to a V-phase line in the model developed drawing shown in FIG. 9.

FIG. 12 is a drawing for explaining a flow of electricity from a V-phase line to a W-phase line in the model developed drawing shown in FIG. 9.

FIG. 13 is a drawing for explaining a flow of electricity from a W-phase line to a U-phase line in the model developed drawing shown in FIG. 9.

FIG. 14 is an exploded view showing the second embodiment of the rotating electrical machine.

FIG. 15A is an assembly drawing of the rotating electrical machine shown in FIG. 14 viewed obliquely from the left. FIG. 15B is an assembly drawing viewed obliquely from the right.

FIG. 16 is a developed drawing modeled on the rotating electrical machine shown in FIG. 14.

FIG. 17 is an exploded view showing the third embodiment of the rotating electrical machine.

FIG. 18A is an assembly drawing of the rotating electrical machine shown in FIG. 17 viewed obliquely from the left. FIG. 18B is an assembly drawing viewed obliquely from the right.

FIG. 19 is a developed drawing modeled on the rotating electrical machine shown in FIG. 17.

FIG. 20 is a drawing for explaining a flow of a heat medium in the model developed drawing shown in FIG. 19.

FIG. 21 is a drawing for explaining a flow of electricity from a U-phase line to a V-phase line in the model developed drawing shown in FIG. 19.

FIG. 22 is a drawing for explaining a flow of electricity from a V-phase line to a W-phase line in the model developed drawing shown in FIG. 19.

FIG. 23 is a drawing for explaining a flow of electricity from a W-phase line to a U-phase line in the model developed drawing shown in FIG. 19.

FIG. 24 is an exploded view showing the fourth embodiment of the rotating electrical machine.

FIG. 25A is an assembly drawing of the rotating electrical machine shown in FIG. 24 viewed obliquely from the left. FIG. 25B is an assembly drawing viewed obliquely from the right.

FIG. 26 is a developed drawing modeled on the rotating electrical machine shown in FIG. 24.

FIG. 27 is a developed drawing modeled on the rotating electrical machine of the fifth embodiment.

FIG. 28 is a drawing for explaining a flow of electricity from a V-phase line to a W-phase line in the model developed drawing shown in FIG. 27.

FIG. 29 is a drawing for explaining a flow of electricity from a W-phase line to a U-phase line in the model developed drawing shown in FIG. 27.

FIG. 30 is a developed drawing modeled on the rotating electrical machine of the sixth embodiment.

FIG. 31 is a drawing for explaining a flow of electricity from a U-phase line to a V-phase line in the model developed drawing shown in FIG. 30.

FIG. 32 is a drawing for explaining a flow of electricity from a V-phase line to a W-phase line in the model developed drawing shown in FIG. 30.

FIG. 33 is a drawing for explaining a flow of electricity from a W-phase line to a U-phase line in the model developed view shown in FIG. 30.

FIG. 34 is a developed drawing modeled on the rotating electrical machine of the seventh embodiment.

FIG. 35 is a drawing for explaining a flow of electricity from a U-phase line to a V-phase line in the model developed drawing shown in FIG. 34.

FIG. 36 is a drawing for explaining a flow of electricity from a V-phase line to a W-phase line in the model developed drawing shown in FIG. 34.

FIG. 37 is a drawing for explaining a flow of electricity from a W-phase line to a U-phase line in the model developed drawing shown in FIG. 34.

FIG. 38 is a developed drawing modeled on the rotating electrical machine of the eighth embodiment.

FIG. 39 is a drawing for explaining a flow of electricity from a U-phase line to a V-phase line in the model developed drawing shown in FIG. 38.

FIG. 40 is a drawing for explaining a flow of electricity from a V-phase line to a W-phase line in the model developed drawing shown in FIG. 38.

FIG. 41 is a drawing for explaining a flow of electricity from a W-phase line to a U-phase line in the model developed drawing shown in FIG. 38.

FIG. 42 is a developed drawing modeled on the rotating electrical machine of the ninth embodiment.

FIG. 43 is a drawing for explaining a flow of electricity from a U-phase line to a V-phase line in the model developed drawing shown in FIG. 42.

FIG. 44 is a drawing for explaining a flow of electricity from a V-phase line to a W-phase line in the model developed drawing shown in FIG. 42.

FIG. 45 is a drawing for explaining a flow of electricity from a W-phase line to a U-phase line in the model developed drawing shown in FIG. 42.

FIG. 46 is a developed drawing modeled on the rotating electrical machine of the tenth embodiment.

FIG. 47 is a drawing for explaining a flow of electricity from a U-phase line to a V-phase line in the model developed drawing shown in FIG. 46.

FIG. 48 is a drawing for explaining a flow of electricity from a V-phase line to a W-phase line in the model developed drawing shown in FIG. 46.

FIG. 49 is a drawing for explaining a flow of electricity from a W-phase line to a U-phase line in the model developed drawing shown in FIG. 46.

FIG. 50 is a developed drawing modeled on the rotating electrical machine of the eleventh embodiment.

FIG. 51 is a drawing for explaining a flow of electricity from a U-phase line to a V-phase line in the model developed drawing shown in FIG. 50.

FIG. 52 is a drawing for explaining a flow of electricity from a V-phase line to a W-phase line in the model developed drawing shown in FIG. 50.

FIG. 53 is a drawing for explaining a flow of electricity from a W-phase line to a U-phase line in the model developed drawing shown in FIG. 50.

FIG. 54 is a drawing showing an example of a stator of a slotless type rotating electrical machine (electrical energy-mechanical energy converter).

FIG. 55 is an exploded view of a rotating electrical machine in which a main body portion of a heat medium flow member also serves as a motor housing.

FIG. 56A is an assembly drawing of the rotating electrical machine shown in FIG. 55 viewed obliquely from the left. FIG. 56B is an assembly drawing viewed obliquely from the right.

FIG. 57 is a drawing showing an example of a cylindrical type conductive tube.

FIG. 58 is a drawing showing an example of a conductive tube of a type in which a plurality of passages is formed.

FIG. 59 is a drawing showing an example in which one heat medium flow member and the other heat medium flow member used in the second embodiment are applied to the fifth embodiment.

FIG. 60 is a drawing showing an example in which the heat medium flow member used in the fourth embodiment is applied to the third embodiment.

### DETAILED DESCRIPTION OF THE INVENTION

Embodiments of the present invention and advantages of the present invention will be explained in detail below with reference to the attached drawings.

### First Embodiment

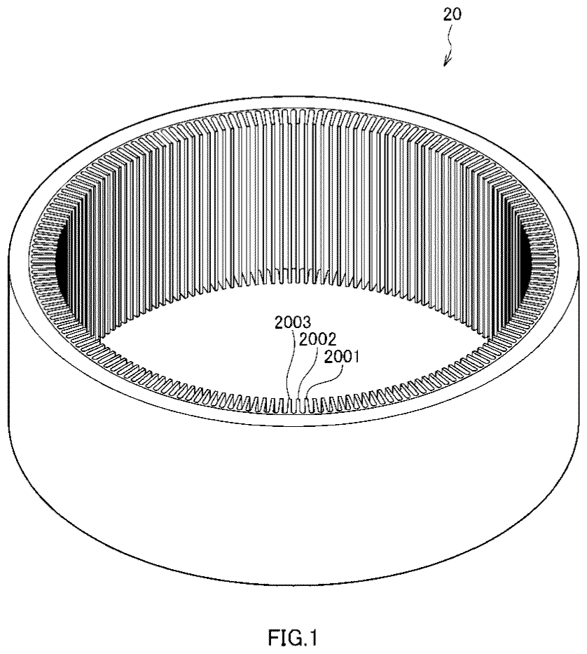

FIG. 1 is a drawing showing a stator of an electrical energy-mechanical energy converter prototyped this time.

In the following explanation, unless otherwise specified, a rotating electrical machine functioning as an electric motor or a generator will be explained as an example of the electrical energy-mechanical energy converter.

FIG. 1 shows a stator core which is a characteristic configuration of the rotating electrical machine of the present embodiment. FIG. 1 shows a stator core used in an inner rotor type rotating electrical machine. However, this is merely an example. The gist of the present invention may be applied to an outer rotor type rotating electrical machine.

As shown in FIG. 1, the stator core 20 has a cylindrical shape and has a structure in which a plurality of teeth 2001, 2002, . . . is protruded from an inner peripheral wall of a base portion. In FIG. 1, 192 teeth are protruded. The stator core 20 is formed by laminating thin plate-shaped electromagnetic steel sheets.

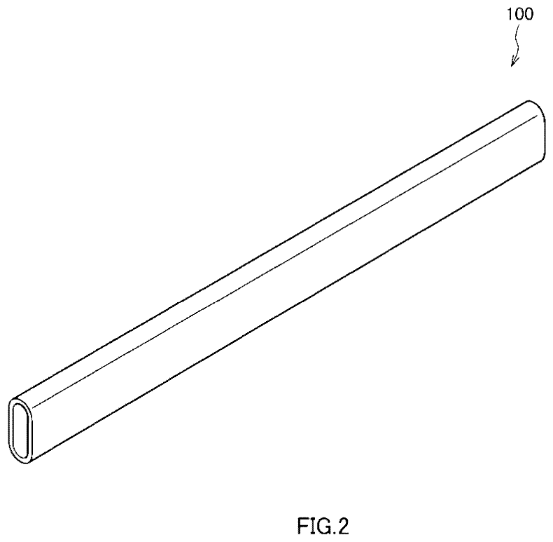

FIG. 2 is a drawing showing an example of a conductive tube.

A conductive tube 100 is electrically conductive and allows a heat medium to flow through the conductive tube 100. An insulation treatment using an insulating varnish or the like is applied to a surface of the conductive tube 100. The heat medium flows through an inner peripheral side, and an insulation treatment using an insulating varnish or the like may also be applied to the inner peripheral surface. FIG. 2 shows a flat-shaped conductive tube 100 as an example. However, the conductive tube may be cylindrical.

The conductive tube 100 is arranged in a space (slot) between the teeth of the stator core 20. Since the conductive tube 100 is longer than a thickness of the stator core 20, the conductive tube 100 protrudes from both sides of the stator core 20 when arranged in the slot of the stator core 20.

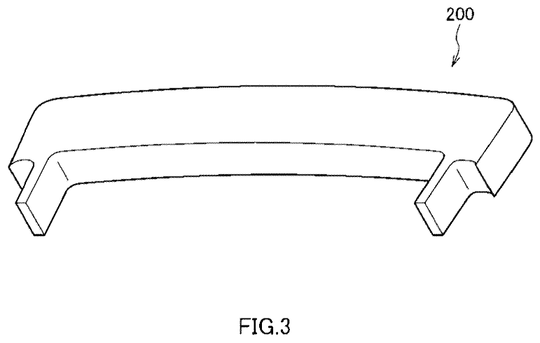

FIG. 3 is a drawing showing an example of a connector.

As described above, since the conductive tube 100 is longer than the thickness of the stator core 20, the conductive tube 100 protrudes from both sides of the stator core 20 when arranged in the slot of the stator core 20. The connector is connected to the above described protruding portion and enables electrical conduction between specific conductive tubes. The connector 200 shown in FIG. 3 is arranged on an outer peripheral side of the stator core 20 and is connected to the conductive tube 100 from the outer peripheral side. However, the above described configuration is merely an example. The connector 200 may be arranged on an inner peripheral side of the stator core 20 and connected to the conductive tube 100 from the inner peripheral side.

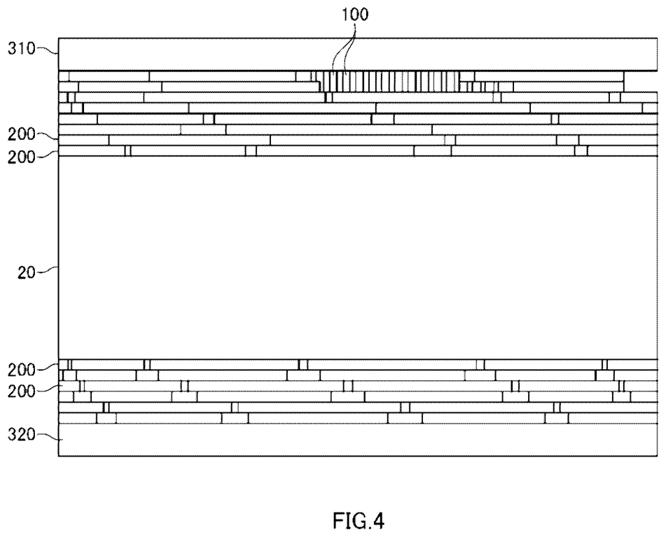

FIG. 4 is a drawing of the stator in side view.

The conductive tube 100 is arranged in a space (slot) between the teeth of the stator core 20, and the connector 200 is connected to portions protruding from both sides of the stator core 20. Specific connection locations and the like will be described later.

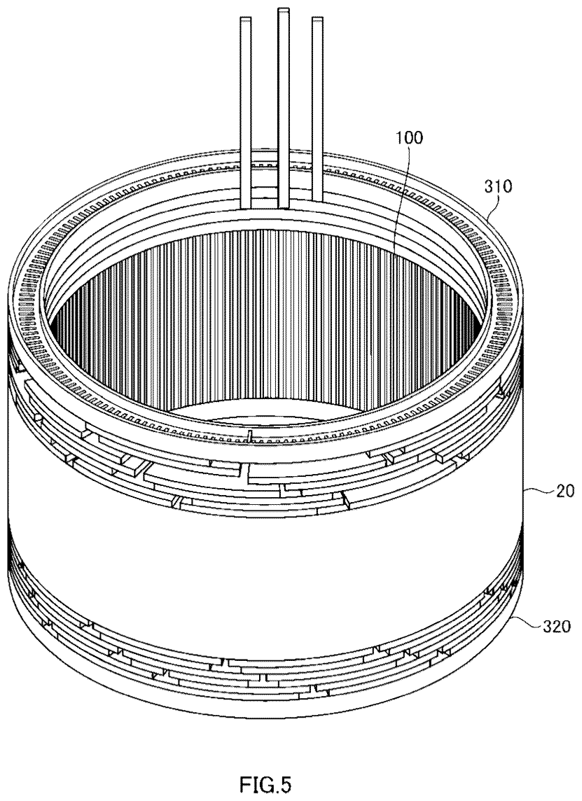

FIG. 5 is a drawing of the stator viewed obliquely from above.

As described above, the connector 200 is connected to the conductive tube 100 protruding from both sides of the stator core 20. Heat medium flow members 300 (310, 320) made of resin are arranged above and below the stator core 20.

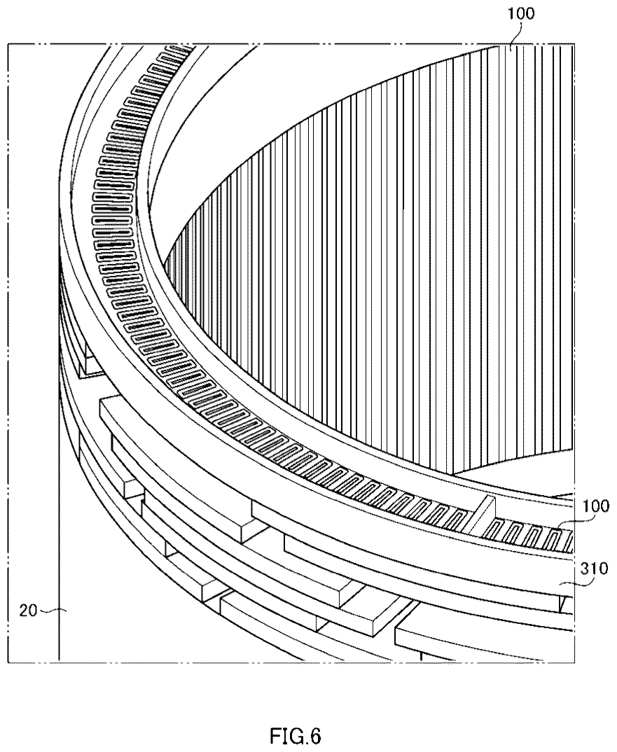

FIG. 6 is an enlarged view of the vicinity of the heat medium flow member arranged above the stator core viewed obliquely from above.

Holes having the same shape as the conductive tube 100 are formed in a bottom surface of the heat medium flow member 310, and the conductive tube 100 is inserted into the holes. A portion where the conductive tube 100 is inserted into the hole is liquid-tight so that the heat medium does not leak. Although the illustration is omitted in FIG. 5 and FIG. 6, the heat medium flow member 310 has a lid portion so that the heat medium does not leak from the heat medium flow member 310 to the outside.

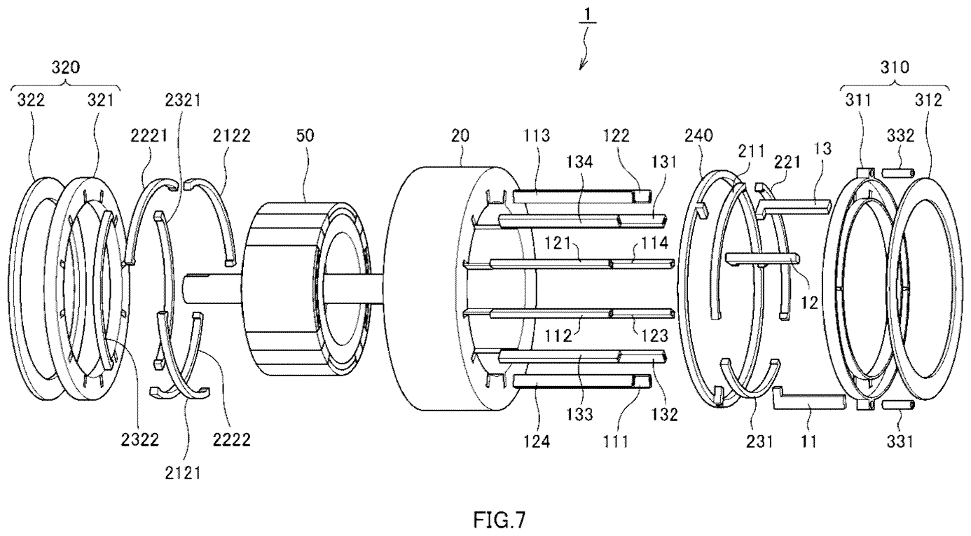

FIG. 7 is an exploded view showing an example of a rotating electrical machine.

In FIG. 1 to FIG. 6, the stator core 20 having 192 teeth protruded on the stator core 20 and 192 conductive tubes arranged in the spaces (slots) between the teeth is explained as an example. However, the structure is very complex. Therefore, simplified structures will be used for the explanation bellow for ease of understanding. However, these are not mere models. These also operate, of course.

The rotating electrical machine 1 shown in FIG. 7 has a structure in which twelve teeth are protruded on the stator core 20 and twelve conductive tubes are arranged in the spaces (slots) between the teeth. The rotor 50 is a 4-pole type, and the rotating electrical machine of FIG. 7 is a 12N4P type.

The stator core 20 is formed by laminating thin plate-shaped electromagnetic steel sheets. The stator core 20 has twelve teeth protruded from an inner peripheral wall of a base portion. Twelve conductive tubes 111, 112, . . . are arranged in the spaces (slots) between the teeth. Since the conductive tubes are longer than the thickness of the stator core 20, the conductive tube protrudes from both sides of the stator core 20 when arranged in the slots of the stator core 20. Connectors 211, 221, . . . are connected to the protruding portions to enable electrical conduction between specific conductive tubes. Details will be described later.

Heat medium flow members 310, 320 are arranged on both sides of the stator core 20. The conductive tubes 111, 112, . . . are inserted into the holes of the heat medium flow members 310, 320.

The heat medium flow member 310 includes a main body portion 311 and a lid portion 312. A flow path through which the heat medium flows is formed in the main body portion 311. The flow path is divided into two by a pair of partition portions 3100. A first heat medium flow tube 331 for supplying or discharging the heat medium is connected to one compartment (first heat medium flow compartment 3101). A second heat medium flow tube 332 for discharging or supplying the heat medium is connected to the other compartment (second heat medium flow compartment 3102). The lid portion 312 is liquid-tightly fixed to the main body portion 311 so that the heat medium flowing through the flow path of the main body portion 311 does not leak to the outside.

The heat medium flow member 320 includes a main body portion 321 and a lid portion 322. A flow path through which the heat medium flows is formed in the main body portion 321. The lid portion 322 is liquid-tightly fixed to the main body portion 321 so that the heat medium flowing through the flow path of the main body portion 321 does not leak to the outside.

A U-phase line 11 is connected to one of the U-phase conductive tubes among the twelve conductive tubes. A V-phase line 12 is connected to one of the V-phase conductive tubes among the twelve conductive tubes. A W-phase line 13 is connected to one of the W-phase conductive tubes among the twelve conductive tubes.

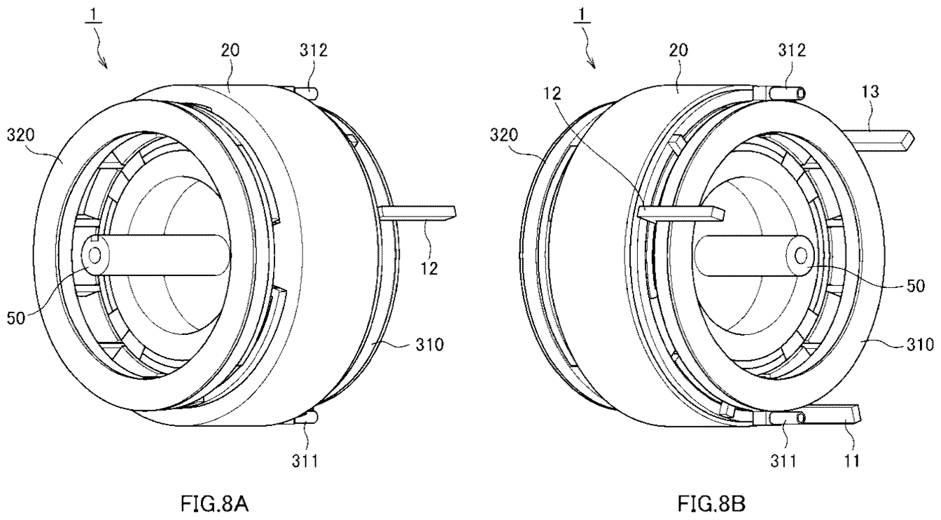

FIGS. 8A and 8B are assembly drawings of the rotating electrical machine shown in FIG. 7. FIG. 8A is the drawing viewed obliquely from the left. FIG. 8B is the drawing viewed obliquely from the right. As can be seen from FIG. 8A and FIG. 8B, the heat medium flow members 310, 320 are arranged on both sides of the stator core 20. As can be seen from FIG. 8B, the heat medium flow member 310 is provided with the first heat medium flow tube 331 and the second heat medium flow tube 332. It can also be seen that the U-phase line 11, the V-phase line 12 and the W-phase line 13 are protruded.

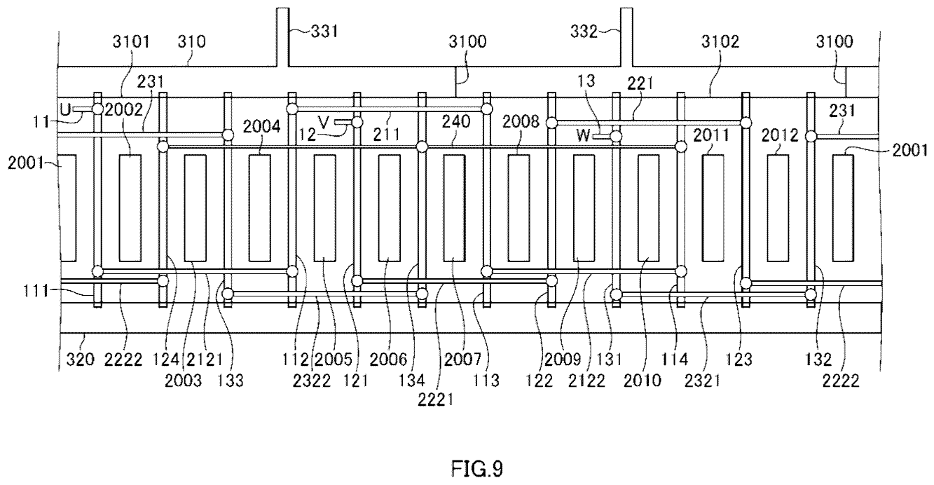

FIG. 9 is a development drawing modeled on the rotating electrical machine shown in FIG. 7.

A plurality of teeth is protruded from the inner peripheral wall of the base portion of the stator core 20. In FIG. 9, there are a first tooth 2001, a second tooth 2002, a third tooth 2003, a fourth tooth 2004, a fifth tooth 2005, a sixth tooth 2006, a seventh tooth 2007, an eighth tooth 2008, a ninth tooth 2009, a tenth tooth 2010, an eleventh tooth 2011 and a twelfth tooth 2012 from the left.

The conductive tubes are arranged in the spaces (slots) between the respective teeth. A U-phase first conductive tube 111 is arranged in the space (slot) between the first tooth 2001 and the second tooth 2002. A V-phase fourth conductive tube 124 is arranged in the space (slot) between the second tooth 2002 and the third tooth 2003. A W-phase third conductive tube 133 is arranged in the space (slot) between the third tooth 2003 and the fourth tooth 2004. A U-phase second conductive tube 112 is arranged in the space (slot) between the fourth tooth 2004 and the fifth tooth 2005. A V-phase first conductive tube 121 is arranged in the space (slot) between the fifth tooth 2005 and the sixth tooth 2006. A W-phase fourth conductive tube 134 is arranged in the space (slot) between the sixth tooth 2006 and the seventh tooth 2007. A U-phase third conductive tube 113 is arranged in the space (slot) between the seventh tooth 2007 and the eighth tooth 2008. A V-phase second conductive tube 122 is arranged in the space (slot) between the eighth tooth 2008 and the ninth tooth 2009. A W-phase first conductive tube 131 is arranged in the space (slot) between the ninth tooth 2009 and the tenth tooth 2010. A U-phase fourth conductive tube 114 is arranged in the space (slot) between the tenth tooth 2010 and the eleventh tooth 2011. A V-phase third conductive tube 123 is arranged in the space (slot) between the eleventh tooth 2011 and the twelfth tooth 2012. A W-phase second conductive tube 132 is arranged in the space (slot) between the twelfth tooth 2012 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Twelve holes are formed in the bottom surface of one heat medium flow member 310. Six holes are formed in the first heat medium flow compartment 3101. The remaining six holes are formed in the second heat medium flow compartment 3102.

One ends of the U-phase first conductive tube 111, the V-phase fourth conductive tube 124, the W-phase third conductive tube 133, the U-phase second conductive tube 112, the V-phase first conductive tube 121 and the W-phase fourth conductive tube 134 are inserted into the holes formed in the first heat medium flow compartment 3101.

One ends of the U-phase third conductive tube 113, the V-phase second conductive tube 122, the W-phase first conductive tube 131, the U-phase fourth conductive tube 114, the V-phase third conductive tube 123 and the W-phase second conductive tube 132 are inserted into the holes formed in the second heat medium flow compartment 3102.

The other heat medium flow member 320 is arranged below (on the other end side of) the stator core 20. Twelve holes are formed in the bottom surface of the other heat medium flow member 320. The other ends of the U-phase first conductive tube 111, the V-phase fourth conductive tube 124, the W-phase third conductive tube 133, the U-phase second conductive tube 112, the V-phase first conductive tube 121, the W-phase fourth conductive tube 134, the U-phase third conductive tube 113, the V-phase second conductive tube 122, the W-phase first conductive tube 131, the U-phase fourth conductive tube 114, the V-phase third conductive tube 123 and the W-phase second conductive tube 132 are inserted into the holes.

The U-phase line 11 is connected to one end side of the U-phase first conductive tube 111. The U-phase line 11 is a solid conductor. A U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

A U-phase one-end-side connector 211 is connected to one end side of the U-phase second conductive tube 112 and one end side of the U-phase third conductive tube 113 so that the U-phase second conductive tube 112 and the U-phase third conductive tube 113 are electrically conducted.

A U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

The V-phase line 12 is connected to one end side of the V-phase first conductive tube 121. The V-phase line 12 is a solid conductor. A V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

A V-phase one-end-side connector 221 is connected to one end side of the V-phase second conductive tube 122 and one end side of the V-phase third conductive tube 123 so that the V-phase second conductive tube 122 and the V-phase third conductive tube 123 are electrically conducted.

A V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

The W-phase line 13 is connected to one end side of the W-phase first conductive tube 131. The W-phase line 13 is a solid conductor. A W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

A W-phase one-end-side connector 231 is connected to one end side of the W-phase second conductive tube 132 and one end side of the W-phase third conductive tube 133 so that the W-phase second conductive tube 132 and the W-phase third conductive tube 133 are electrically conducted.

A W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

A neutral line connector 240 is connected to one end side of the U-phase fourth conductive tube 114, one end side of the V-phase fourth conductive tube 124 and one end side of the W-phase fourth conductive tube 134 so that the U-phase fourth conductive tube 114, the V-phase fourth conductive tube 124 and the W-phase fourth conductive tube 134 are electrically conducted.

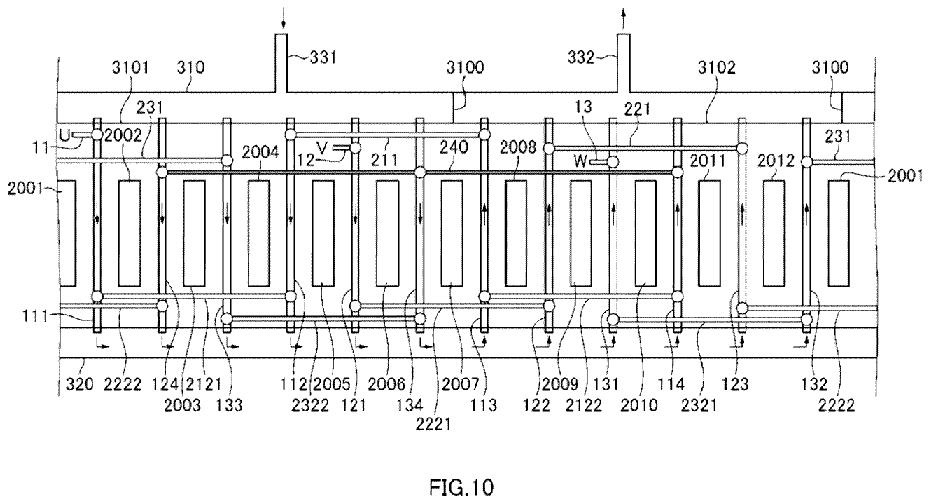

FIG. 10 is a drawing for explaining a flow of the heat medium in the model developed drawing shown in FIG. 9. The arrows indicate the flow direction of the heat medium.

The heat medium supplied from the first heat medium flow tube 331 flows from the first heat medium flow compartment 3101 of one heat medium flow member 310 through any one of the U-phase first conductive tube 111, the V-phase fourth conductive tube 124, the W-phase third conductive tube 133, the U-phase second conductive tube 112, the V-phase first conductive tube 121 and the W-phase fourth conductive tube 134, and reaches the other heat medium flow member 320. The heat medium flows through any one of the U-phase third conductive tube 113, the V-phase second conductive tube 122, the W-phase first conductive tube 131, the U-phase fourth conductive tube 114, the V-phase third conductive tube 123 and the W-phase second conductive tube 132, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

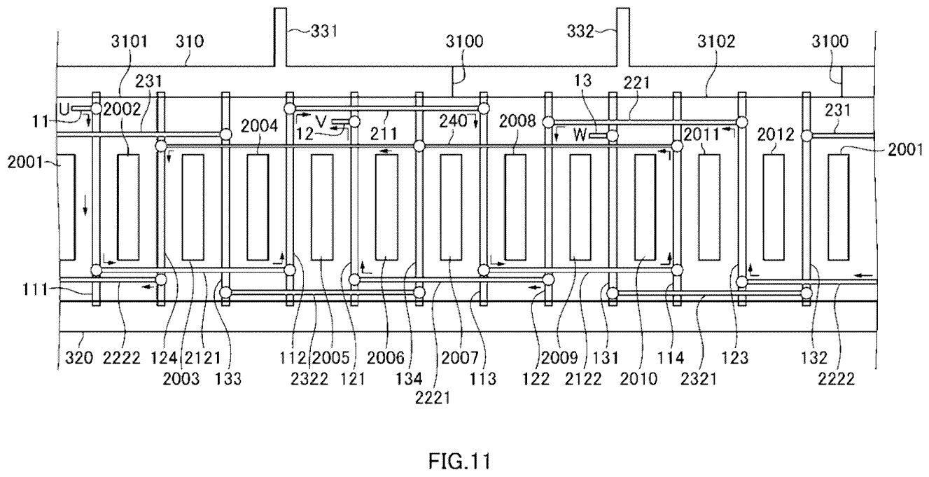

FIG. 11 is a drawing for explaining a flow of electricity from the U-phase line to the V-phase line in the model developed drawing shown in FIG. 9. The arrows indicate the flow direction of the electricity.

First, a case where the electricity flows from the U-phase line 11 to the V-phase line 12 will be explained.

The electricity entering from the U phase line 11 flows as follows: U phase line 11→U-phase first conductive tube 111→U-phase other-end-side first connector 2121→U-phase second conductive tube 112→U-phase one-end-side connector 211→U-phase third conductive tube 113→U-phase other-end-side second connector 2122→U-phase fourth conductive tube 114→neutral line connector 240→V-phase fourth conductive tube 124→V-phase other-end-side second connector 2222→V-phase third conductive tube 123→V-phase one-end-side connector 221→V-phase second conductive tube 122→V-phase other-end-side first connector 2221→V-phase first conductive tube 121→V phase line 12.

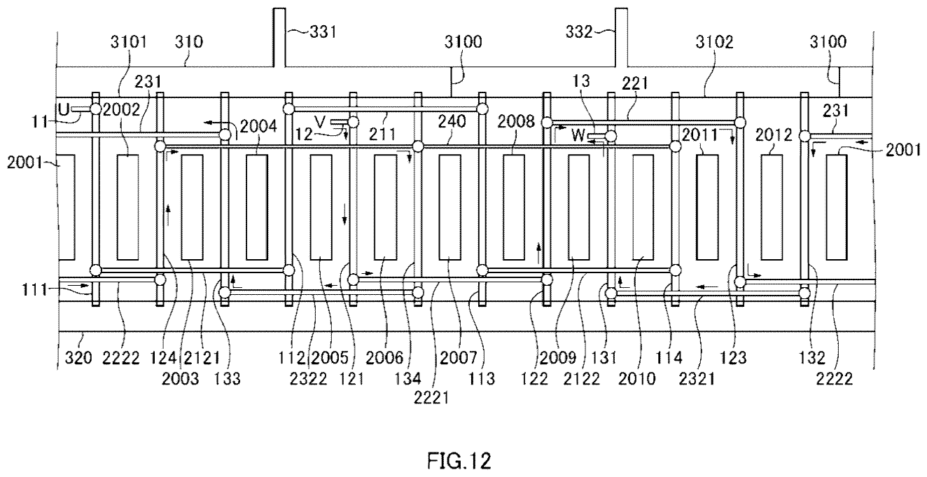

FIG. 12 is a drawing for explaining a flow of electricity from the V-phase line to the W-phase line in the model developed drawing shown in FIG. 9. The arrows indicate the flow direction of the electricity.

Next, a case where the electricity flows from the V-phase line 12 to the W-phase line 13 will be explained.

The electricity entering from the V-phase line 12 flows as follows: V phase line 12→V-phase first conductive tube 121→V-phase other-end-side first connector 2221→V-phase second conductive tube 122→V-phase one-end-side connector 221→V-phase third conductive tube 123→V-phase other-end-side second connector 2222→V-phase fourth conductive tube 124→neutral line connector 240→W-phase fourth conductive tube 134→W-phase other-end-side second connector 2322→W-phase third conductive tube 133→W-phase one-end-side connector 231→W-phase second conductive tube 132→W-phase other-end-side first connector 2321→W-phase first conductive tube 131→W phase line 13.

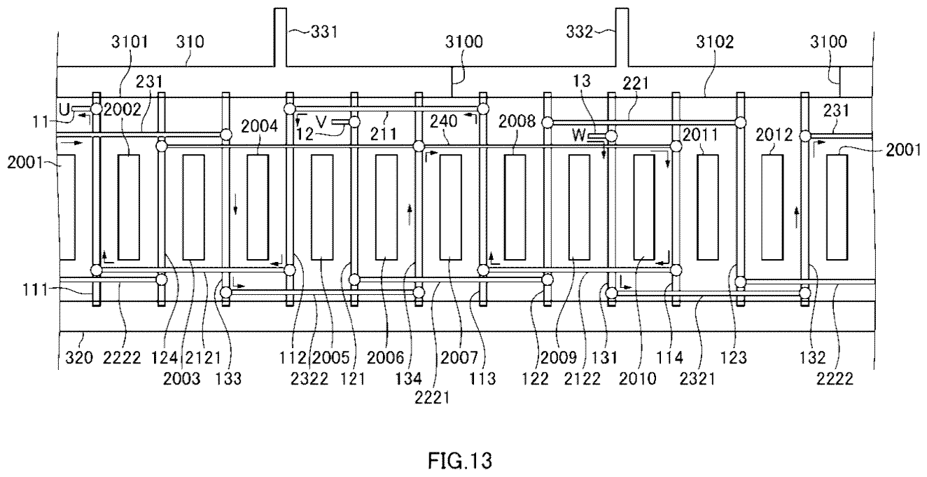

FIG. 13 is a drawing for explaining a flow of electricity from the W-phase line to the U-phase line in the model developed drawing shown in FIG. 9. The arrows indicate the flow direction of the electricity.

Next, a case where the electricity flows from the W-phase line 13 to the U-phase line 11 will be explained.

The electricity entering from the W-phase line 13 flows as follows: W phase line 13→W-phase first conductive tube 131→W-phase other-end-side first connector 2321→W-phase second conductive tube 132→W-phase one-end-side connector 231→W-phase third conductive tube 133→W-phase other-end-side second connector 2322→W-phase fourth conductive tube 134→neutral line connector 240→U-phase fourth conductive tube 114→U-phase other-end-side second connector 2122→U-phase third conductive tube 113→U-phase one-end-side connector 211→U-phase second conductive tube 112→U-phase other-end-side first connector 2121→U-phase first conductive tube 111→U phase line 11.

According to the present embodiment explained above, since the heat medium flows through the inside of each of the conductive tubes, the cooling performance is excellent.

Furthermore, each of the conductive tubes is arranged in the space (slot) between the teeth of the stator core 20, and one end of each of the conductive tubes is inserted into a hole formed in one heat medium flow member 310 while the other end is inserted into a hole formed in the other heat medium flow member 320. Thus, the conductive tubes are held. With the above described configuration, it is unnecessary to wind a conductor around the teeth as in a general rotating electrical machine. Thus, the productivity is excellent.

Furthermore, the heat medium is supplied from the first heat medium flow tube 331 provided on one heat medium flow member 310, flows from the first heat medium flow compartment 3101 through one of the conductive tubes to reach the other heat medium flow member 320, flows through the other conductive tube, reaches the second heat medium flow compartment 3102 of one heat medium flow member 310, and is discharged from the second heat medium flow tube 332. As described above, since both the supply location and the discharge location of the heat medium are provided on one heat medium flow member 310, the mountability when the rotating electrical machine of the present embodiment is attached to device is excellent.

### Second Embodiment

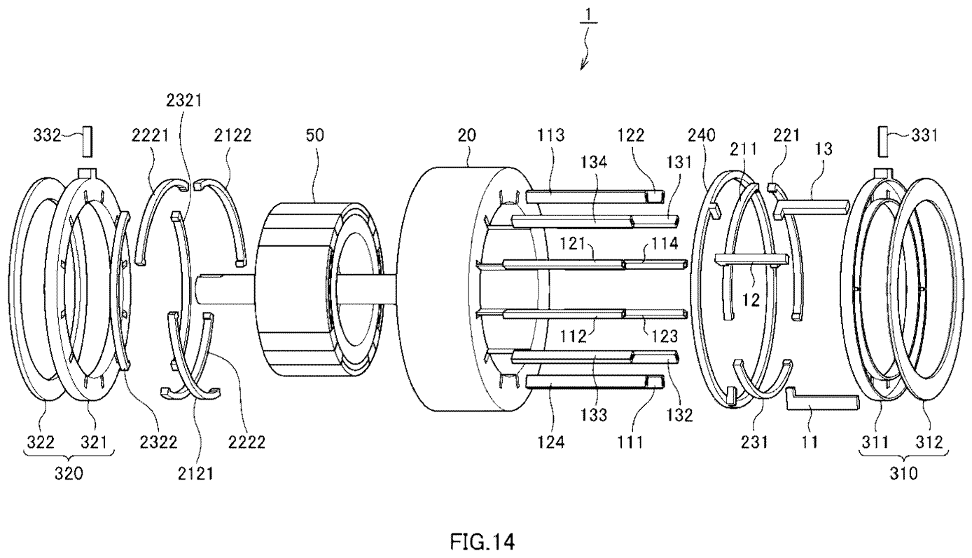

FIG. 14 is an exploded view showing the second embodiment of the rotating electrical machine.

In the following explanation, the same reference numerals are assigned to the components having the same functions as those described above, and redundant descriptions will be appropriately omitted.

The second embodiment differs from the first embodiment in the shapes of one heat medium flow member 310 and the other heat medium flow member 320.

Namely, in one heat medium flow member 310 of the first embodiment, the inside is divided into two by a pair of partition portions 3100. However, there is no partition portion in one heat medium flow member 310 of this second embodiment. In the second embodiment, although the first heat medium flow tube 331 through which the heat medium flows is connected to one heat medium flow member 310, the second heat medium flow tube 332 through which the heat medium flows is not connected to one heat medium flow member 310.

The second heat medium flow tube 332 is connected to the other heat medium flow member 320.

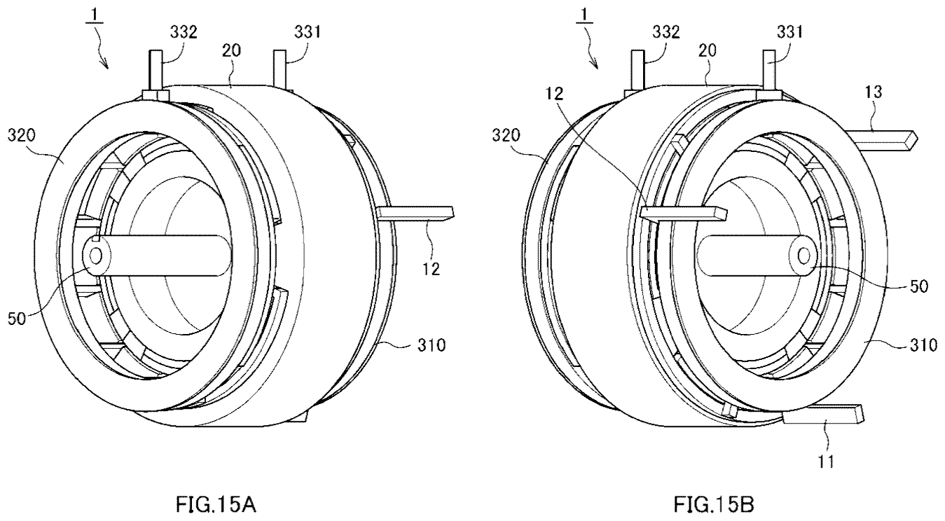

FIGS. 15A and 15B are assembly drawing of the rotating electrical machine shown in FIG. 14. FIG. 15A is viewed obliquely from the left. FIG. 15B is viewed obliquely from the right.

As can be seen from FIG. 15A, the other heat medium flow member 320 is provided with the second heat medium flow tube 332. As can be seen from FIG. 15B, one heat medium flow member 310 is provided with the first heat medium flow tube 331.

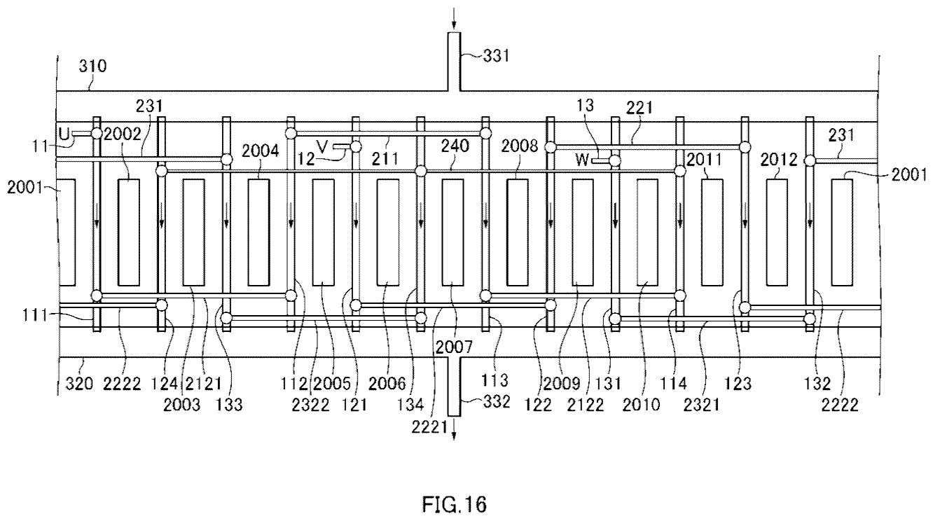

FIG. 16 is a developed drawing modeled on the rotating electrical machine shown in FIG. 14. The arrows indicate the flow direction of the heat medium.

The conductive tubes are arranged in the spaces (slots) between the teeth of the stator core 20. The arrangement order of the teeth and the conductive tubes, the connection configuration of the connectors and the like are the same as those of the first embodiment. Thus, the explanation of them will be omitted.

One heat medium flow member 310 is arranged above (on one end side of) the stator core 20. The first heat medium flow tube 331 for supplying or discharging the heat medium is connected to one heat medium flow member 310. The second heat medium flow tube 332 for discharging or supplying the heat medium is connected to the other heat medium flow member 320.

The heat medium supplied from the first heat medium flow tube 331 flows from one heat medium flow member 310 through any one of the U-phase first conductive tube 111, the V-phase fourth conductive tube 124, the W-phase third conductive tube 133, the U-phase second conductive tube 112, the V-phase first conductive tube 121, the W-phase fourth conductive tube 134, the U-phase third conductive tube 113, the V-phase second conductive tube 122, the W-phase first conductive tube 131, the U-phase fourth conductive tube 114, the V-phase third conductive tube 123 and the W-phase second conductive tube 132, reaches the other heat medium flow member 320, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

As explained above, also in the second embodiment, since the heat medium flows through the inside of each of the conductive tubes, the cooling performance is excellent. In particular, in the second embodiment, the heat medium is supplied from the first heat medium flow tube 331 provided on one heat medium flow member 310, flows from the first heat medium flow compartment 3101 through one of the conductive tubes, reaches the other heat medium flow member 320, and is discharged from the second heat medium flow tube 332. As described above, since the flow distance of the heat medium is short, the cooling performance is further excellent compared to the first embodiment.

Furthermore, since all the heat medium flows in one direction (from top to bottom in FIG. 16), the flow resistance of the heat medium is small and the output of heat medium supply device such as a pump can be kept low.

### Third Embodiment

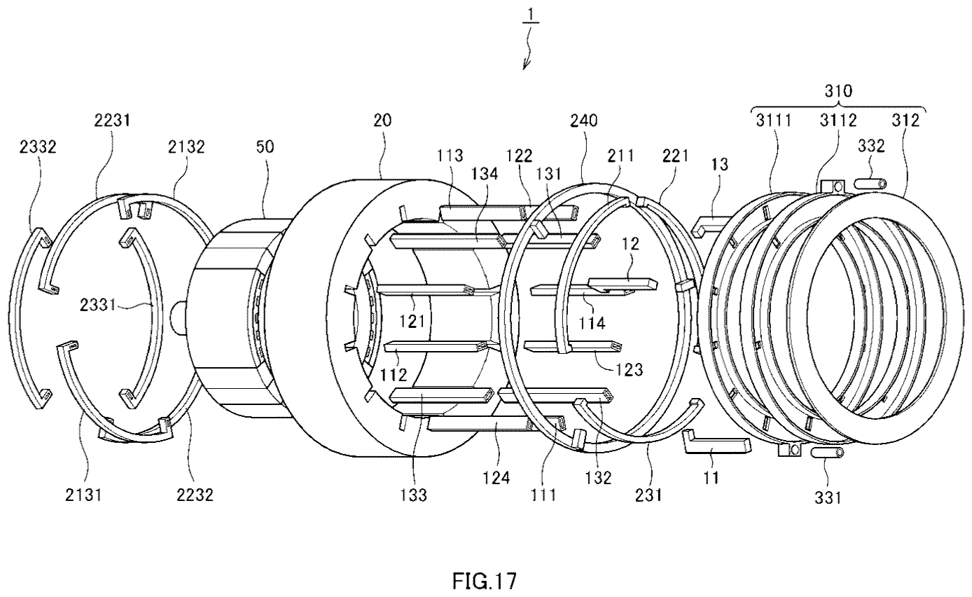

FIG. 17 is an exploded view showing the third embodiment of the rotating electrical machine.

In the first embodiment and the second embodiment described above, one heat medium flow member 310 and the other heat medium flow member 320 are arranged on both sides of the stator core 20. In contrast, in the third embodiment, the heat medium flow member 310 is arranged only on one side of the stator core 20 and no heat medium flow member is arranged on the other side. The other ends of each of the conductive tubes are connected by connector tubes.

The heat medium flow member 310 includes a first main body portion 3111, a second main body portion 3112 and a lid portion 312. The flow paths are formed in the first main body portion 3111 and the second main body portion 3112 so that the heat medium flows through the flow paths. The first heat medium flow tube 331 for supplying or discharging the heat medium is connected to the first main body portion 3111. The second heat medium flow tube 332 for discharging or supplying the heat medium is connected to the second main body portion 3112. The second main body portion 3112 is liquid-tightly fixed to the first main body portion 3111 so that the heat medium flowing through the flow path of the first main body portion 3111 does not leak to the outside. The lid portion 312 is liquid-tightly fixed to the second main body portion 3112 so that the heat medium flowing through the flow path of the second main body portion 3112 does not leak to the outside.

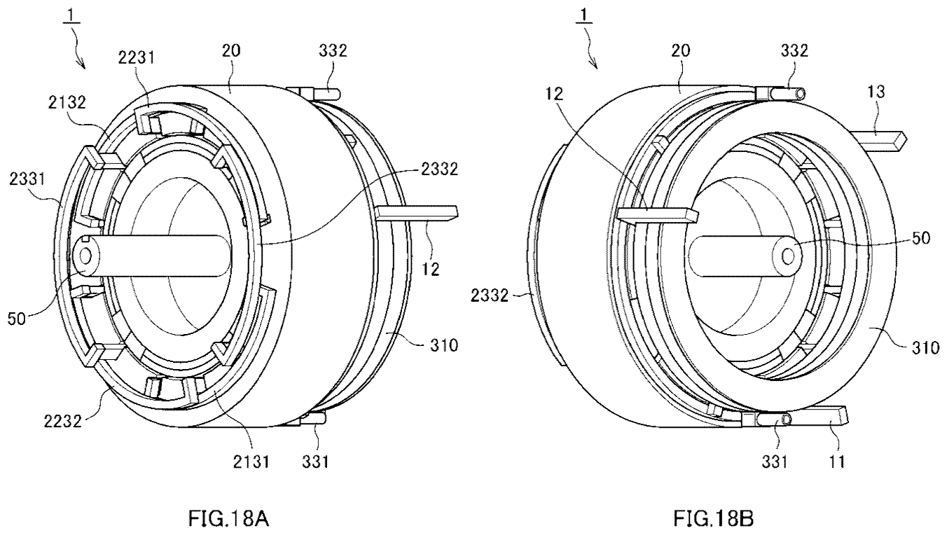

FIGS. 18A and 18B are assembly drawings of the rotating electrical machine shown in FIG. 17. FIG. 18A is viewed obliquely from the left. FIG. 18B is viewed obliquely from the right.

As can be seen from FIG. 18A, the other ends of each of the conductive tubes are connected by connector tubes 2131, 2132, . . . . As can be seen from FIG. 18B, the heat medium flow member 310 is provided with the first heat medium flow tube 331 and the second heat medium flow tube 332. Details will be described later.

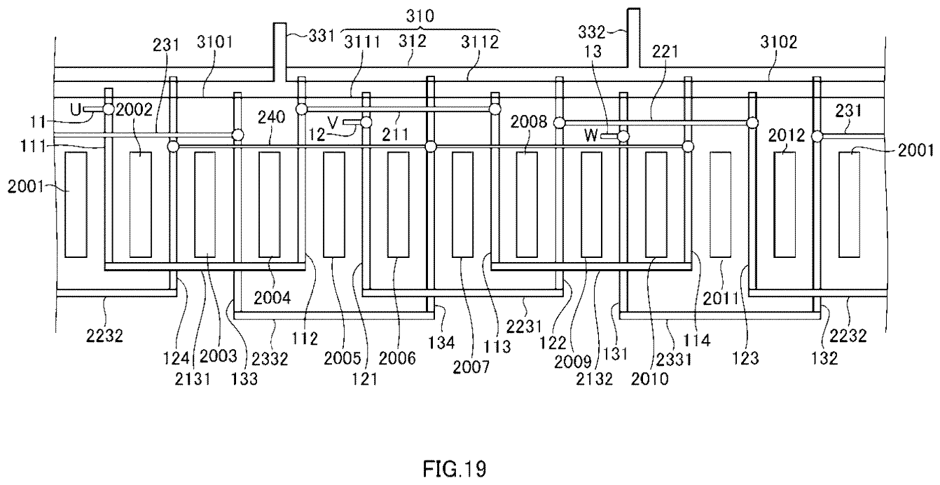

FIG. 19 is a developed drawing modeled on the rotating electrical machine shown in FIG. 17.

The conductive tubes are arranged in the spaces (slots) between the teeth of the stator core 20. The arrangement order of the teeth and the conductive tubes is the same as that of the first embodiment. Thus, the explanation of this will be omitted.

The heat medium flow member 310 is arranged above (on one end side of) the stator core 20. The heat medium flow member 310 includes a first main body portion 3111, a second main body portion 3112 and a lid portion 312. The second main body portion 3112 is liquid-tightly fixed to the first main body portion 3111 so that the heat medium flowing through the flow path of the first main body portion 3111 does not leak to the outside. The lid portion 312 is liquid-tightly fixed to the second main body portion 3112 so that the heat medium flowing through the flow path of the second main body portion 3112 does not leak to the outside. With the above described structure, the flow path formed inside the heat medium flow member 310 is divided into two upper and lower tiers so that the heat medium flows through the flow path. The first heat medium flow tube 331 for supplying or discharging the heat medium is connected to one compartment on the first main body portion 3111 side (first heat medium flow compartment 3101). The second heat medium flow tube 332 for discharging or supplying the heat medium is connected to the other compartment on the second main body portion 3112 side (second heat medium flow compartment 3102).

Twelve holes are formed in the bottom surface of the first main body portion 3111. Six holes are formed in the second main body portion 3112.

One ends of the U-phase first conductive tube 111, the W-phase third conductive tube 133, the V-phase first conductive tube 121, the U-phase third conductive tube 113, the W-phase first conductive tube 131 and the V-phase third conductive tube 123 are inserted into the holes formed in the bottom surface of the first main body portion 3111.

One ends of the V-phase fourth conductive tube 124, the U-phase second conductive tube 112, the W-phase fourth conductive tube 134, the V-phase second conductive tube 122, the U-phase fourth conductive tube 114 and the W-phase second conductive tube 132 are inserted into the holes formed in the bottom surface of the first main body portion 3111 and further inserted into the holes formed in the second main body portion 3112.

The U-phase line 11 is connected to one end side of the U-phase first conductive tube 111. The U-phase line 11 is a solid conductor. A U-phase other-end-side first connector tube 2131 is connected to the other end of the U-phase first conductive tube 111 and the other end of the U-phase second conductive tube 112. With the above described configuration, the U-phase first conductive tube 111 and the U-phase second conductive tube 112 can be electrically conducted and the heat medium can flow through the U-phase first conductive tube 111 and the U-phase second conductive tube 112.

The U-phase connector 211 is connected to one end side of the U-phase second conductive tube 112 and one end side of the U-phase third conductive tube 113 so that the U-phase second conductive tube 112 and the U-phase third conductive tube 113 are electrically conducted.

A U-phase other-end-side second connector tube 2132 is connected to the other end of the U-phase third conductive tube 113 and the other end of the U-phase fourth conductive tube 114. With the above described configuration, the U-phase third conductive tube 113 and the U-phase fourth conductive tube 114 can be electrically conducted and the heat medium can flow through the U-phase third conductive tube 113 and the U-phase fourth conductive tube 114.

The V-phase line 12 is connected to one end side of the V-phase first conductive tube 121. The V-phase line 12 is a solid conductor. A V-phase other-end-side first connector tube 2231 is connected to the other end of the V-phase first conductive tube 121 and the other end of the V-phase second conductive tube 122. With the above described configuration, the V-phase first conductive tube 121 and the V-phase second conductive tube 122 can be electrically conducted and the heat medium can flow through the V-phase first conductive tube 121 and the V-phase second conductive tube 122.

The V-phase connector 221 is connected to one end side of the V-phase second conductive tube 122 and one end side of the V-phase third conductive tube 123 so that the V-phase second conductive tube 122 and the V-phase third conductive tube 123 are electrically conducted.

A V-phase other-end-side second connector tube 2232 is connected to the other end of the V-phase third conductive tube 123 and the other end of the V-phase fourth conductive tube 124. With the above described configuration, the V-phase third conductive tube 123 and the V-phase fourth conductive tube 124 can be electrically conducted and the heat medium can flow through the V-phase third conductive tube 123 and the V-phase fourth conductive tube 124.

The W-phase line 13 is connected to one end side of the W-phase first conductive tube 131. The W-phase line 13 is a solid conductor. A W-phase other-end-side first connector tube 2331 is connected to the other end of the W-phase first conductive tube 131 and the other end of the W-phase second conductive tube 132. With the above described configuration, the W-phase first conductive tube 131 and the W-phase second conductive tube 132 can be electrically conducted and the heat medium can flow through the W-phase first conductive tube 131 and the W-phase second conductive tube 132.

The W-phase connector 231 is connected to one end side of the W-phase second conductive tube 132 and one end side of the W-phase third conductive tube 133 so that the W-phase second conductive tube 132 and the W-phase third conductive tube 133 are electrically conducted.

A W-phase other-end-side second connector tube 2332 is connected to the other end of the W-phase third conductive tube 133 and the other end of the W-phase fourth conductive tube 134. With the above described configuration, the W-phase third conductive tube 133 and the W-phase fourth conductive tube 134 can be electrically conducted and the heat medium can flow through the W-phase third conductive tube 133 and the W-phase fourth conductive tube 134.

The neutral line connector 240 is connected to one end side of the U-phase fourth conductive tube 114, one end side of the V-phase fourth conductive tube 124 and one end side of the W-phase fourth conductive tube 134 so that the U-phase fourth conductive tube 114, the V-phase fourth conductive tube 124 and the W-phase fourth conductive tube 134 are electrically conducted.

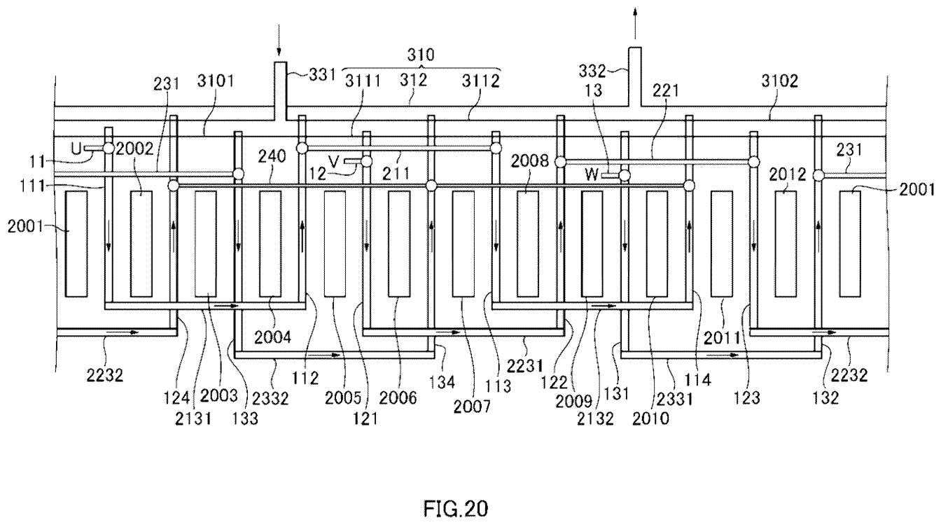

FIG. 20 is a drawing for explaining a flow of a heat medium in the model developed drawing shown in FIG. 19.

The heat medium supplied from the first heat medium flow tube 331 flows from the first heat medium flow compartment 3101 as the first flow through U-phase first conductive tube 111→U-phase other-end-side first connector tube 2321→U-phase second conductive tube 112, and reaches the second heat medium flow compartment 3102.

As the second flow, the heat medium flows through: U-phase third conductive tube 113→U-phase other-end-side second connector tube 2132→U-phase fourth conductive tube 114, and reaches the second heat medium flow compartment 3102.

As the third flow, the heat medium flows through: V-phase first conductive tube 121→V-phase other-end-side first connector tube 2231→V-phase second conductive tube 122, and reaches the second heat medium flow compartment 3102.

As the fourth flow, the heat medium flows through: V-phase third conductive tube 123→V-phase other-end-side second connector tube 2232→V-phase fourth conductive tube 124, and reaches the second heat medium flow compartment 3102.

As the fifth flow, the heat medium flows through: W-phase first conductive tube 131→W-phase other-end-side first connector tube 2331→W-phase second conductive tube 132, and reaches the second heat medium flow compartment 3102.

As the sixth flow, the heat medium flows through: W-phase third conductive tube 133→W-phase other-end-side second connector tube 2332→W-phase fourth conductive tube 134, and reaches the second heat medium flow compartment 3102.

The heat medium reaches the second heat medium flow compartment 3102 in the above described manner and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

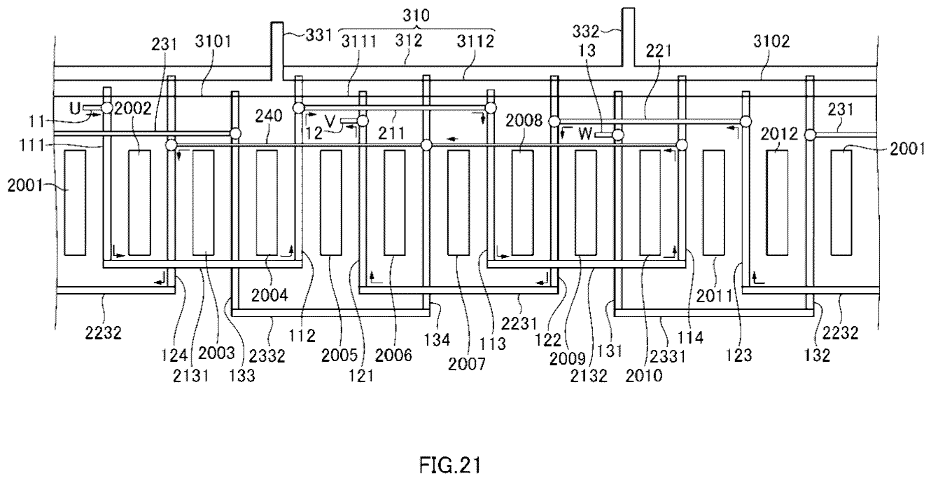

FIG. 21 is a drawing for explaining a flow of electricity from the U-phase line to the V-phase line in the model developed drawing shown in FIG. 19. The arrows indicate the flow direction of the electricity.

First, a case where the electricity flows from the U-phase line 11 to the V-phase line 12 will be explained.

The electricity entering from the U-phase line 11 flows as follows: U phase line 11→U-phase first conductive tube 111→U-phase other-end-side first connector tube 2321→U-phase second conductive tube 112→U-phase connector 211→U-phase third conductive tube 113→U-phase other-end-side second connector tube 2132→U-phase fourth conductive tube 114→neutral line connector 240→V-phase fourth conductive tube 124→V-phase other-end-side second connector tube 2232→V-phase third conductive tube 123→V-phase connector 221→V-phase second conductive tube 122→V-phase other-end-side first connector tube 2231→V-phase first conductive tube 121→V phase line 12.

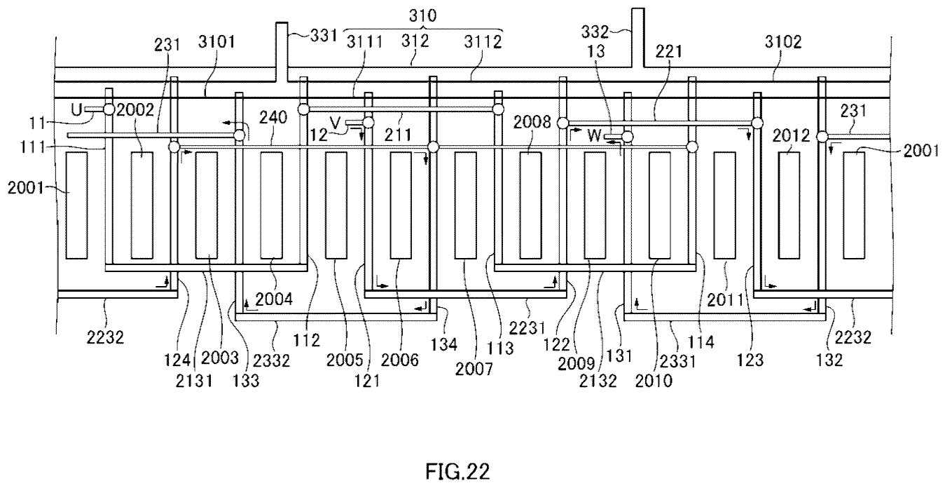

FIG. 22 is a drawing for explaining a flow of electricity from the V-phase line to the W-phase line in the model developed drawing shown in FIG. 19. The arrows indicate the flow direction of the electricity.

Next, a case where the electricity flows from the V-phase line 12 to the W-phase line 13 will be explained.

The electricity entering from the V-phase line 12 flows as follows: V phase line 12→V-phase first conductive tube 121→V-phase other-end-side first connector tube 2231→V-phase second conductive tube 122→V-phase connector 221→V-phase third conductive tube 123→V-phase other-end-side second connector tube 2232→V-phase fourth conductive tube 124→neutral line connector 240→W-phase fourth conductive tube 134→W-phase other-end-side second connector tube 2332→W-phase third conductive tube 133→W-phase connector 231→W-phase second conductive tube 132→W-phase other-end-side connector tube 2331→W-phase first conductive tube 131→W phase line 13.

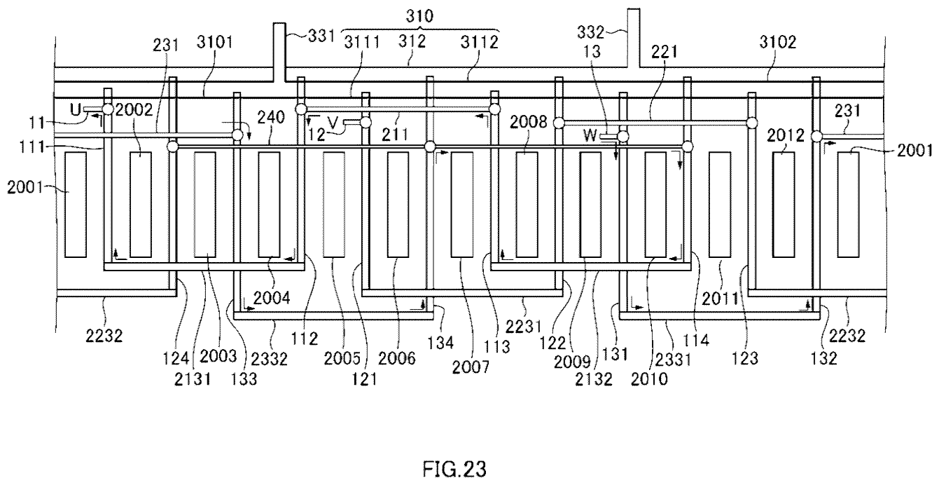

FIG. 23 is a drawing for explaining a flow of electricity from the W-phase line to the U-phase line in the model developed drawing shown in FIG. 19. The arrows indicate the flow direction of the electricity.

Next, a case where the electricity flows from the W-phase line 13 to the U-phase line 11 will be explained.

The electricity entering from the W-phase line 13 flows as follows: W phase line 13→W-phase first conductive tube 131→W-phase other-end-side connector tube 2331→W-phase second conductive tube 132→W-phase connector 231→W-phase third conductive tube 133→W-phase other-end-side second connector tube 2332→W-phase fourth conductive tube 134→neutral line connector 240→U-phase fourth conductive tube 114→U-phase other-end-side second connector tube 2132→U-phase third conductive tube 113→U-phase connector 211→U-phase second conductive tube 112→U-phase other-end-side first connector tube 2321→U-phase first conductive tube 111→U phase line 11.

As explained above, also in the third embodiment, since the heat medium flows through the inside of each of the conductive tubes, the cooling performance is excellent.

Furthermore, in the first embodiment and the second embodiment, one heat medium flow member 310 and the other heat medium flow member 320 are arranged on both sides of the stator core 20. In contrast, in the third embodiment, the heat medium flow member is arranged only on one side of the stator core 20, and no heat medium flow member is arranged on the other side. With the above described configuration, the size is compact.

Furthermore, since both the supply location and the discharge location of the heat medium are provided on the heat medium flow member, the mountability when the rotating electrical machine of the present embodiment is attached to the device is excellent.

Furthermore, in the first embodiment, the heat medium supplied from the first heat medium flow tube 331 passes from the first heat medium flow compartment 3101 of one heat medium flow member 310 through one of the conductive tubes to reach the other heat medium flow member 320, and passes through one of the conductive tubes to reach the second heat medium flow compartment 3102 of one heat medium flow member 310. At this time, in the other heat medium flow member 320, there is a possibility that the flows of the heat medium interfere with each other and the heat medium do not flow smoothly.

In contrast, in the third embodiment, since the heat medium flows in one direction inside the connector tubes, the flow resistance of the heat medium is small, and the output of heat medium supply device such as a pump can be kept low.

### Fourth Embodiment

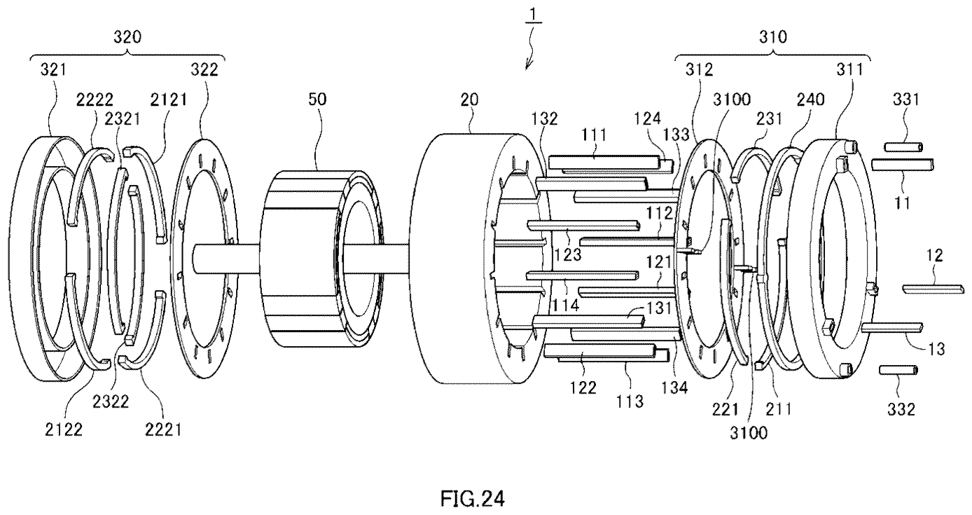

FIG. 24 is an exploded view showing the fourth embodiment of the rotating electrical machine.

In each of the embodiments described above, each connector is connected to the conductive tube protruding from the stator core 20. The end portion of the conductive tube is inserted into the hole formed in the bottom surface of the heat medium flow member. Namely, each connector is arranged between the stator core 20 and the heat medium flow member.

In contrast, in the fourth embodiment, each connector is arranged inside the heat medium flow member.

Namely, the heat medium flow member 310 includes a cover 311 and a bottom plate 312. The cover 311 is made of metal (e.g., aluminum). The bottom plate 312 is made of, for example, resin and has insulating properties. Twelve holes are formed in the bottom plate 312. In addition, a pair of partition portions 3100 is formed. The end portions of the conductive tube are inserted into the holes of the bottom plate 312, and each connector is connected to the conductive tube protruding from the bottom plate 312. The cover 311 is fixed to the bottom plate 312.

The heat medium flow member 320 includes a cover 321 and a bottom plate 322. The cover 321 is made of metal (e.g., aluminum). The bottom plate 322 is made of, for example, resin and has insulating properties. Twelve holes are formed in the bottom plate 322. The end portions of the conductive tube are inserted into the holes of the bottom plate 322, and each connector is connected to the conductive tube protruding from the bottom plate 322. Then, the cover 321 is fixed to the bottom plate 322.

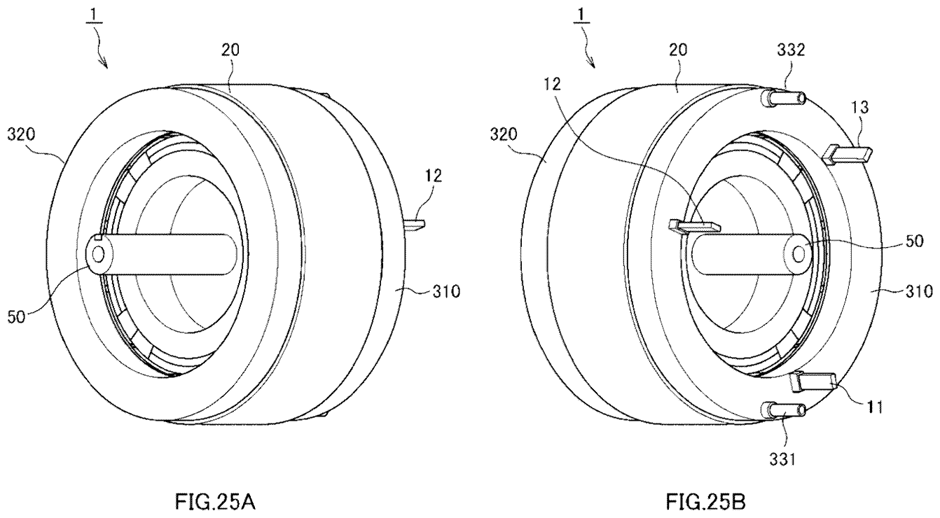

FIGS. 25A and 25B are assembly drawings of the rotating electrical machine shown in FIG. 24. FIG. 25A is viewed obliquely from the left. FIG. 25B is viewed obliquely from the right.

As can be seen from FIGS. 25A and 25B, the heat medium flow members are arranged on both sides of the stator core 20, and each connector is not visible. As can be seen from FIG. 25B, the heat medium flow member is provided with the first heat medium flow tube 331 and the second heat medium flow tube 332.

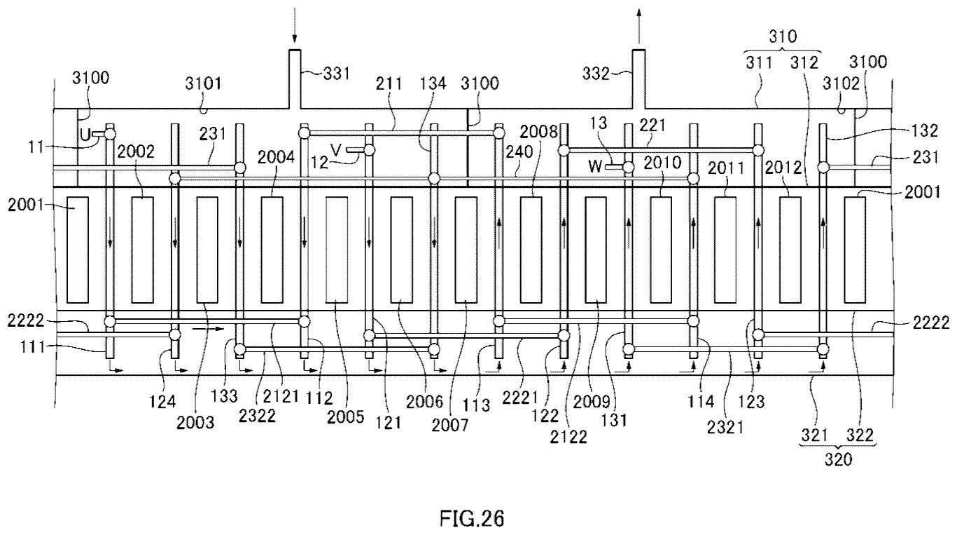

FIG. 26 is a developed drawing modeled on the rotating electrical machine shown in FIG. 24. The arrows indicate the flow direction of the heat medium.

The conductive tubes are arranged in the spaces (slots) between the teeth of the stator core 20. One end of each conductive tube is inserted into a hole formed in the bottom plate 312 of one heat medium flow member 310. Each connector is connected to the conductive tube protruding from the bottom plate 312. The cover 311 is fixed to the bottom plate 312. The other end of each conductive tube is inserted into a hole formed in the bottom plate 322 of the other heat medium flow member 320. Each connector is connected to the conductive tube protruding from the bottom plate 322. The cover 321 is fixed to the bottom plate 322.

The arrangement order of the teeth and the conductive tubes, the connection configuration of the connectors and the like are the same as those of the first embodiment. Thus, the explanation of them will be omitted.

As indicated by the arrows, the heat medium supplied from the first heat medium flow tube 331 flows into the first heat medium flow compartment 3101 of one heat medium flow member 310. Here, the heat medium cools each connector located in the first heat medium flow compartment 3101. The heat medium flows through any one of the U-phase first conductive tube 111, the V-phase fourth conductive tube 124, the W-phase third conductive tube 133, the U-phase second conductive tube 112, the V-phase first conductive tube 121 and the W-phase fourth conductive tube 134, and reaches the other heat medium flow member 320. Here, the heat medium cools each connector located in the other heat medium flow member 320. The heat medium flows through any one of the U-phase third conductive tube 113, the V-phase second conductive tube 122, the W-phase first conductive tube 131, the U-phase fourth conductive tube 114, the V-phase third conductive tube 123 and the W-phase second conductive tube 132, and reaches the second heat medium flow compartment 3102 of one heat medium flow member 310. Here, the heat medium cools each connector located in the second heat medium flow compartment 3102. The heat medium is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

The flow of the electricity is basically the same as that of the first embodiment. Thus, the explanation of this will be omitted here.

According to the fourth embodiment described above, since each connector is arranged inside the heat medium flow member, each connector is cooled by the heat medium flowing through the heat medium flow member. Thus, the cooling performance is excellent.

Furthermore, since each connector is arranged inside the heat medium flow member and is not exposed, a situation in which foreign matter enters between the connectors can be avoided. Thus, the maintainability is excellent.

### Fifth Embodiment

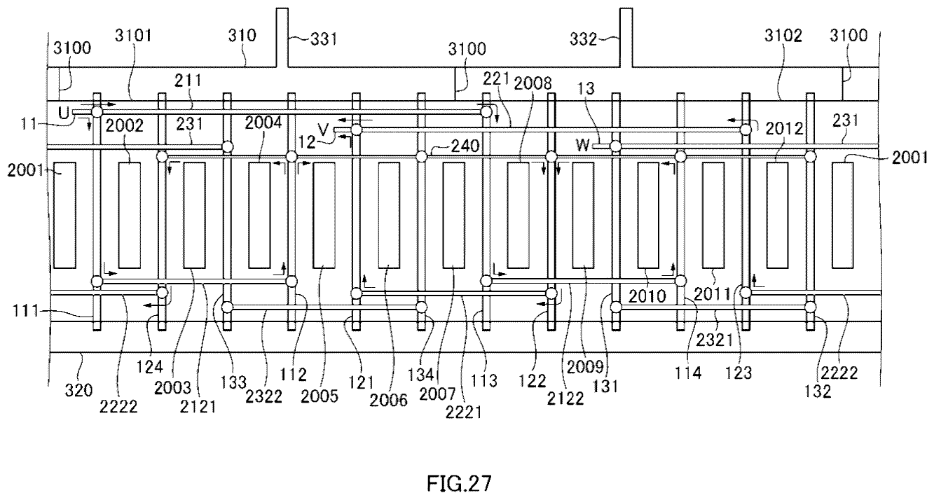

FIG. 27 is a developed drawing modeled on the rotating electrical machine of the fifth embodiment.

The rotating electrical machine of the fifth embodiment differs from the rotating electrical machine of the first embodiment in the connection of the conductive tubes by the connectors. The arrangement order of the teeth and the conductive tubes is the same as that of the first embodiment. Thus, the explanation of this will be omitted. In addition, the configurations of the heat medium flow member, the flow manner of the heat medium and the like are the same as those of the first embodiment. Thus, the explanation of them will be omitted.

The U-phase line 11 is connected to one end side of the U-phase first conductive tube 111. In addition, the U-phase one-end-side connector 211 is connected to one end side of the U-phase first conductive tube 111 and one end side of the U-phase third conductive tube 113 so that the U-phase first conductive tube 111 and the U-phase third conductive tube 113 are electrically conducted.

The U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

The U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

The V-phase line 12 is connected to one end side of the V-phase first conductive tube 121. In addition, a V-phase one-end-side connector 221 is connected to one end side of the V-phase first conductive tube 121 and one end side of the V-phase third conductive tube 123 so that the V-phase first conductive tube 121 and the V-phase third conductive tube 123 are electrically conducted.

The V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

The V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

The W-phase line 13 is connected to one end side of the W-phase first conductive tube 131. In addition, the W-phase one-end-side connector 231 is connected to one end side of the W-phase first conductive tube 131 and one end side of the W-phase third conductive tube 133 so that the W-phase first conductive tube 131 and the W-phase third conductive tube 133 are electrically conducted.

The W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

The W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

The neutral line connector 240 is connected to one end side of the U-phase second conductive tube 112, one end side of the U-phase fourth conductive tube 114, one end side of the V-phase second conductive tube 122, one end side of the V-phase fourth conductive tube 124, one end side of the W-phase second conductive tube 132 and one end side of the W-phase fourth conductive tube 134 so that the U-phase second conductive tube 112, the U-phase fourth conductive tube 114, the V-phase second conductive tube 122, the V-phase fourth conductive tube 124, the W-phase second conductive tube 132 and the W-phase fourth conductive tube 134 are electrically conducted.

Next, the flow of the electricity from the U-phase line to the V-phase line will be explained. The arrows indicate the flow direction of the electricity.

The electricity entering from the U-phase line 11 branches into two. In the first embodiment and the like, the electricity flows from the U-phase line to the V-phase line without branching, and this is a series connection type. In contrast, in the fifth embodiment, the electricity branches and then merges, and this is a parallel connection type.

One branched flow proceeds as follows: U-phase one-end-side connector 211→U-phase third conductive tube 113→U-phase other-end-side second connector 2122→U-phase fourth conductive tube 114→neutral line connector 240→V-phase second conductive tube 122→V-phase other-end-side first connector 2221→V-phase first conductive tube 121→V phase line 12.

Another flow proceeds as follows: U-phase first conductive tube 111→U-phase other-end-side first connector 2121→U-phase second conductive tube 112→neutral line connector 240, and branches into two.

One branch proceeds as follows: V-phase second conductive tube 122→V-phase other-end-side first connector 2221→V-phase first conductive tube 121→V phase line 12.

The other branch proceeds as follows: V-phase fourth conductive tube 124→V-phase other-end-side second connector 2222→V-phase third conductive tube 123→V-phase one-end-side connector 221→V phase line 12.

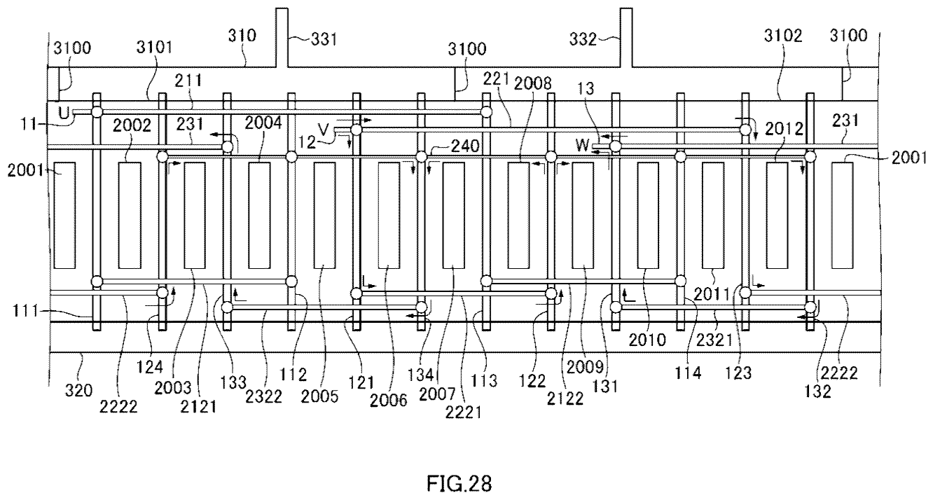

FIG. 28 is a drawing for explaining a flow of electricity from the V-phase line to the W-phase line in the model developed drawing shown in FIG. 27. The arrows indicate the flow direction of the electricity.

Next, a case where the electricity flows from the V-phase line 12 to the W-phase line 13 will be explained.

The electricity entering from the V-phase line 12 branches into two.

One flow proceeds as follows: V-phase one-end-side connector 221→V-phase third conductive tube 123→V-phase other-end-side second connector 2222→V-phase fourth conductive tube 124→neutral line connector 240→W-phase fourth conductive tube 134→W-phase other-end-side second connector 2322→W-phase third conductive tube 133→W-phase one-end-side connector 231→W phase line 13.

Another flow proceeds as follows: V-phase first conductive tube 121→V-phase other-end-side first connector 2221→V-phase second conductive tube 122→neutral line connector 240, and branches into two.

One branch proceeds as follows: W-phase second conductive tube 132→W-phase other-end-side first connector 2321→W-phase first conductive tube 131→W phase line 13.

Another branch proceeds as follows: W-phase fourth conductive tube 134→W-phase other-end-side second connector 2322→W-phase third conductive tube 133→W-phase one-end-side connector 231→W phase line 13.

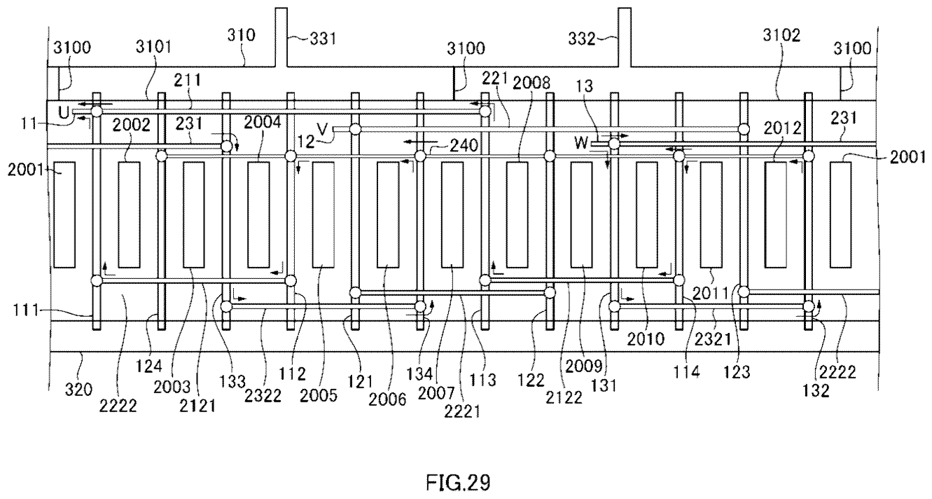

FIG. 29 is a drawing for explaining a flow of electricity from the W-phase line to the U-phase line in the model developed drawing shown in FIG. 27. The arrows indicate the flow direction of the electricity.

Next, a case where the electricity flows from the W-phase line 13 to the U-phase line 11 will be explained.

The electricity entering from the W-phase line 13 branches into two.

One flow proceeds as follows: W-phase one-end-side connector 231→W-phase third conductive tube 133→W-phase other-end-side second connector 2322→W-phase fourth conductive tube 134→neutral line connector 240→U-phase second conductive tube 112→U-phase other-end-side first connector 2121→U-phase first conductive tube 111→U phase line 11.

Another flow proceeds as follows: W-phase first conductive tube 131→W-phase other-end-side first connector 2321→W-phase second conductive tube 132→neutral line connector 240, and branches into two.

One branch proceeds as follows: U-phase second conductive tube 112→U-phase other-end-side first connector 2121→U-phase first conductive tube 111→U phase line 11.

The other branch proceeds as follows: U-phase fourth conductive tube 114→U-phase other-end-side second connector 2122→U-phase third conductive tube 113→U-phase one-end-side connector 211→U phase line 11.

Also in the fifth embodiment described above, since the heat medium flows through the inside of each conductive tube, the cooling performance is excellent.

If the current values are the same, the type of the fifth embodiment (parallel connection type) generates ¼ the amount of heat compared to the series connection type like the first embodiment. When the voltage and the output are the same, the rotational speed must be twice in the parallel connection type compared to the series connection type. Thus, the motor length must be doubled and actually the amount of heat generated becomes about ½ to achieve the same rotational speed. If twice the rotational speed compared to the series connection type is acceptable, the amount of the generated heat becomes ¼ at the same voltage, same output and motor length. As described above, the amount of the generated heat can be kept low. Conversely, this also means that twice the current can flow with the same motor size and weight although the rotational speed is doubled.

### Sixth Embodiment

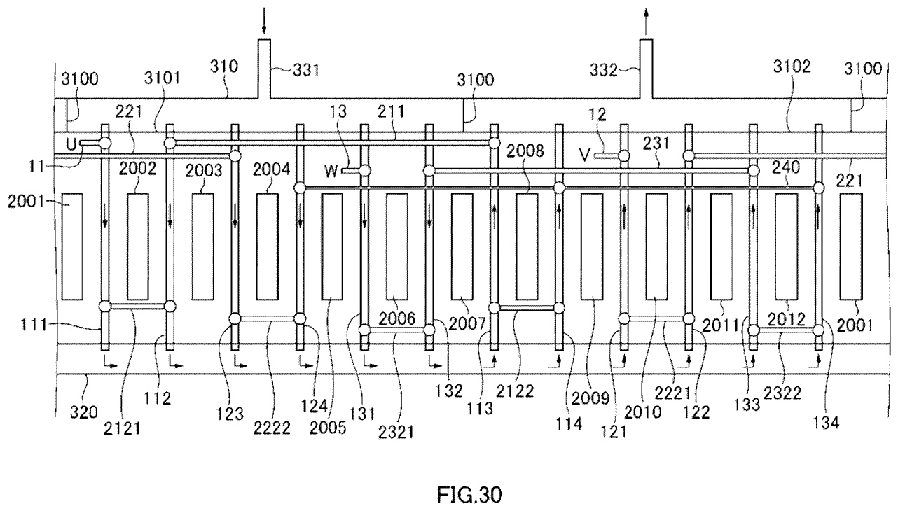

FIG. 30 is a developed drawing modeled on the rotating electrical machine of the sixth embodiment.

All the rotating electrical machines of each of the embodiments described above are 12N4P type rotating electrical machines in which twelve conductive tubes are arranged in the spaces (slots) between the teeth and a 4-pole type rotor is used.

In contrast, the rotating electrical machine of the sixth embodiment is a 12N8P type rotating electrical machine in which twelve conductive tubes are arranged in the spaces (slots) between the teeth and an 8-pole type rotor is used. As a specific configuration, compared to the rotating electrical machine of the first embodiment, the arrangement order of the conductive tubes is different, and the connection of the conductive tubes by the connectors is different.

A plurality of teeth is protruded from the inner peripheral wall of the base portion of the stator core 20. As shown in FIG. 30, there are a first tooth 2001, a second tooth 2002, a third tooth 2003, a fourth tooth 2004, a fifth tooth 2005, a sixth tooth 2006, a seventh tooth 2007, an eighth tooth 2008, a ninth tooth 2009, a tenth tooth 2010, an eleventh tooth 2011, a twelfth tooth 2012 from the left.

The conductive tubes are arranged in the spaces (slots) between the respective teeth.

A U-phase first conductive tube 111 is arranged in the space (slot) between the first tooth 2001 and the second tooth 2002. A U-phase second conductive tube 112 is arranged in the space (slot) between the second tooth 2002 and the third tooth 2003. A V-phase third conductive tube 123 is arranged in the space (slot) between the third tooth 2003 and the fourth tooth 2004. A V-phase fourth conductive tube 124 is arranged in the space (slot) between the fourth tooth 2004 and the fifth tooth 2005. A W-phase first conductive tube 131 is arranged in the space (slot) between the fifth tooth 2005 and the sixth tooth 2006. A W-phase second conductive tube 132 is arranged in the space (slot) between the sixth tooth 2006 and the seventh tooth 2007. A U-phase third conductive tube 113 is arranged in the space (slot) between the seventh tooth 2007 and the eighth tooth 2008. A U-phase fourth conductive tube 114 is arranged in the space (slot) between the eighth tooth 2008 and the ninth tooth 2009. A V-phase first conductive tube 121 is arranged in the space (slot) between the ninth tooth 2009 and the tenth tooth 2010. A V-phase second conductive tube 122 is arranged in the space (slot) between the tenth tooth 2010 and the eleventh tooth 2011. A W-phase third conductive tube 133 is arranged in the space (slot) between the eleventh tooth 2011 and the twelfth tooth 2012. A W-phase fourth conductive tube 134 is arranged in the space (slot) between the twelfth tooth 2012 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Twelve holes are formed in the bottom surface of one heat medium flow member 310. Six holes are formed in the first heat medium flow compartment 3101. The remaining six holes are formed in the second heat medium flow compartment 3102.

One ends of the U-phase first conductive tube 111, the U-phase second conductive tube 112, the V-phase third conductive tube 123, the V-phase fourth conductive tube 124, the W-phase first conductive tube 131 and the W-phase second conductive tube 132 are inserted into the holes formed in the first heat medium flow compartment 3101.

One ends of the U-phase third conductive tube 113, the U-phase fourth conductive tube 114, the V-phase first conductive tube 121, the V-phase second conductive tube 122, the W-phase third conductive tube 133 and the W-phase fourth conductive tube 134 are inserted into the holes formed in the second heat medium flow compartment 3102.

The other heat medium flow member 320 is arranged below (on the other end side of) the stator core 20. Twelve holes are formed in the bottom surface of the other heat medium flow member 320. The other ends of the U-phase first conductive tube 111, the U-phase second conductive tube 112, the V-phase third conductive tube 123, the V-phase fourth conductive tube 124, the W-phase first conductive tube 131, the W-phase second conductive tube 132, the U-phase third conductive tube 113, the U-phase fourth conductive tube 114, the V-phase first conductive tube 121, the V-phase second conductive tube 122, the W-phase third conductive tube 133 and the W-phase fourth conductive tube 134 are inserted into the holes.

The U-phase line 11 is connected to one end side of the U-phase first conductive tube 111. The U-phase line 11 is a solid conductor. The U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

The U-phase one-end-side connector 211 is connected to one end side of the U-phase second conductive tube 112 and one end side of the U-phase third conductive tube 113 so that the U-phase second conductive tube 112 and the U-phase third conductive tube 113 are electrically conducted.

The U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

The V-phase line 12 is connected to one end side of the V-phase first conductive tube 121. The V-phase line 12 is a solid conductor. The V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

The V-phase one-end-side connector 221 is connected to one end side of the V-phase second conductive tube 122 and one end side of the V-phase third conductive tube 123 so that the V-phase second conductive tube 122 and the V-phase third conductive tube 123 are electrically conducted.

The V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

The W-phase line 13 is connected to one end side of the W-phase first conductive tube 131. The W-phase line 13 is a solid conductor. The W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

The W-phase one-end-side connector 231 is connected to one end side of the W-phase second conductive tube 132 and one end side of the W-phase third conductive tube 133 so that the W-phase second conductive tube 132 and the W-phase third conductive tube 133 are electrically conducted.

The W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

The neutral line connector 240 is connected to one end side of the U-phase fourth conductive tube 114, one end side of the V-phase fourth conductive tube 124 and one end side of the W-phase fourth conductive tube 134 so that the U-phase fourth conductive tube 114, the V-phase fourth conductive tube 124 and the W-phase fourth conductive tube 134 are electrically conducted.

### Flow of Heat Medium

In FIG. 30, the arrows indicate the flow direction of the heat medium. The heat medium supplied from the first heat medium flow tube 331 flows from the first heat medium flow compartment 3101 of one heat medium flow member 310 through any one of the U-phase first conductive tube 111, the U-phase second conductive tube 112, the V-phase third conductive tube 123, the V-phase fourth conductive tube 124, the W-phase first conductive tube 131 and the W-phase second conductive tube 132, and reaches the other heat medium flow member 320.

The heat medium flows through any one of the U-phase third conductive tube 113, the U-phase fourth conductive tube 114, the V-phase first conductive tube 121, the V-phase second conductive tube 122, the W-phase third conductive tube 133 and the W-phase fourth conductive tube 134, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However a pattern where the heat medium is supplied from the second heat medium flow tube 332 and discharged from the first heat medium flow tube 331 may also be used.

Next, the flow of the electricity from the U-phase line to the V-phase line will be explained.

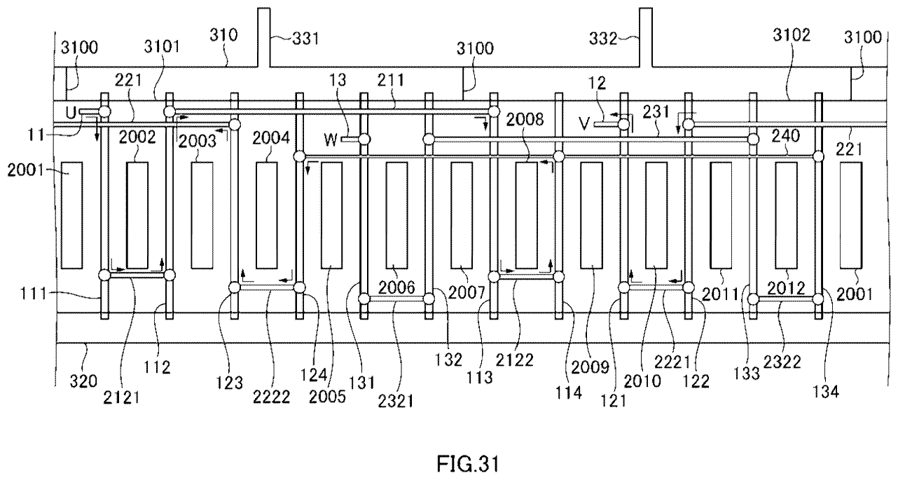

FIG. 31 is a drawing for explaining a flow of electricity from the U-phase line to the V-phase line in the model developed drawing shown in FIG. 30. The arrows indicate the flow direction of the electricity.

The electricity entering from the U-phase line 11 flows as follows: U phase line 11→U-phase first conductive tube 111→U-phase other-end-side first connector 2121→U-phase second conductive tube 112→U-phase one-end-side connector 211→U-phase third conductive tube 113→U-phase other-end-side second connector 2122→U-phase fourth conductive tube 114→neutral line connector 240→V-phase fourth conductive tube 124→V-phase other-end-side second connector 2222→V-phase third conductive tube 123→V-phase one-end-side connector 221→V-phase second conductive tube 122→V-phase other-end-side first connector 2221→V-phase first conductive tube 121→V phase line 12.

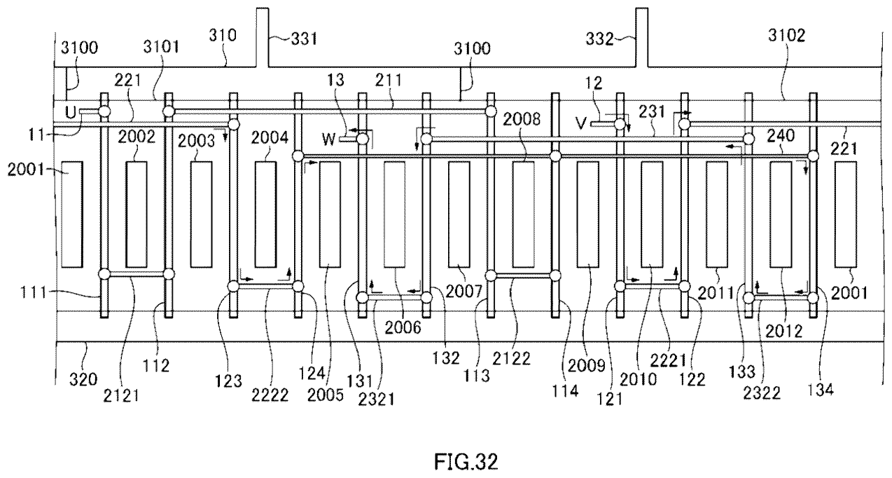

FIG. 32 is a drawing for explaining a flow of electricity from the V-phase line to the W-phase line in the model developed drawing shown in FIG. 30. The arrows indicate the flow direction of the electricity.

Next, a case where the electricity flows from the V-phase line 12 to the W-phase line 13 will be explained.

The electricity entering from the V-phase line 12 flows as follows: V phase line 12→V-phase first conductive tube 121→V-phase other-end-side first connector 2221→V-phase second conductive tube 122→V-phase one-end-side connector 221→V-phase third conductive tube 123→V-phase other-end-side second connector 2222→V-phase fourth conductive tube 124→neutral line connector 240→W-phase fourth conductive tube 134→W-phase other-end-side second connector 2322→W-phase third conductive tube 133→W-phase one-end-side connector 231→W-phase second conductive tube 132→W-phase other-end-side first connector 2321→W-phase first conductive tube 131→W phase line 13.

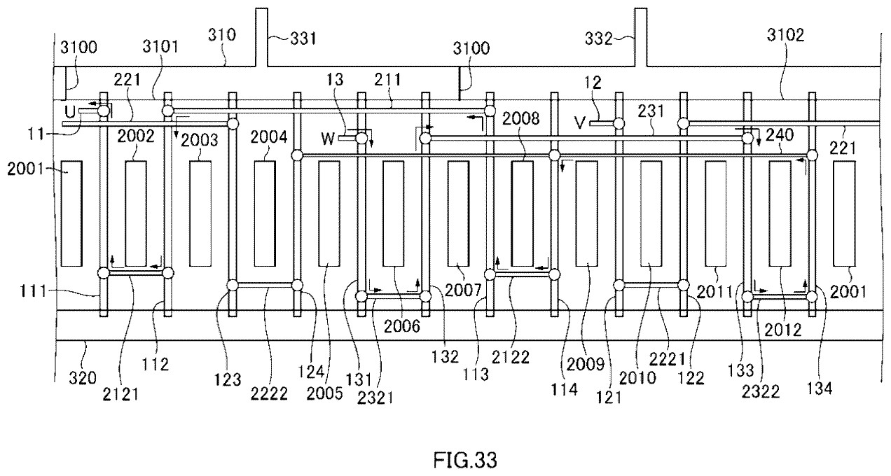

FIG. 33 is a drawing for explaining a flow of electricity from the W-phase line to the U-phase line in the model developed view shown in FIG. 30. The arrows indicate the flow direction of the electricity.

Next, a case where the electricity flows from the W-phase line 13 to the U-phase line 11 will be explained.

The electricity entering from the W-phase line 13 flows as follows: W phase line 13→W-phase first conductive tube 131→W-phase other-end-side first connector 2321→W-phase second conductive tube 132→W-phase one-end-side connector 231→W-phase third conductive tube 133→W-phase other-end-side second connector 2322→W-phase fourth conductive tube 134→neutral line connector 240→U-phase fourth conductive tube 114→U-phase other-end-side second connector 2122→U-phase third conductive tube 113→U-phase one-end-side connector 211→U-phase second conductive tube 112→U-phase other-end-side first connector 2121→U-phase first conductive tube 111→U phase line 11.

By configuring as in the present embodiment described above, even in a 12N8P type rotating electrical machine, the heat medium can flow through the inside of each conductive tube, and the cooling performance is excellent.

### Seventh Embodiment

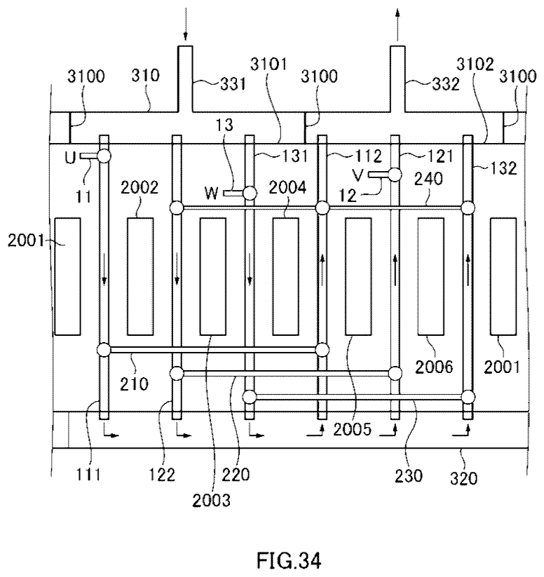

FIG. 34 is a developed drawing modeled on the rotating electrical machine of the seventh embodiment.

The rotating electrical machine of the seventh embodiment is a 6N2P type rotating electrical machine in which six conductive tubes are arranged in the spaces (slots) between the teeth and a 2-pole type rotor is used.

A plurality of teeth is protruded from the inner peripheral wall of the base portion of the stator core 20. As shown in FIG. 34, there are a first tooth 2001, a second tooth 2002, a third tooth 2003, a fourth tooth 2004, a fifth tooth 2005 and a sixth tooth 2006 from the left.

The conductive tubes are arranged in the spaces (slots) between the respective teeth. A U-phase first conductive tube 111 is arranged in the space (slot) between the first tooth 2001 and the second tooth 2002. A V-phase second conductive tube 122 is arranged in the space (slot) between the second tooth 2002 and the third tooth 2003. A W-phase first conductive tube 131 is arranged in the space (slot) between the third tooth 2003 and the fourth tooth 2004. A U-phase second conductive tube 112 is arranged in the space (slot) between the fourth tooth 2004 and the fifth tooth 2005. A V-phase first conductive tube 121 is arranged in the space (slot) between the fifth tooth 2005 and the sixth tooth 2006. A W-phase second conductive tube 132 is arranged in the space (slot) between the sixth tooth 2006 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Six holes are formed in the bottom surface of one heat medium flow member 310. Three holes are formed in the first heat medium flow compartment 3101. The remaining three holes are formed in the second heat medium flow compartment 3102.

One ends of the U-phase first conductive tube 111, the V-phase second conductive tube 122 and the W-phase first conductive tube 131 are inserted into the holes formed in the first heat medium flow compartment 3101.

One ends of the U-phase second conductive tube 112, the V-phase first conductive tube 121 and the W-phase second conductive tube 132 are inserted into the holes formed in the second heat medium flow compartment 3102.

The other heat medium flow member 320 is arranged below (on the other end side of) the stator core 20. Six holes are formed in the bottom surface of the other heat medium flow member 320. The other ends of the U-phase first conductive tube 111, the V-phase second conductive tube 122, the W-phase first conductive tube 131, the U-phase second conductive tube 112, the V-phase first conductive tube 121 and the W-phase second conductive tube 132 are inserted into the holes.

The U-phase line 11 is connected to one end side of the U-phase first conductive tube 111. The U-phase line 11 is a solid conductor. A U-phase connector 210 is connected to the other end side of the U-phase first conductive tube 111 and the other end side of the U-phase second conductive tube 112 so that the U-phase first conductive tube 111 and the U-phase second conductive tube 112 are electrically conducted.

The V-phase line 12 is connected to one end side of the V-phase first conductive tube 121. The V-phase line 12 is a solid conductor. The V-phase connector 220 is connected to the other end side of the V-phase first conductive tube 121 and the other end side of the V-phase second conductive tube 122 so that the V-phase first conductive tube 121 and the V-phase second conductive tube 122 are electrically conducted.

The W-phase line 13 is connected to one end side of the W-phase first conductive tube 131. The W-phase line 13 is a solid conductor. The W-phase connector 230 is connected to the other end side of the W-phase first conductive tube 131 and the other end side of the W-phase second conductive tube 132 so that the W-phase first conductive tube 131 and the W-phase second conductive tube 132 are electrically conducted.

The neutral line connector 240 is connected to one end side of the U-phase second conductive tube 112, one end side of the V-phase second conductive tube 122 and one end side of the W-phase second conductive tube 132 so that the U-phase second conductive tube 112, the V-phase second conductive tube 122 and the W-phase second conductive tube 132 are electrically conducted.

### Flow of Heat Medium

In FIG. 34, the arrows indicate the flow direction of the heat medium. The heat medium supplied from the first heat medium flow tube 331 flows from the first heat medium flow compartment 3101 of one heat medium flow member 310 through any one of the U-phase first conductive tube 111, the V-phase second conductive tube 122 and the W-phase first conductive tube 131, and reaches the other heat medium flow member 320. The heat medium flows through any one of the U-phase second conductive tube 112, the V-phase first conductive tube 121 and the W-phase second conductive tube 132, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

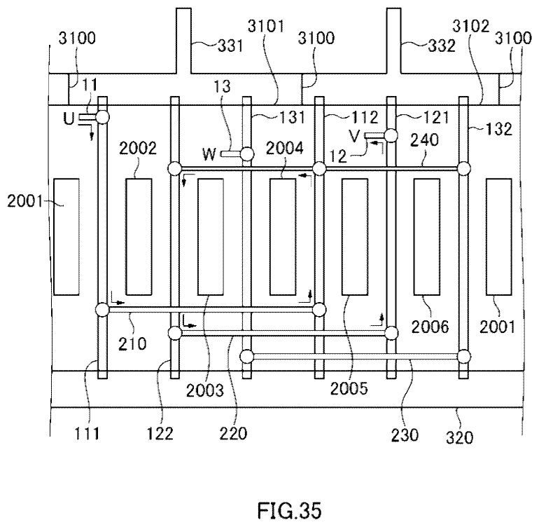

FIG. 35 is a drawing for explaining a flow of electricity from the U-phase line to the V-phase line in the model developed drawing shown in FIG. 34. The arrows indicate the flow direction of the electricity.

First, the flow of the electricity from the U-phase line to the V-phase line will be explained.

The electricity entering from the U-phase line 11 flows as follows: U phase line 11→U-phase first conductive tube 111→U-phase connector 210→U-phase second conductive tube 112→neutral line connector 240→V-phase second conductive tube 122→V-phase connector 220→V-phase first conductive tube 121→V phase line 12.

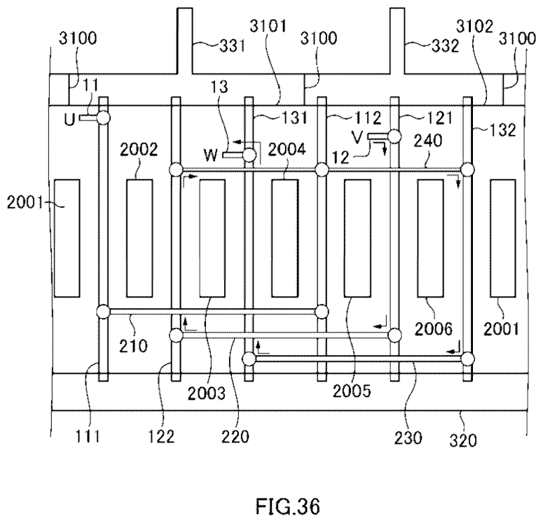

FIG. 36 is a drawing for explaining a flow of electricity from the V-phase line to the W-phase line in the model developed drawing shown in FIG. 34. The arrows indicate the flow direction of the electricity.

Next, a case where the electricity flows from the V-phase line 12 to the W-phase line 13 will be explained.

The electricity entering from the V-phase line 12 flows as follows: V phase line 12→V-phase first conductive tube 121→V-phase connector 220→V-phase second conductive tube 122→neutral line connector 240→W-phase second conductive tube 132→W-phase connector 230→W-phase first conductive tube 131→W phase line 13.

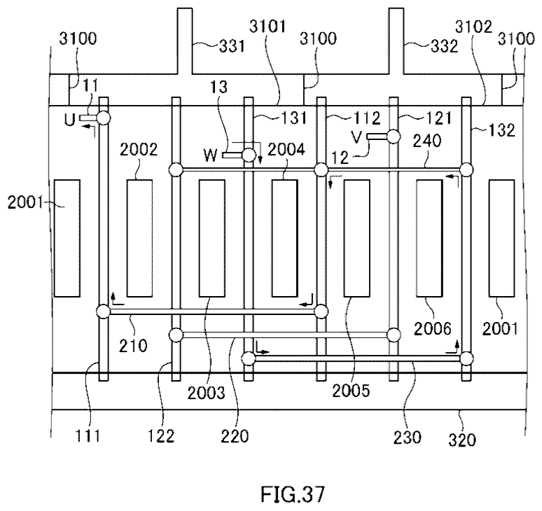

FIG. 37 is a drawing for explaining a flow of electricity from the W-phase line to the U-phase line in the model developed drawing shown in FIG. 34. The arrows indicate the flow direction of the electricity.

Next, a case where the electricity flows from the W-phase line 13 to the U-phase line 11 will be explained.

The electricity entering from the W-phase line 13 flows as follows: W phase line 13→W-phase first conductive tube 131→W-phase connector 230→W-phase second conductive tube 132→neutral line connector 240→U-phase second conductive tube 112→U-phase connector 210→U-phase first conductive tube 111→U phase line 11.

By configuring as in the present embodiment described above, even in a 6N2P type rotating electrical machine, the heat medium can flow through the inside of each conductive tube, and the cooling performance is excellent.

### Eighth Embodiment

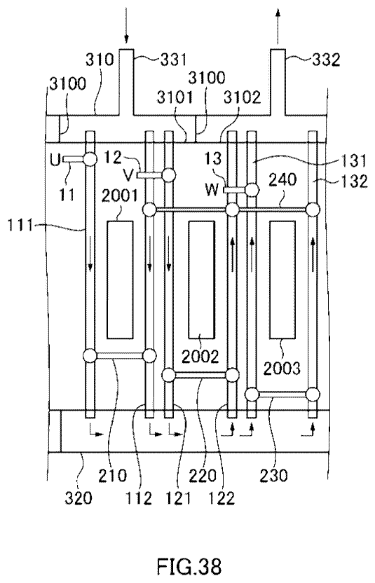

FIG. 38 is a developed drawing modeled on the rotating electrical machine of the eighth embodiment.

The rotating electrical machine of the eighth embodiment is a 3N2P type rotating electrical machine in which the conductive tubes are arranged in the spaces (slots) between three teeth and a 2-pole type rotor is used.

A plurality of teeth is protruded from the inner peripheral wall of the base portion of the stator core 20. As shown in FIG. 38, there are a first tooth 2001, a second tooth 2002 and a third tooth 2003 from the left.

The conductive tubes are arranged in the spaces (slots) between the respective teeth.

A U-phase second conductive tube 112 and a V-phase first conductive tube 121 are arranged in the space (slot) between the first tooth 2001 and the second tooth 2002. In FIG. 38, the U-phase second conductive tube 112 is arranged on the first tooth 2001 side and the V-phase first conductive tube 121 is arranged on the second tooth 2002 side. Conversely, the V-phase first conductive tube 121 may be arranged on the first tooth 2001 side and the U-phase second conductive tube 112 may be arranged on the second tooth 2002 side. However, from the viewpoint of efficiency, it is desirable that the U-phase second conductive tube 112 is arranged on the first tooth 2001 side and the V-phase first conductive tube 121 is arranged on the second tooth 2002 side as shown in FIG. 38. The same applies hereinafter.

A V-phase second conductive tube 122 and a W-phase first conductive tube 131 are arranged in the space (slot) between the second tooth 2002 and the third tooth 2003.

A W-phase second conductive tube 132 and a U-phase first conductive tube 111 are arranged in the space (slot) between the third tooth 2003 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Six holes are formed in the bottom surface of one heat medium flow member 310. Three holes are formed in the first heat medium flow compartment 3101. The remaining three holes are formed in the second heat medium flow compartment 3102.

One ends of the U-phase first conductive tube 111, the U-phase second conductive tube 112 and the V-phase first conductive tube 121 are inserted into the holes formed in the first heat medium flow compartment 3101.

One ends of the V-phase second conductive tube 122, the W-phase first conductive tube 131 and the W-phase second conductive tube 132 are inserted into the holes formed in the second heat medium flow compartment 3102.

The other heat medium flow member 320 is arranged below (on the other end side of) the stator core 20. Six holes are formed in the bottom surface of the other heat medium flow member 320. The other ends of the U-phase first conductive tube 111, the U-phase second conductive tube 112, the V-phase first conductive tube 121, the V-phase second conductive tube 122, the W-phase first conductive tube 131 and the W-phase second conductive tube 132 are inserted into the holes.

The U-phase line 11 is connected to one end side of the U-phase first conductive tube 111. The U-phase line 11 is a solid conductor. The U-phase connector 210 is connected to the other end side of the U-phase first conductive tube 111 and the other end side of the U-phase second conductive tube 112 so that the U-phase first conductive tube 111 and the U-phase second conductive tube 112 are electrically conducted.

The V-phase line 12 is connected to one end side of the V-phase first conductive tube 121. The V-phase line 12 is a solid conductor. The V-phase connector 220 is connected to the other end side of the V-phase first conductive tube 121 and the other end side of the V-phase second conductive tube 122 so that the V-phase first conductive tube 121 and the V-phase second conductive tube 122 are electrically conducted.

The W-phase line 13 is connected to one end side of the W-phase first conductive tube 131. The W-phase line 13 is a solid conductor. The W-phase connector 230 is connected to the other end side of the W-phase first conductive tube 131 and the other end side of the W-phase second conductive tube 132 so that the W-phase first conductive tube 131 and the W-phase second conductive tube 132 are electrically conducted.

The neutral line connector 240 is connected to one end side of the U-phase second conductive tube 112, one end side of the V-phase second conductive tube 122 and one end side of the W-phase second conductive tube 132 so that the U-phase second conductive tube 112, the V-phase second conductive tube 122 and the W-phase second conductive tube 132 are electrically conducted.

### Flow of Heat Medium

In FIG. 38, the arrows indicate the flow direction of the heat medium. The heat medium supplied from the first heat medium flow tube 331 flows from the first heat medium flow compartment 3101 of one heat medium flow member 310 through any one of the U-phase first conductive tube 111, the U-phase second conductive tube 112 and the V-phase first conductive tube 121, and reaches the other heat medium flow member 320. Then, the heat medium flows through any one of the V-phase second conductive tube 122, the W-phase first conductive tube 131 and the W-phase second conductive tube 132, reaches the second heat medium flow compartment 3102 of one heat medium flow member 310, and is discharged from the second heat medium flow tube 332. In the present embodiment, the heat medium is described in a pattern of being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

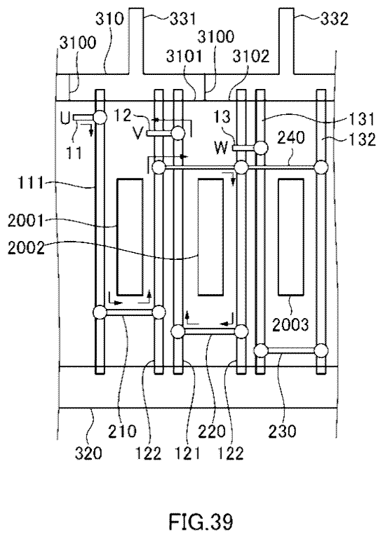

FIG. 39 is a drawing for explaining a flow of electricity from the U-phase line to the V-phase line in the model developed drawing shown in FIG. 38. The arrows indicate the flow direction of the electricity.

First, the flow of the electricity from the U-phase line to the V-phase line will be explained.

The electricity entering from the U-phase line 11 flows as follows: U phase line 11→U-phase first conductive tube 111→U-phase connector 210→U-phase second conductive tube 112→neutral line connector 240→V-phase second conductive tube 122→V-phase connector 220→V-phase first conductive tube 121→V phase line 12.

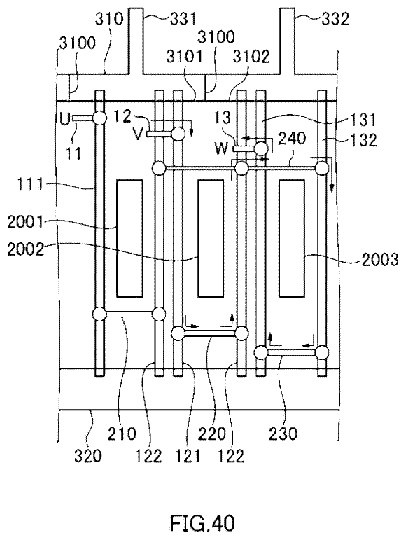

FIG. 40 is a drawing for explaining a flow of electricity from the V-phase line to the W-phase line in the model developed drawing shown in FIG. 38. The arrows indicate the flow direction of the electricity.

Next, a case where the electricity flows from the V-phase line 12 to the W-phase line 13 will be explained.

The electricity entering from the V-phase line 12 flows as follows: V phase line 12→V-phase first conductive tube 121→V-phase connector 220→V-phase second conductive tube 122→neutral line connector 240→W-phase second conductive tube 132→W-phase connector 230→W-phase first conductive tube 131→W phase line 13.

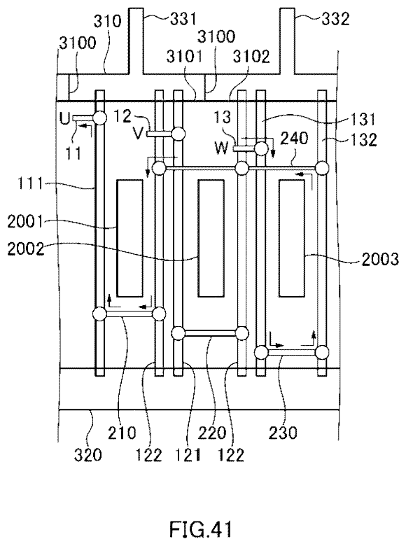

FIG. 41 is a drawing for explaining a flow of electricity from the W-phase line to the U-phase line in the model developed drawing shown in FIG. 38. The arrows indicate the flow direction of the electricity.

Next, a case where the electricity flows from the W-phase line 13 to the U-phase line 11 will be explained.

The electricity entering from the W-phase line 13 flows as follows: W phase line 13→W-phase first conductive tube 131→W-phase connector 230→W-phase second conductive tube 132→neutral line connector 240→U-phase second conductive tube 112→U-phase connector 210→U-phase first conductive tube 111→U phase line 11.

By configuring as in the present embodiment described above, even in a 3N2P type rotating electrical machine, the heat medium can flow through the inside of each conductive tube, and the cooling performance is excellent.

### Ninth Embodiment

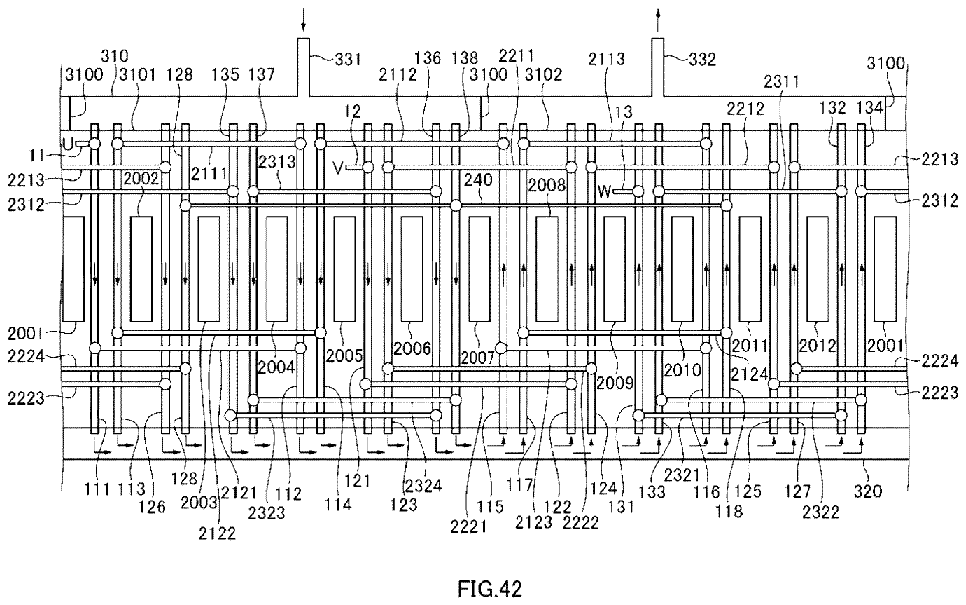

FIG. 42 is a developed drawing modeled on the rotating electrical machine of the ninth embodiment.

The rotating electrical machine of the ninth embodiment is a 12N4P type rotating electrical machine in which the conductive tubes are arranged in the spaces (slots) between 12 teeth and a 4-pole type rotor is used. In addition, each of the above described embodiments is a 1-turn type in which electricity makes only one revolution around the teeth. However the ninth embodiment is a 2-turn type in which electricity makes two revolutions around the teeth.

A plurality of teeth is protruded from the inner peripheral wall of the base portion of the stator core 20. As shown in FIG. 42, there are a first tooth 2001, a second tooth 2002, a third tooth 2003, a fourth tooth 2004, a fifth tooth 2005, a sixth tooth 2006, a seventh tooth 2007, an eighth tooth 2008, a ninth tooth 2009, a tenth tooth 2010, an eleventh tooth 2011 and a twelfth tooth 2012 from the left.

The conductive tubes are arranged in the spaces (slots) between the respective teeth. A U-phase first conductive tube 111 and a U-phase third conductive tube 113 are arranged in the space (slot) between the first tooth 2001 and the second tooth 2002. In FIG. 42, the U-phase first conductive tube 111 is arranged on the first tooth 2001 side and the U-phase third conductive tube 113 is arranged on the second tooth 2002 side. Conversely, the U-phase third conductive tube 113 may be arranged on the first tooth 2001 side and the U-phase first conductive tube 111 may be arranged on the second tooth 2002 side. In addition, the U-phase first conductive tube 111 and the U-phase third conductive tube 113 may be arranged so as to overlap in the front-back direction. The same applies hereinafter. A V-phase sixth conductive tube 126 and a V-phase eighth conductive tube 128 are arranged in the space (slot) between the second tooth 2002 and the third tooth 2003. A W-phase fifth conductive tube 135 and a W-phase seventh conductive tube 137 are arranged in the space (slot) between the third tooth 2003 and the fourth tooth 2004. A U-phase second conductive tube 112 and a U-phase fourth conductive tube 114 are arranged in the space (slot) between the fourth tooth 2004 and the fifth tooth 2005. A V-phase first conductive tube 121 and a V-phase third conductive tube 123 are arranged in the space (slot) between the fifth tooth 2005 and the sixth tooth 2006. A W-phase sixth conductive tube 136 and a W-phase eighth conductive tube 138 are arranged in the space (slot) between the sixth tooth 2006 and the seventh tooth 2007. A U-phase fifth conductive tube 115 and a U-phase seventh conductive tube 117 are arranged in the space (slot) between the seventh tooth 2007 and the eighth tooth 2008. A V-phase second conductive tube 122 and a V-phase fourth conductive tube 124 are arranged in the space (slot) between the eighth tooth 2008 and the ninth tooth 2009. A W-phase first conductive tube 131 and a W-phase third conductive tube 133 are arranged in the space (slot) between the ninth tooth 2009 and the tenth tooth 2010. A U-phase sixth conductive tube 116 and a U-phase eighth conductive tube 118 are arranged in the space (slot) between the tenth tooth 2010 and the eleventh tooth 2011. A V-phase fifth conductive tube 125 and a V-phase seventh conductive tube 127 are arranged in the space (slot) between the eleventh tooth 2011 and the twelfth tooth 2012. A W-phase second conductive tube 132 and a W-phase fourth conductive tube 134 are arranged in the space (slot) between the twelfth tooth 2012 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Twenty-four holes are formed in the bottom surface of one heat medium flow member 310. Twelve holes are formed in the first heat medium flow compartment 3101. The remaining twelve holes are formed in the second heat medium flow compartment 3102.

One ends of the U-phase first conductive tube 111, the U-phase third conductive tube 113, the V-phase sixth conductive tube 126, the V-phase eighth conductive tube 128, the W-phase fifth conductive tube 135, the W-phase seventh conductive tube 137, the U-phase second conductive tube 112, the U-phase fourth conductive tube 114, the V-phase first conductive tube 121, the V-phase third conductive tube 123, the W-phase sixth conductive tube 136 and the W-phase eighth conductive tube 138 are inserted into the holes formed in the first heat medium flow compartment 3101.

One ends of the U-phase fifth conductive tube 115, the U-phase seventh conductive tube 117, the V-phase second conductive tube 122, the V-phase fourth conductive tube 124, the W-phase first conductive tube 131, the W-phase third conductive tube 133, the U-phase sixth conductive tube 116, the U-phase eighth conductive tube 118, the V-phase fifth conductive tube 125, the V-phase seventh conductive tube 127, the W-phase second conductive tube 132 and the W-phase fourth conductive tube 134 are inserted into the holes formed in the second heat medium flow compartment 3102.

The other heat medium flow member 320 is arranged below (on the other end side of) the stator core 20. Twenty-four holes are formed in the bottom surface of the other heat medium flow member 320. The other ends of the U-phase first conductive tube 111, the U-phase third conductive tube 113, the V-phase sixth conductive tube 126, the V-phase eighth conductive tube 128, the W-phase fifth conductive tube 135, the W-phase seventh conductive tube 137, the U-phase second conductive tube 112, the U-phase fourth conductive tube 114, the V-phase first conductive tube 121, the V-phase third conductive tube 123, the W-phase sixth conductive tube 136, the W-phase eighth conductive tube 138, the U-phase fifth conductive tube 115, the U-phase seventh conductive tube 117, the V-phase second conductive tube 122, the V-phase fourth conductive tube 124, the W-phase first conductive tube 131, the W-phase third conductive tube 133, the U-phase sixth conductive tube 116, the U-phase eighth conductive tube 118, the V-phase fifth conductive tube 125, the V-phase seventh conductive tube 127, the W-phase second conductive tube 132 and the W-phase fourth conductive tube 134 are inserted into the holes.

The U-phase line 11 is connected to one end side of the U-phase first conductive tube 111. The U-phase line 11 is a solid conductor. A U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

A U-phase one-end-side first connector 2111 is connected to one end side of the U-phase second conductive tube 112 and one end side of the U-phase third conductive tube 113 so that the U-phase second conductive tube 112 and the U-phase third conductive tube 113 are electrically conducted.

A U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

A U-phase one-end-side second connector 2112 is connected to one end side of the U-phase fourth conductive tube 114 and one end side of the U-phase fifth conductive tube 115 so that the U-phase fourth conductive tube 114 and the U-phase fifth conductive tube 115 are electrically conducted.

A U-phase other-end-side third connector 2123 is connected to the other end side of the U-phase fifth conductive tube 115 and the other end side of the U-phase sixth conductive tube 116 so that the U-phase fifth conductive tube 115 and the U-phase sixth conductive tube 116 are electrically conducted.

A U-phase one-end-side third connector 2113 is connected to one end side of the U-phase sixth conductive tube 116 and one end side of the U-phase seventh conductive tube 117 so that the U-phase sixth conductive tube 116 and the U-phase seventh conductive tube 117 are electrically conducted.

A U-phase other-end-side fourth connector 2124 is connected to the other end side of the U-phase seventh conductive tube 117 and the other end side of the U-phase eighth conductive tube 118 so that the U-phase seventh conductive tube 117 and the U-phase eighth conductive tube 118 are electrically conducted.

The V-phase line 12 is connected to one end side of the V-phase first conductive tube 121. The V-phase line 12 is a solid conductor. A V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

A V-phase one-end-side first connector 2211 is connected to one end side of the V-phase second conductive tube 122 and one end side of the V-phase third conductive tube 123 so that the V-phase second conductive tube 122 and the V-phase third conductive tube 123 are electrically conducted.

A V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

A V-phase one-end-side second connector 2212 is connected to one end side of the V-phase fourth conductive tube 124 and one end side of the V-phase fifth conductive tube 125 so that the V-phase fourth conductive tube 124 and the V-phase fifth conductive tube 125 are electrically conducted.

A V-phase other-end-side third connector 2223 is connected to the other end side of the V-phase fifth conductive tube 125 and the other end side of the V-phase sixth conductive tube 126 so that the V-phase fifth conductive tube 125 and the V-phase sixth conductive tube 126 are electrically conducted.

A V-phase one-end-side third connector 2213 is connected to one end side of the V-phase sixth conductive tube 126 and one end side of the V-phase seventh conductive tube 127 so that the V-phase sixth conductive tube 126 and the V-phase seventh conductive tube 127 are electrically conducted.

A V-phase other-end-side fourth connector 2224 is connected to the other end side of the V-phase seventh conductive tube 127 and the other end side of the V-phase eighth conductive tube 128 so that the V-phase seventh conductive tube 127 and the V-phase eighth conductive tube 128 are electrically conducted.

The W-phase line 13 is connected to one end side of the W-phase first conductive tube 131. The W-phase line 13 is a solid conductor. A W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

A W-phase one-end-side first connector 2311 is connected to one end side of the W-phase second conductive tube 132 and one end side of the W-phase third conductive tube 133 so that the W-phase second conductive tube 132 and the W-phase third conductive tube 133 are electrically conducted.

A W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

A W-phase one-end-side second connector 2312 is connected to one end side of the W-phase fourth conductive tube 134 and one end side of the W-phase fifth conductive tube 135 so that the W-phase fourth conductive tube 134 and the W-phase fifth conductive tube 135 are electrically conducted.

A W-phase other-end-side third connector 2323 is connected to the other end side of the W-phase fifth conductive tube 135 and the other end side of the W-phase sixth conductive tube 136 so that the W-phase fifth conductive tube 135 and the W-phase sixth conductive tube 136 are electrically conducted.

A W-phase one-end-side third connector 2313 is connected to one end side of the W-phase sixth conductive tube 136 and one end side of the W-phase seventh conductive tube 137 so that the W-phase sixth conductive tube 136 and the W-phase seventh conductive tube 137 are electrically conducted.

A W-phase other-end-side fourth connector 2324 is connected to the other end side of the W-phase seventh conductive tube 137 and the other end side of the W-phase eighth conductive tube 138 so that the W-phase seventh conductive tube 137 and the W-phase eighth conductive tube 138 are electrically conducted.

The neutral line connector 240 is connected to one end side of the U-phase eighth conductive tube 118, one end side of the V-phase eighth conductive tube 128, and one end side of the W-phase eighth conductive tube 138 and the U-phase eighth conductive tube 118 so that the V-phase eighth conductive tube 128 and the W-phase eighth conductive tube 138 are electrically conducted.

### Flow of Heat Medium

In FIG. 42, the arrows indicate the flow direction of the heat medium. The heat medium supplied from the first heat medium flow tube 331 flows from the first heat medium flow compartment 3101 of one heat medium flow member 310 through any one of the U-phase first conductive tube 111, the U-phase third conductive tube 113, the V-phase sixth conductive tube 126, the V-phase eighth conductive tube 128, the W-phase fifth conductive tube 135, the W-phase seventh conductive tube 137, the U-phase second conductive tube 112, the U-phase fourth conductive tube 114, the V-phase first conductive tube 121, the V-phase third conductive tube 123, the W-phase sixth conductive tube 136 and the W-phase eighth conductive tube 138, and reaches the other heat medium flow member 320. Then, the heat medium flows through any one of the U-phase fifth conductive tube 115, the U-phase seventh conductive tube 117, the V-phase second conductive tube 122, the V-phase fourth conductive tube 124, the W-phase first conductive tube 131, the W-phase third conductive tube 133, the U-phase sixth conductive tube 116, the U-phase eighth conductive tube 118, the V-phase fifth conductive tube 125, the V-phase seventh conductive tube 127, the W-phase second conductive tube 132 and the W-phase fourth conductive tube 134, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

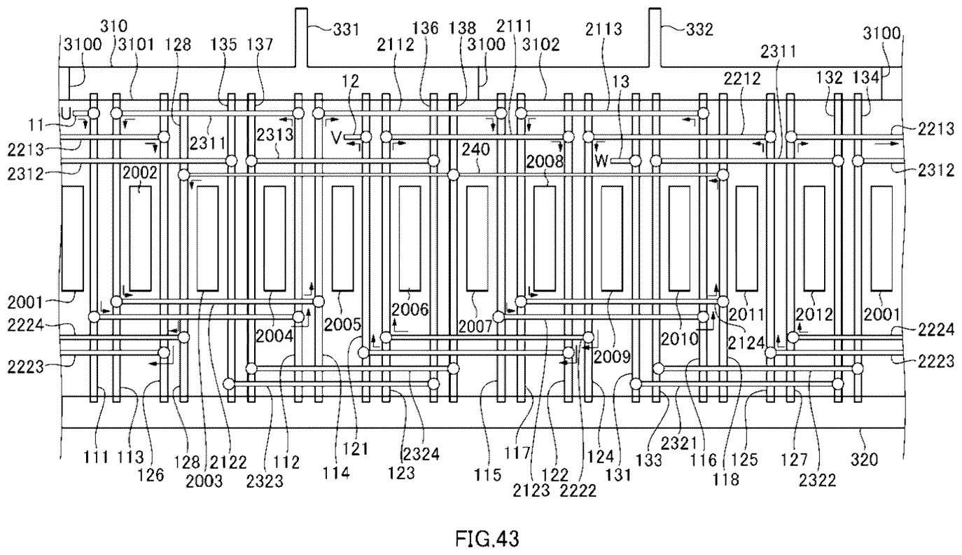

FIG. 43 is a drawing for explaining a flow of electricity from the U-phase line to the V-phase line in the model developed drawing shown in FIG. 42. The arrows indicate the flow direction of the electricity.

First, the flow of the electricity from the U-phase line to the V-phase line will be explained.

The electricity entering from the U-phase line 11 flows as follows: U phase line 11→U-phase first conductive tube 111→U-phase other-end-side first connector 2121→U-phase second conductive tube 112→U-phase one-end-side first connector 2111→U-phase third conductive tube 113→U-phase other-end-side second connector 2122→U-phase fourth conductive tube 114→U-phase one-end-side second connector 2112→U-phase fifth conductive tube 115→U-phase other-end-side third connector 2123→U-phase sixth conductive tube 116→U-phase one-end-side third connector 2113→U-phase seventh conductive tube 117→U-phase other-end-side fourth connector 2124→U-phase eighth conductive tube 118→neutral line connector 240→V-phase eighth conductive tube 128→V-phase other-end-side fourth connector 2224→V-phase seventh conductive tube 127→V-phase one-end-side third connector 2213→V-phase sixth conductive tube 126→V-phase other-end-side third connector 2223→V-phase fifth conductive tube 125→V-phase one-end-side second connector 2212→V-phase fourth conductive tube 124→V-phase other-end-side second connector 2222→V-phase third conductive tube 123→V-phase one-end-side first connector 2211→V-phase second conductive tube 122→V-phase other-end-side first connector 2221→V-phase first conductive tube 121→V phase line 12.

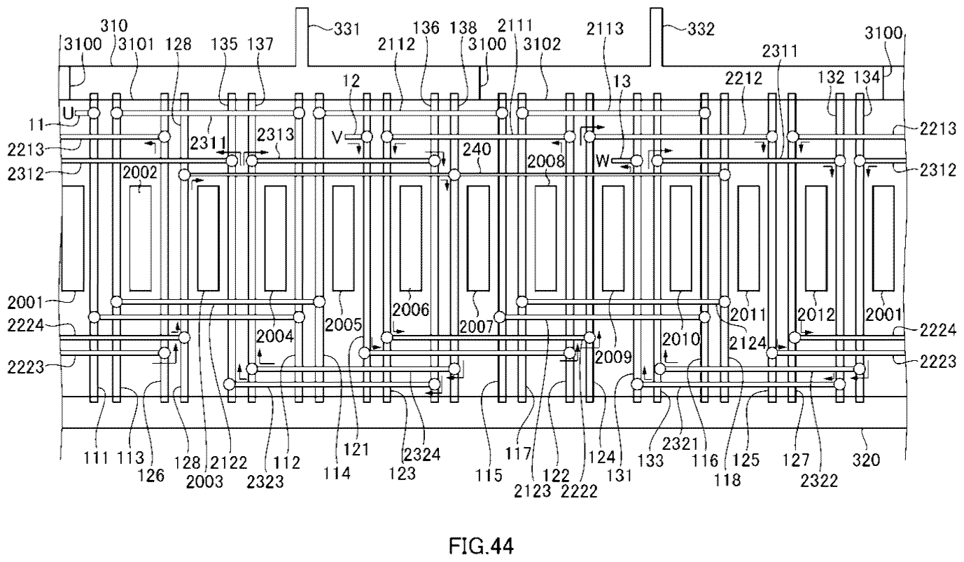

FIG. 44 is a drawing for explaining a flow of electricity from the V-phase line to the W-phase line in the model developed drawing shown in FIG. 42. The arrows indicate the flow direction of the electricity.

Next, the flow of the electricity from the V-phase line to the W-phase line will be explained.

The electricity entering from the V-phase line 12 flows as follows: V phase line 12→V-phase first conductive tube 121→V-phase other-end-side first connector 2221→V-phase second conductive tube 122→V-phase one-end-side first connector 2211→V-phase third conductive tube 123→V-phase other-end-side second connector 2222→V-phase fourth conductive tube 124→V-phase one-end-side second connector 2212→V-phase fifth conductive tube 125→V-phase other-end-side third connector 2223→V-phase sixth conductive tube 126→V-phase one-end-side third connector 2213→V-phase seventh conductive tube 127→V-phase other-end-side fourth connector 2224→V-phase eighth conductive tube 128→neutral line connector 240→W-phase seventh conductive tube 138→W-phase other-end-side fourth connector 2324→W-phase seventh conductive tube 137→W-phase one-end-side third connector 2313→W-phase sixth conductive tube 136→W-phase other-end-side third connector 2323→W-phase fifth conductive tube 135→W-phase one-end-side second connector 2312→W-phase fourth conductive tube 134→W-phase other-end-side second connector 2322→W-phase third conductive tube 133→W-phase one-end-side first connector 2311→W-phase second conductive tube 132→W-phase other-end-side first connector 2321→W-phase first conductive tube 131→W phase line 13.

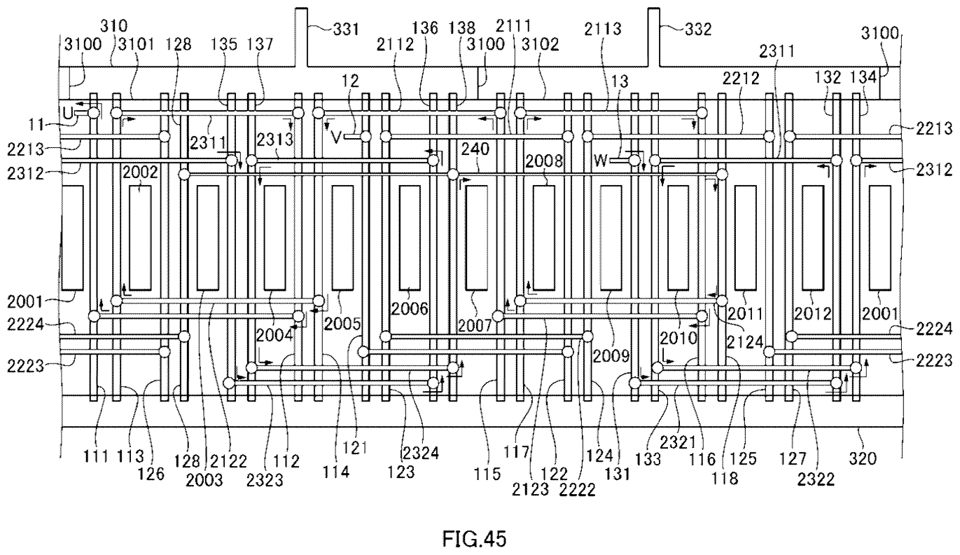

FIG. 45 is a drawing for explaining a flow of electricity from the W-phase line to the U-phase line in the model developed drawing shown in FIG. 42. The arrows indicate the flow direction of the electricity.

Next, the flow of the electricity from the W-phase line to the U-phase line will be explained.

The electricity entering from the W-phase line 13 flows as follows: W phase line 13→W-phase first conductive tube 131→W-phase other-end-side first connector 2321→W-phase second conductive tube 132→W-phase one-end-side first connector 2311→W-phase third conductive tube 133→W-phase other-end-side second connector 2322→W-phase fourth conductive tube 134→W-phase one-end-side second connector 2312→W-phase fifth conductive tube 135→W-phase other-end-side third connector 2323→W-phase sixth conductive tube 136→W-phase one-end-side third connector 2313→W-phase seventh conductive tube 137→W-phase other-end-side fourth connector 2324→W-phase seventh conductive tube 138→neutral line connector 240→U-phase eighth conductive tube 118→U-phase other-end-side fourth connector 2124→U-phase seventh conductive tube 117→U-phase one-end-side third connector 2113→U-phase sixth conductive tube 116→U-phase other-end-side third connector 2123→U-phase fifth conductive tube 115→U-phase one-end-side second connector 2112→U-phase fourth conductive tube 114→U-phase other-end-side second connector 2122→U-phase third conductive tube 113→U-phase one-end-side first connector 2111→U-phase second conductive tube 112→U-phase other-end-side first connector 2121→U-phase first conductive tube 111→U phase line 11.

By configuring as in the present embodiment described above, even in a 2-turn type 12N4P type rotating electrical machine, the heat medium can flow through the inside of each conductive tube, and the cooling performance is excellent.

Furthermore, by adopting the 2-turn type, higher voltage operation is possible.

In the description of the present embodiment, the 2-turn type is explained to avoid complication of the description. However, by increasing the number of conductive tubes arranged in the spaces (slots) between the teeth, a 3-turn type or a type with a higher number of turns is also possible.

### Tenth Embodiment

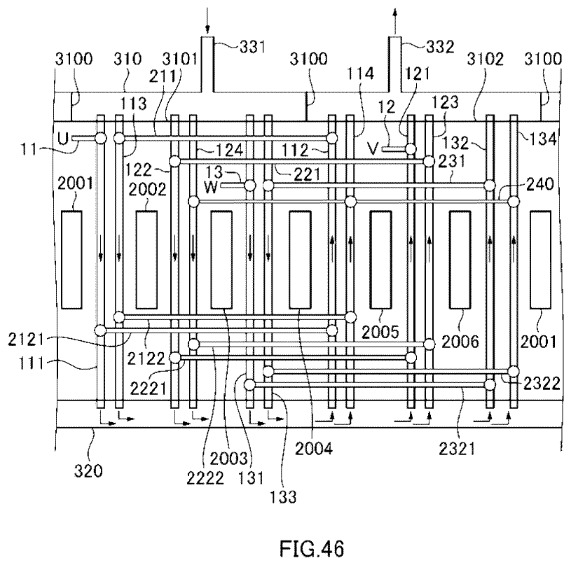

FIG. 46 is a developed drawing modeled on the rotating electrical machine of the tenth embodiment.

The rotating electrical machine of the tenth embodiment is a 6N2P type rotating electrical machine in which the conductive tubes are arranged in the spaces (slots) between six teeth and a 2-pole type rotor is used. In addition, the seventh embodiment is a 1-turn type in which electricity makes only one revolution around the teeth. However, the tenth embodiment is a 2-turn type in which electricity makes two revolutions around the teeth.

A plurality of teeth is protruded from the inner peripheral wall of the base portion of the stator core 20. As shown in FIG. 46, there are a first tooth 2001, a second tooth 2002, a third tooth 2003, a fourth tooth 2004, a fifth tooth 2005 and a sixth tooth 2006 from the left.

The conductive tubes are arranged in the spaces (slots) between the respective teeth. A U-phase first conductive tube 111 and a U-phase third conductive tube 113 are arranged in the space (slot) between the first tooth 2001 and the second tooth 2002. In FIG. 46, the U-phase first conductive tube 111 is arranged on the first tooth 2001 side and the U-phase third conductive tube 113 is arranged on the second tooth 2002 side. Conversely, the U-phase third conductive tube 113 may be arranged on the first tooth 2001 side and the U-phase second conductive tube 112 may be arranged on the second tooth 2002 side. In addition, the U-phase first conductive tube 111 and the U-phase third conductive tube 113 may be arranged so as to overlap in the front-back direction. The same applies hereinafter. A V-phase second conductive tube 122 and a V-phase fourth conductive tube 124 are arranged in the space (slot) between the second tooth 2002 and the third tooth 2003. A W-phase first conductive tube 131 and a W-phase third conductive tube 133 are arranged in the space (slot) between the third tooth 2003 and the fourth tooth 2004. A U-phase second conductive tube 112 and a U-phase fourth conductive tube 114 are arranged in the space (slot) between the fourth tooth 2004 and the fifth tooth 2005. A V-phase first conductive tube 121 and a V-phase third conductive tube 123 are arranged in the space (slot) between the fifth tooth 2005 and the sixth tooth 2006. A W-phase second conductive tube 132 and a W-phase fourth conductive tube 134 are arranged in the space (slot) between the sixth tooth 2006 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Twelve holes are formed in the bottom surface of one heat medium flow member 310. Six holes are formed in the first heat medium flow compartment 3101. The remaining six holes are formed in the second heat medium flow compartment 3102.

One ends of the U-phase first conductive tube 111, the U-phase third conductive tube 113, the V-phase second conductive tube 122, the V-phase fourth conductive tube 124, the W-phase first conductive tube 131 and the W-phase third conductive tube 133 are inserted into the holes formed in the first heat medium flow compartment 3101.

One ends of the U-phase second conductive tube 112, the U-phase fourth conductive tube 114, the V-phase first conductive tube 121, the V-phase third conductive tube 123, the W-phase second conductive tube 132 and the W-phase fourth conductive tube 134 are inserted into the holes formed in the second heat medium flow compartment 3102.

The other heat medium flow member 320 is arranged below (on the other end side of) the stator core 20. Twelve holes are formed in the bottom surface of the other heat medium flow member 320. The other ends of the U-phase first conductive tube 111, the U-phase third conductive tube 113, the V-phase second conductive tube 122, the V-phase fourth conductive tube 124, the W-phase first conductive tube 131, the W-phase third conductive tube 133, the U-phase second conductive tube 112, the U-phase fourth conductive tube 114, the V-phase first conductive tube 121, the V-phase third conductive tube 123, the W-phase second conductive tube 132 and the W-phase fourth conductive tube 134 are inserted into the holes.

The U-phase line 11 is connected to one end side of the U-phase first conductive tube 111. The U-phase line 11 is a solid conductor. The U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

The U-phase one-end-side connector 211 is connected to one end side of the U-phase second conductive tube 112 and one end side of the U-phase third conductive tube 113 so that the U-phase second conductive tube 112 and the U-phase third conductive tube 113 are electrically conducted.

The U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

The V-phase line 12 is connected to one end side of the V-phase first conductive tube 121. The V-phase line 12 is a solid conductor. The V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

The V-phase one-end-side connector 221 is connected to one end side of the V-phase second conductive tube 122 and one end side of the V-phase third conductive tube 123 so that the V-phase second conductive tube 122 and the V-phase third conductive tube 123 are electrically conducted.

The V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

The W-phase line 13 is connected to one end side of the W-phase first conductive tube 131. The W-phase line 13 is a solid conductor. The W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

The W-phase one-end-side connector 231 is connected to one end side of the W-phase second conductive tube 132 and one end side of the W-phase third conductive tube 133 so that the W-phase second conductive tube 132 and the W-phase third conductive tube 133 are electrically conducted.

The W-phase one-end-side connector 231 is connected to one end side of the W-phase second conductive tube 132 and one end side of the W-phase third conductive tube 133 so that the W-phase second conductive tube 132 and the W-phase third conductive tube 133 are electrically conducted.

The W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

### Flow of Heat Medium

In FIG. 46, the arrows indicate the flow direction of the heat medium.

The heat medium supplied from the first heat medium flow tube 331 flows from the first heat medium flow compartment 3101 of one heat medium flow member 310 through any one of the U-phase first conductive tube 111, the U-phase third conductive tube 113, the V-phase second conductive tube 122, the V-phase fourth conductive tube 124, the W-phase first conductive tube 131 and the W-phase third conductive tube 133, and reaches the other heat medium flow member 320. Then, the heat medium flows through any one of the U-phase second conductive tube 112, the U-phase fourth conductive tube 114, the V-phase first conductive tube 121, the V-phase third conductive tube 123, the W-phase second conductive tube 132 and the W-phase fourth conductive tube 134, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

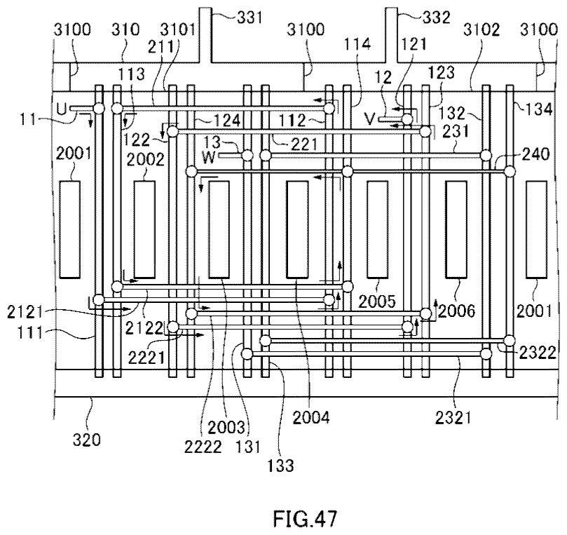

FIG. 47 is a drawing for explaining a flow of electricity from the U-phase line to the V-phase line in the model developed drawing shown in FIG. 46. The arrows indicate the flow direction of the electricity.

First, the flow of the electricity from the U-phase line to the V-phase line will be explained.

The electricity entering from the U-phase line 11 flows as follows: U phase line 11→U-phase first conductive tube 111→U-phase other-end-side first connector 2121→U-phase second conductive tube 112→U-phase one-end-side connector 211→U-phase third conductive tube 113→U-phase other-end-side second connector 2122→U-phase fourth conductive tube 114→neutral line connector 240→V-phase fourth conductive tube 124→V-phase other-end-side second connector 2222→V-phase third conductive tube 123→V-phase one-end-side connector 221→V-phase second conductive tube 122→V-phase other-end-side first connector 2221→V-phase first conductive tube 121→V phase line 12.

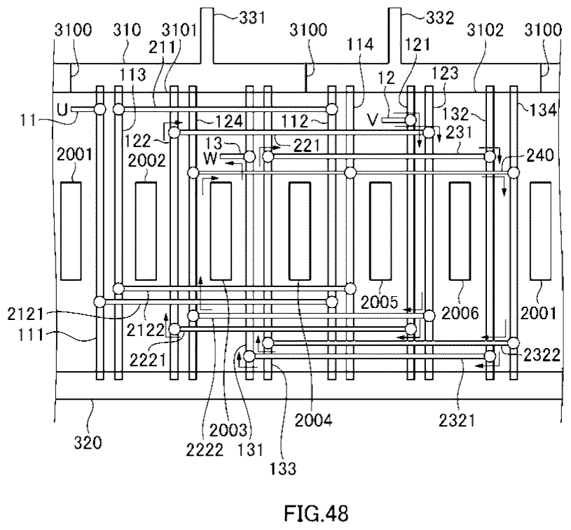

FIG. 48 is a drawing for explaining a flow of electricity from the V-phase line to the W-phase line in the model developed drawing shown in FIG. 46. The arrows indicate the flow direction of the electricity.

Next, the flow of the electricity from the V-phase line to the W-phase line will be explained.

The electricity entering from the V-phase line 12 flows as follows: V phase line 12→V-phase first conductive tube 121→V-phase other-end-side first connector 2221→V-phase second conductive tube 122→V-phase one-end-side connector 221→V-phase third conductive tube 123→V-phase other-end-side second connector 2222→V-phase fourth conductive tube 124→neutral line connector 240→W-phase fourth conductive tube 134→W-phase other-end-side second connector 2322→W-phase third conductive tube 133→W-phase one-end-side connector 231→W-phase second conductive tube 132→W-phase other-end-side first connector 2321→W-phase first conductive tube 131→W phase line 13.

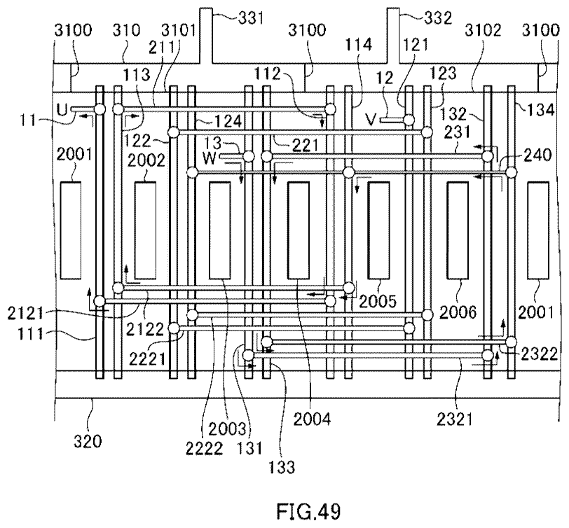

FIG. 49 is a drawing for explaining a flow of electricity from the W-phase line to the U-phase line in the model developed drawing shown in FIG. 46. The arrows indicate the flow direction of the electricity.

Next, the flow of the electricity from the W-phase line to the U-phase line will be explained.

The electricity entering from the W-phase line 13 flows as follows: W phase line 13→W-phase first conductive tube 131→W-phase other-end-side first connector 2321→W-phase second conductive tube 132→W-phase one-end-side connector 231→W-phase third conductive tube 133→W-phase other-end-side second connector 2322→W-phase fourth conductive tube 134→neutral line connector 240→U-phase fourth conductive tube 114→U-phase other-end-side second connector 2122→U-phase third conductive tube 113→U-phase one-end-side connector 211→U-phase second conductive tube 112→U-phase other-end-side first connector 2121→U-phase first conductive tube 111→U phase line 11.

By configuring as in the present embodiment described above, even in a 2-turn type 6N2P type rotating electrical machine, the heat medium can flow through the inside of each conductive tube, and the cooling performance is excellent.

Furthermore, by adopting the 2-turn type, it is possible to increase the output.

In the explanation of the present embodiment, the 2-turn type is explained to avoid complication of the description. However, by increasing the number of conductive tubes arranged in the spaces (slots) between the teeth, a 3-turn type or a type with a higher number of turns is also possible.

### Eleventh Embodiment

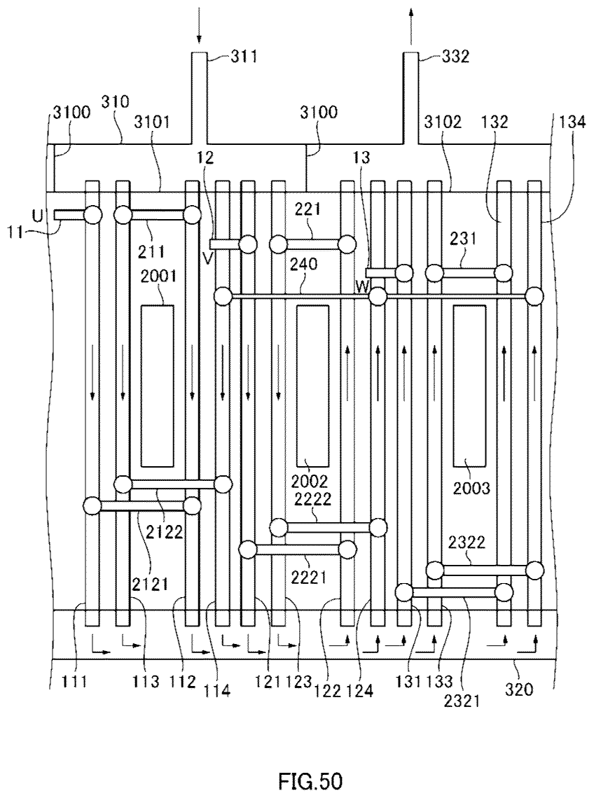

FIG. 50 is a developed drawing modeled on the rotating electrical machine of the eleventh embodiment.

The rotating electrical machine of the eleventh embodiment is a 3N2P type rotating electrical machine in which the conductive tubes are arranged in the spaces (slots) between three teeth and a 2-pole type rotor is used. In addition, the eighth embodiment is a 1-turn type in which electricity makes only one revolution around the teeth. However, the eleventh embodiment is a 2-turn type in which electricity makes two revolutions around the teeth.

A plurality of teeth is protruded from the inner peripheral wall of the base portion of the stator core 20. As shown in FIG. 50, there are a first tooth 2001, a second tooth 2002 and a third tooth 2003 from the left.

The conductive tubes are arranged in the spaces (slots) between the respective teeth.

A U-phase second conductive tube 112, a U-phase fourth conductive tube 114, a V-phase first conductive tube 121 and a V-phase third conductive tube 123 are arranged in the space (slot) between the first tooth 2001 and the second tooth 2002. In FIG. 50, the U-phase second conductive tube 112 and the U-phase fourth conductive tube 114 are arranged on the first tooth 2001 side, and the V-phase first conductive tube 121 and the V-phase third conductive tube 123 are arranged on the second tooth 2002 side. Conversely, the V-phase first conductive tube 121 and the V-phase third conductive tube 123 may be arranged on the first tooth 2001 side, and the U-phase second conductive tube 112 and the U-phase fourth conductive tube 114 may be arranged on the second tooth 2002 side. However, from the viewpoint of efficiency, it is desirable that the U-phase second conductive tube 112 and the U-phase fourth conductive tube 114 are arranged on the first tooth 2001 side and the V-phase first conductive tube 121 and the V-phase third conductive tube 123 are arranged on the second tooth 2002 side as shown in FIG. 50. The same applies hereinafter.

A V-phase second conductive tube 122, a V-phase fourth conductive tube 124, a W-phase first conductive tube 131 and a W-phase third conductive tube 133 are arranged in the space (slot) between the second tooth 2002 and the third tooth 2003.

A W-phase second conductive tube 132, a W-phase fourth conductive tube 134, a U-phase first conductive tube 111 and a U-phase third conductive tube 113 are arranged in the space (slot) between the third tooth 2003 and the first tooth 2001.

One heat medium flow member 310 is arranged above (on one end side of) the stator core 20. The inside of one heat medium flow member 310 is divided into two by a pair of partition portions 3100. The first heat medium flow tube 331 for supplying or discharging the heat medium is connected to one compartment (first heat medium flow compartment 3101). The second heat medium flow tube 332 for discharging or supplying the heat medium is connected to the other compartment (second heat medium flow compartment 3102).

Twelve holes are formed in the bottom surface of one heat medium flow member 310. Six holes are formed in the first heat medium flow compartment 3101. The remaining six holes are formed in the second heat medium flow compartment 3102.

One ends of the U-phase first conductive tube 111, the U-phase third conductive tube 113, the U-phase second conductive tube 112, the U-phase fourth conductive tube 114, the V-phase first conductive tube 121 and the V-phase third conductive tube 123 are inserted into the holes formed in the first heat medium flow compartment 3101.

One ends of the V-phase second conductive tube 122, the V-phase fourth conductive tube 124, the W-phase first conductive tube 131, the W-phase third conductive tube 133, the W-phase second conductive tube 132 and the W-phase fourth conductive tube 134 are inserted into the holes formed in the second heat medium flow compartment 3102.

The other heat medium flow member 320 is arranged below (on the other end side of) the stator core 20. Six holes are formed in the bottom surface of the other heat medium flow member 320. The other ends of the U-phase first conductive tube 111, the U-phase third conductive tube 113, the U-phase second conductive tube 112, the U-phase fourth conductive tube 114, the V-phase first conductive tube 121, the V-phase third conductive tube 123, the V-phase second conductive tube 122, the V-phase fourth conductive tube 124, the W-phase first conductive tube 131, the W-phase third conductive tube 133, the W-phase second conductive tube 132 and the W-phase fourth conductive tube 134 are inserted into the holes.

The U-phase line 11 is connected to one end side of the U-phase first conductive tube 111. The U-phase line 11 is a solid conductor. The U-phase other-end-side first connector 2121 is connected to the other end side of the U-phase first conductive tube 111 and the other end side of the U-phase second conductive tube 112 so that the U-phase first conductive tube 111 and the U-phase second conductive tube 112 are electrically conducted.

The U-phase one-end-side connector 211 is connected to one end side of the U-phase second conductive tube 112 and one end side of the U-phase third conductive tube 113 so that the U-phase second conductive tube 112 and the U-phase third conductive tube 113 are electrically conducted.

The U-phase other-end-side second connector 2122 is connected to the other end side of the U-phase third conductive tube 113 and the other end side of the U-phase fourth conductive tube 114 so that the U-phase third conductive tube 113 and the U-phase fourth conductive tube 114 are electrically conducted.

The V-phase line 12 is connected to one end side of the V-phase first conductive tube 121. The V-phase line 12 is a solid conductor. The V-phase other-end-side first connector 2221 is connected to the other end side of the V-phase first conductive tube 121 and the other end side of the V-phase second conductive tube 122 so that the V-phase first conductive tube 121 and the V-phase second conductive tube 122 are electrically conducted.

The V-phase one-end-side connector 221 is connected to one end side of the V-phase second conductive tube 122 and one end side of the V-phase third conductive tube 123 so that the V-phase second conductive tube 122 and the V-phase third conductive tube 123 are electrically conducted.

The V-phase other-end-side second connector 2222 is connected to the other end side of the V-phase third conductive tube 123 and the other end side of the V-phase fourth conductive tube 124 so that the V-phase third conductive tube 123 and the V-phase fourth conductive tube 124 are electrically conducted.

The W-phase line 13 is connected to one end side of the W-phase first conductive tube 131. The W-phase line 13 is a solid conductor. The W-phase other-end-side first connector 2321 is connected to the other end side of the W-phase first conductive tube 131 and the other end side of the W-phase second conductive tube 132 so that the W-phase first conductive tube 131 and the W-phase second conductive tube 132 are electrically conducted.

The W-phase one-end-side connector 231 is connected to one end side of the W-phase second conductive tube 132 and one end side of the W-phase third conductive tube 133 so that the W-phase second conductive tube 132 and the W-phase third conductive tube 133 are electrically conducted.

The W-phase other-end-side second connector 2322 is connected to the other end side of the W-phase third conductive tube 133 and the other end side of the W-phase fourth conductive tube 134 so that the W-phase third conductive tube 133 and the W-phase fourth conductive tube 134 are electrically conducted.

The neutral line connector 240 is connected to one end side of the U-phase fourth conductive tube 114, one end side of the V-phase fourth conductive tube 124 and one end side of the W-phase fourth conductive tube 134 so that the U-phase fourth conductive tube 114, the V-phase fourth conductive tube 124, and the W-phase fourth conductive tube 134 are electrically conducted.

### Flow of Heat Medium

In FIG. 50, the arrows indicate the flow direction of the heat medium.

The heat medium supplied from the first heat medium flow tube 331 flows from the first heat medium flow compartment 3101 of one heat medium flow member 310 through any one of the U-phase first conductive tube 111, the U-phase third conductive tube 113, the U-phase second conductive tube 112, the U-phase fourth conductive tube 114, the V-phase first conductive tube 121 and the V-phase third conductive tube 123, and reaches the other heat medium flow member 320. Then, the heat medium flows through any one of the V-phase second conductive tube 122, the V-phase fourth conductive tube 124, the W-phase first conductive tube 131, the W-phase third conductive tube 133, the W-phase second conductive tube 132 and the W-phase fourth conductive tube 134, reaches the second heat medium flow compartment 3102 of one heat medium flow member 310, and is discharged from the second heat medium flow tube 332. In the present embodiment, the heat medium is described as being supplied from the first heat medium flow tube 331 and discharged from the second heat medium flow tube 332. However, a pattern where the heat medium is supplied from the second heat medium flow tube 332 and discharged from the first heat medium flow tube 331 may also be used.

Next, the flow of the electricity will be explained.

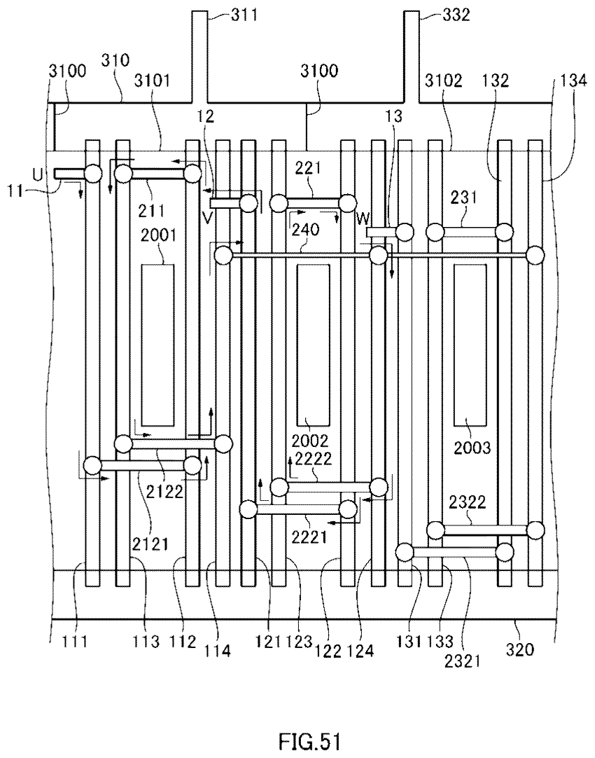

FIG. 51 is a drawing for explaining a flow of electricity from the U-phase line to the V-phase line in the model developed drawing shown in FIG. 50. The arrows indicate the flow direction of the electricity.

First, the flow of the electricity from the U-phase line to the V-phase line will be explained.

The electricity entering from the U-phase line 11 flows as follows: U phase line 11→U-phase first conductive tube 111→U-phase other-end-side first connector 2121→U-phase second conductive tube 112→U-phase one-end-side connector 211→U-phase third conductive tube 113→U-phase other-end-side second connector 2122→U-phase fourth conductive tube 114→neutral line connector 240→V-phase fourth conductive tube 124→V-phase other-end-side second connector 2222→V-phase third conductive tube 123→V-phase one-end-side connector 221→V-phase second conductive tube 122→V-phase other-end-side first connector 2221→V-phase first conductive tube 121→V phase line 12.

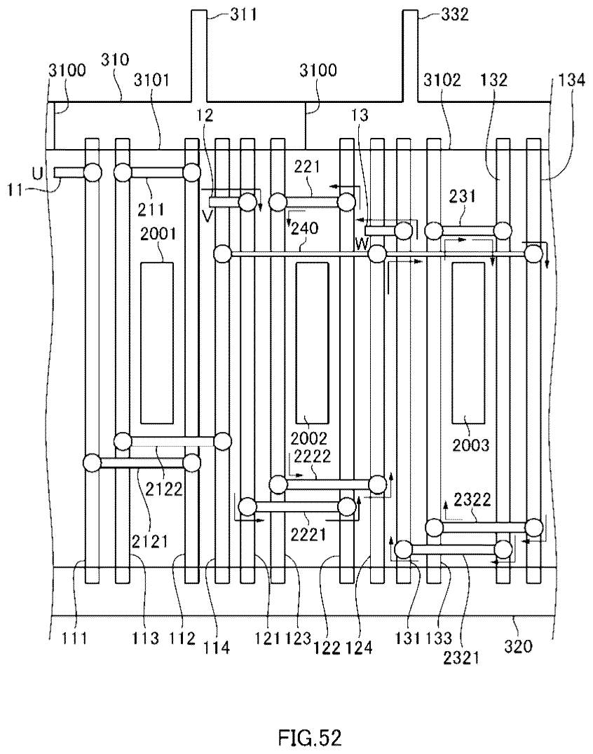

FIG. 52 is a drawing for explaining a flow of electricity from the V-phase line to the W-phase line in the model developed drawing shown in FIG. 50. The arrows indicate the flow direction of the electricity.

Next, the flow of the electricity from the V-phase line to the W-phase line will be explained.

The electricity entering from the V-phase line 12 flows as follows: the V phase line 12→V-phase first conductive tube 121→V-phase other-end-side first connector 2221→V-phase second conductive tube 122→V-phase one-end-side connector 221→V-phase third conductive tube 123→V-phase other-end-side second connector 2222→V-phase fourth conductive tube 124→neutral line connector 240→W-phase fourth conductive tube 134→W-phase other-end-side second connector 2322→W-phase third conductive tube 133→W-phase one-end-side connector 231→W-phase second conductive tube 132→W-phase other-end-side first connector 2321→W-phase first conductive tube 131→W phase line 13.

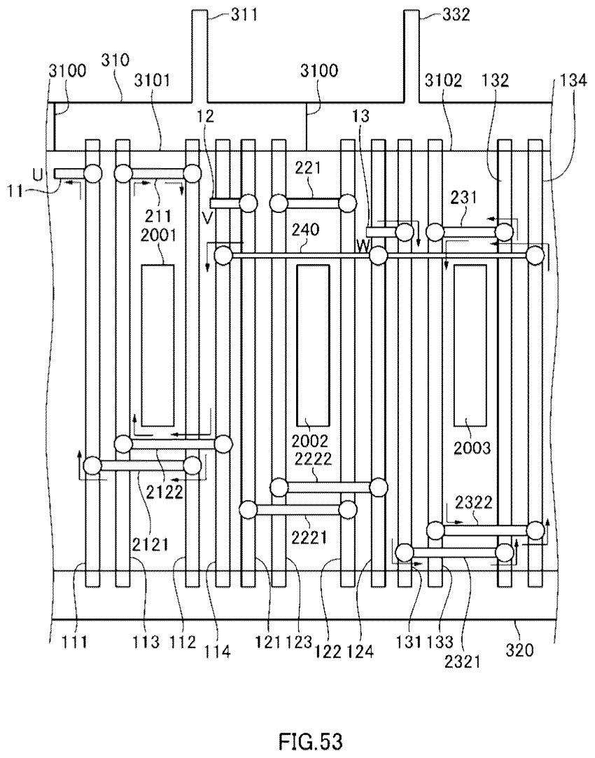

FIG. 53 is a drawing for explaining a flow of electricity from the W-phase line to the U-phase line in the model developed drawing shown in FIG. 50. The arrows indicate the flow direction of the electricity.

Next, the flow of the electricity from the W-phase line to the U-phase line will be explained.

The electricity entering from the W-phase line 13 flows as follows: W phase line 13→W-phase first conductive tube 131→W-phase other-end-side first connector 2321→W-phase second conductive tube 132→W-phase one-end-side connector 231→W-phase third conductive tube 133→W-phase other-end-side second connector 2322→W-phase fourth conductive tube 134→neutral line connector 240→U-phase fourth conductive tube 114→U-phase other-end-side second connector 2122→U-phase third conductive tube 113→U-phase one-end-side connector 211→U-phase second conductive tube 112→U-phase other-end-side first connector 2121→U-phase first conductive tube 111→U phase line 11.

By configuring as in the present embodiment described above, even in a 2-turn type 3N2P type rotating electrical machine, the heat medium can flow through the inside of each of the conductive tubes, and the cooling performance is excellent.

Furthermore, by adopting the 2-turn type, it is possible to increase the output.

In the explanation of the present embodiment, the 2-turn type is explained to avoid complication of the description. However, by increasing the number of conductive tubes arranged in the spaces (slots) between the teeth, a 3-turn type or a type with a higher number of turns is also possible.

The embodiments of the present invention have been explained above. However, the above described embodiments merely show some application examples of the present invention, and are not intended to limit the technical scope of the present invention to the specific configurations of the above described embodiments.

For example, in each of the above described embodiments, the stator core is cylindrical, with a plurality of teeth protruded from the inner peripheral wall of the base portion and conductive tubes arranged in the spaces (slots) between the teeth.

However, the stator core may be flat plate-shaped instead of cylindrical. A plurality of teeth may be protruded from the bottom surface serving as the base portion, and conductive tubes may be arranged in the spaces (slots) between the teeth. By doing so, the present invention can be applied to a linear motor.

In addition, in each of the above described embodiments, a plurality of teeth is protruded from the base portion of the stator core, and the conductive tubes are arranged in the spaces (slots) between the teeth.

However, as also disclosed in Japanese Patent Application Publication No. 2002-101591, a slotless type rotating electrical machine (electrical energy-mechanical energy converter) is known in which air-core coils are arranged on the inner peripheral surface of a stator core having no teeth and slots.

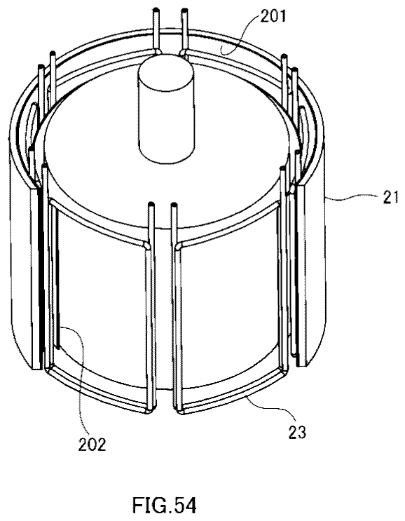

An example of a stator of such a rotating electrical machine is as shown in FIG. 54. FIG. 54 is a perspective view showing a stator of a slotless type rotating electrical machine with a part of the stator core cut away.

The stator 2 of the slotless type rotating electrical machine is an example of a configuration in which a coil 23 arranged inside a stator core 21 via an insulating sheet 201 is further held and fixed by a protective layer 202 on the further inner side. In FIG. 54, to avoid complication of the drawing, the coil 23 is wound only once. Actually the coil 23 is wound multiple times as necessary. In addition, it is possible to use a structure in which the insulating sheet and protective layer are appropriately replaced by other means or not used. The slotless type rotating electrical machine can reduce cogging torque, magnet loss, iron loss, stray loss and the like.

The electrical energy mechanical energy converter (rotating electrical machine/linear motor) of the present invention may be the above described slotless/coreless type.

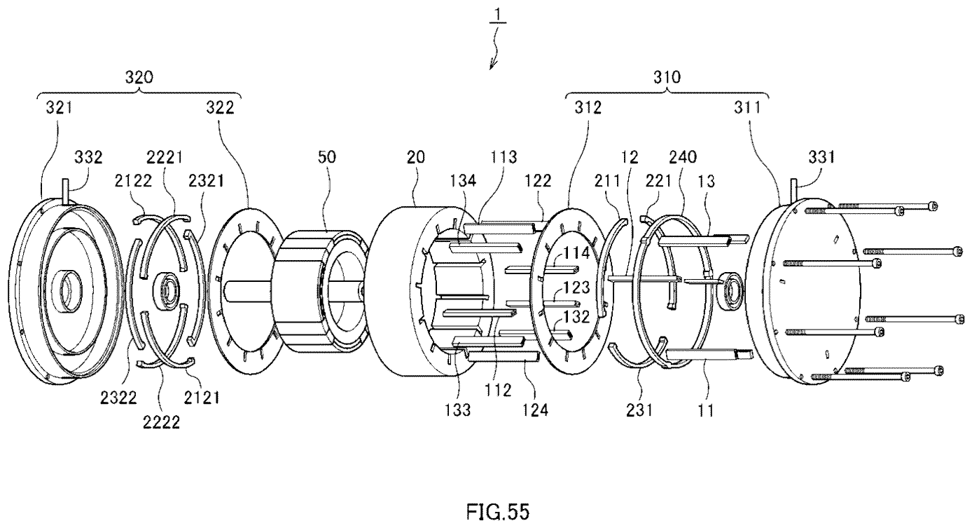

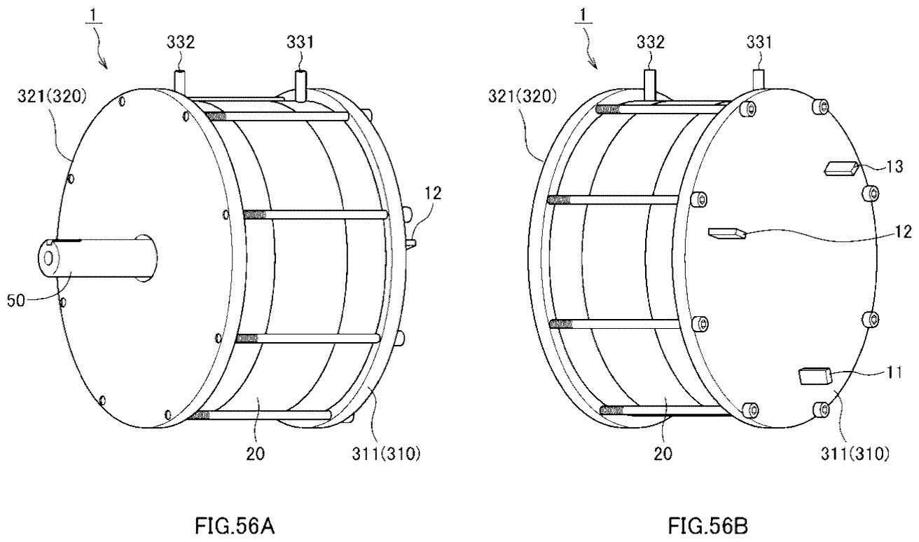

Furthermore, in each of the above described embodiments, the heat medium flow member has a two-body structure of a main body portion and a lid portion. However, the main body portion may also serve as a motor housing. For example, in the fourth embodiment, the heat medium flow member 310 has a two-body structure of a cover (main body portion) 311 and a bottom plate (lid portion) 312. However, the cover (main body portion) 311 may also serve as a motor housing as shown in FIG. 55, and a bolt-fastening structure may be adopted as shown in FIG. 56.

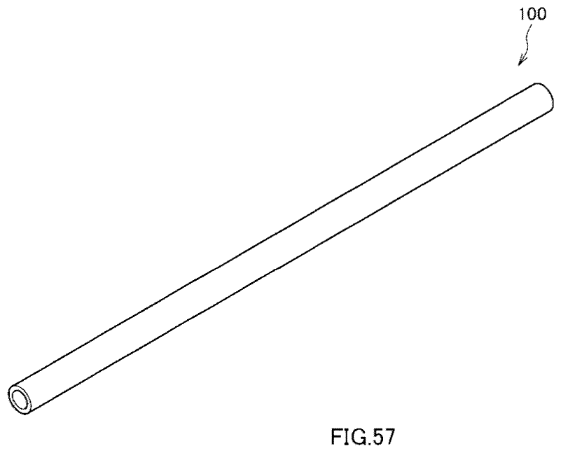

Furthermore, in each of the above described embodiments, a flat-shaped conductive tube 100 is illustrated and explained. However, as shown in FIG. 57, a cylindrical shape may also be used.

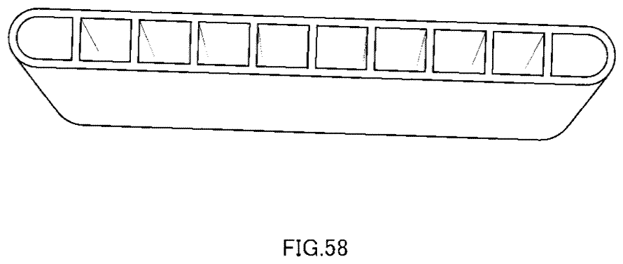

Furthermore, as shown in FIG. 58, a type in which a plurality of passages is formed may also be used.

Furthermore, in FIG. 24 (fourth embodiment) and FIG. 55, after the conductive tubes 111, 112, . . . are arranged on the stator core 20, if a coating material is thinly applied to the inner periphery of the stator core 20, the positions of the conductive tubes 111, 112, . . . are fixed. With the above described structure, the cover 311 and the cover 321 are further liquid-tightly fixed to the stator core 20. With the above described structure, the bottom plate 312 and the bottom plate 322 can be eliminated.

Instead of applying a coating material to the inner periphery of the stator core 20, a slot sealing member may be added to the inner periphery of the stator core 20. If the positions of the conductive tubes 111, 112, . . . are fixed by such a member, productivity is excellent.

Furthermore, the type of rotating electrical machine does not matter. For example, the present invention is also applicable to axial flux type rotating electrical machines, SR rotating electrical machines, induction rotating electrical machines, synchronous rotating electrical machines and the like.

For example, by using liquid nitrogen or liquid helium as the heat medium, a superconducting rotating electrical machine can be realized.

In addition, the heat medium to be used may be a liquid insulating heat medium or a gas such as air. Other than these, antifreeze, liquefied fluorocarbons and halons, liquefied hydrocarbons, silicone oils, liquefied ammonia, liquefied nitrogen, liquefied hydrogen, liquefied noble gases, liquefied carbon dioxide gas and the like may be used. For the heat media such as water, pure water with very low conductivity may be used, appropriately mixed with additives for corrosion prevention and the like.

Furthermore, by coating the inside of the conductive tube with an insulating film, it becomes possible to use a conductive heat medium, for example, an aqueous liquid.

By using a cryogenic heat medium such as liquid nitrogen or liquid helium as the heat medium and using a superconducting material for the conductive tubes, a superconducting rotating electrical machine can be realized.

Furthermore, an ion exchange resin filter may be installed on the heat medium path. By doing so, ions in the heat medium can be removed to lower the electrical conductivity of the heat medium and enhance insulation, and even in the unlikely event that a conductive heat medium leaks, electric leakage and the like can be minimized.

As a method of supplying the heat medium, in addition to a method using power such as a pump when circulating the cooling heat medium, a natural circulation method utilizing gravity and the like without using a pump and the like, like a heat pipe, may also be used.

There are various motor winding methods such as concentrated winding, distributed winding, single-layer winding, double-layer winding, full-pitch winding, short-pitch winding, lap winding, concentric winding, wave winding and the like, and these are appropriately selected by combining each method at the time of design.

Manufacturing is also possible with a type in which the stator slot tooth portion is closed (without coil end heat medium flow path connection parts).

In addition, the connector is exemplified as a solid type in FIG. 3. However, the connector may be a hollow type in which a flow path is formed so that the heat medium flows from the tip through the inside to the other end.

Furthermore, cooling from the outside of the stator core may also be performed together as appropriate.

Regarding the connector, the shape shown in FIG. 3 is exemplified in the above described embodiments. However, the above described shape is merely an example, and the shape of the connector does not matter. In addition, the connector may use a general conductor such as so-called magnet wire or stranded wire.

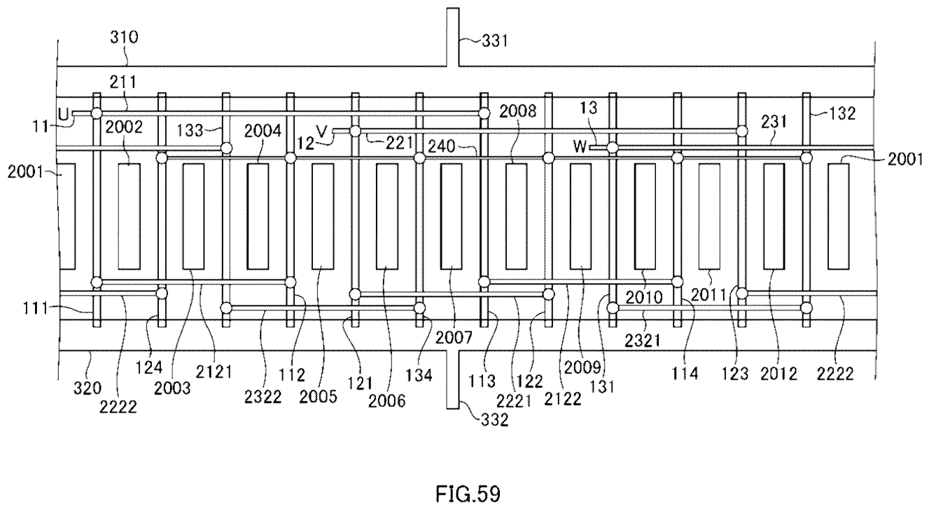

The above embodiments can be appropriately combined. For example, one heat medium flow member 310 and the other heat medium flow member 320 used in the second embodiment may be applied to the fifth embodiment. In this case, it becomes as shown in FIG. 59.

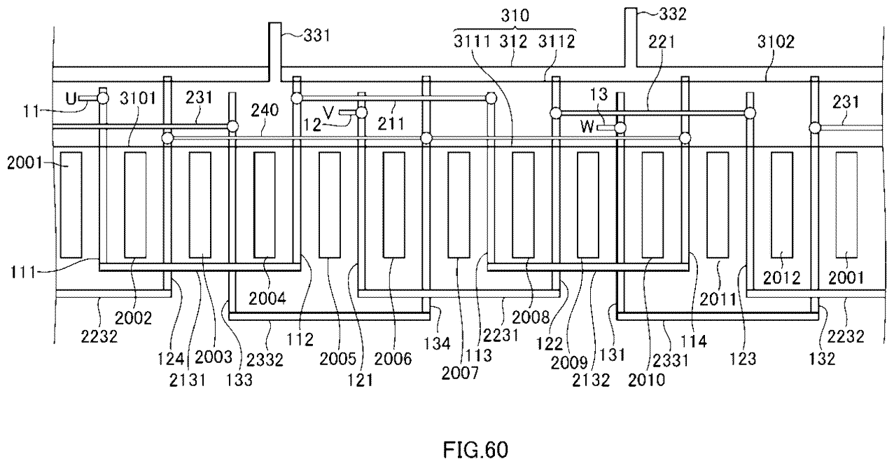

When the heat medium flow member used in the fourth embodiment is applied to the third embodiment, it becomes as shown in FIG. 60.

In this way, the above described embodiments can be appropriately combined.

This application claims priority based on Japanese Patent Application No. 2023-126263 filed with the Japan Patent Office on Aug. 2, 2023, and the entire contents of this application are incorporated herein by reference.

1. An electrical energy-mechanical energy converter comprising:
a stator core having a plurality of teeth protruded from a base portion;
a first U-phase conductive tube that is electrically conductive so that a heat medium can flow through the first U-phase conductive tube, the first U-phase conductive tube being arranged in a space between the plurality of teeth and being longer than a thickness of the stator core and protruding on both sides of the stator core;
a second U-phase conductive tube that is electrically conductive so that the heat medium can flow through the second U-phase conductive tube, the second U-phase conductive tube being arranged in the space between the plurality of teeth and being longer than the thickness of the stator core and protruding on the both sides of the stator core;
a U-phase line that is electrically conductive and is connected to one end side of the first U-phase conductive tube protruding from the stator core;
a U-phase connector that is electrically conductive and is connected to the other end side of the first U-phase conductive tube protruding from the stator core and to the other end side of the second U-phase conductive tube protruding from the stator core;
a first V-phase conductive tube that is electrically conductive so that the heat medium can flow through the first V-phase conductive tube, the first V-phase conductive tube being arranged in the space between the plurality of teeth and being longer than the thickness of the stator core and protruding on the both sides of the stator core;
a second V-phase conductive tube that is electrically conductive so that the heat medium can flow through the second V-phase conductive tube, the second V-phase conductive tube being arranged in the space between the plurality of teeth and being longer than the thickness of the stator core and protruding on the both sides of the stator core;
a V-phase line that is electrically conductive and is connected to one end side of the first V-phase conductive tube protruding from the stator core;
a V-phase connector that is electrically conductive and is connected to the other end side of the first V-phase conductive tube protruding from the stator core and to the other end side of the second V-phase conductive tube protruding from the stator core;
a first W-phase conductive tube that is electrically conductive so that the heat medium can flow through the first W-phase conductive tube, the first W-phase conductive tube being arranged in the space between the plurality of teeth and being longer than the thickness of the stator core and protruding on both sides of the stator core;
a second W-phase conductive tube that is electrically conductive so that the heat medium can flow through the second W-phase conductive tube, the second W-phase conductive tube being arranged in the space between the plurality of teeth and being longer than the thickness of the stator core and protruding on both sides of the stator core;
a W-phase line that is electrically conductive and is connected to one end side of the first W-phase conductive tube protruding from the stator core;
a W-phase connector that is electrically conductive and is connected to the other end side of the first W-phase conductive tube protruding from the stator core and to the other end side of the second W-phase conductive tube protruding from the stator core;
a neutral line that is electrically conductive and is connected to one end side of the second U-phase conductive tube protruding from the stator core, one end side of the second V-phase conductive tube and one end side of the second W-phase conductive tube;
one heat medium flow member that is arranged on one side of the stator core so that the heat medium can flow inside the one heat medium flow member while preventing the heat medium flowing through the first U-phase conductive tube, the second U-phase conductive tube, the first V-phase conductive tube, the second V-phase conductive tube, the first W-phase conductive tube and the second W-phase conductive tube from leaking to the outside from locations contacting the stator core; and
the other heat medium flow member that is arranged on the other side of the stator core so that the heat medium can flow inside the other heat medium flow member while preventing the heat medium flowing through the first U-phase conductive tube, the second U-phase conductive tube, the first V-phase conductive tube, the second V-phase conductive tube, the first W-phase conductive tube and the second W-phase conductive tube from leaking to the outside from the locations contacting the stator core.

2. An electrical energy-mechanical energy converter comprising:
a stator core having a plurality of teeth protruded from a base portion;
a plurality of U-phase conductive tubes that is electrically conductive so that a heat medium can flow through the plurality of U-phase conductive tubes, the plurality of U-phase conductive tubes being arranged in a space between the plurality of teeth and being longer than a thickness of the stator core and protruding on both sides of the stator core;
a plurality of U-phase connectors that is electrically conductive and is connected between one end sides of the plurality of U-phase conductive tubes protruding from the stator core or between other end sides of the plurality of U-phase conductive tubes;
a U-phase line that is electrically conductive and is connected to one end side of one of the plurality of U-phase conductive tubes to which the plurality of U-phase connectors is not connected at one end side;
a plurality of V-phase conductive tubes that is electrically conductive so that the heat medium can flow through the plurality of V-phase conductive tubes, the plurality of V-phase conductive tubes being arranged in a plurality of spaces between the plurality of teeth and being longer than the thickness of the stator core and protruding on both sides of the stator core;
a plurality of V-phase connectors that is electrically conductive and is connected between one end sides of the plurality of V-phase conductive tubes protruding from the stator core or between other end sides of the plurality of V-phase conductive tubes;
a V-phase line that is electrically conductive and is connected to one end side of one of the plurality of V-phase conductive tubes to which the plurality of V-phase connectors is not connected at one end side;
a plurality of W-phase conductive tubes that is electrically conductive so that the heat medium can flow through the plurality of W-phase conductive tubes, the plurality of W-phase conductive tubes being arranged in the plurality of spaces between the plurality of teeth and being longer than the thickness of the stator core and protruding on both sides of the stator core;
a plurality of W-phase connectors that is electrically conductive and is connected between one end sides of the plurality of W-phase conductive tubes protruding from the stator core or between other end sides of the plurality of W-phase conductive tubes;
a W-phase line that is electrically conductive and is connected to one end side of one of the plurality of W-phase conductive tubes to which the plurality of W-phase connectors is not connected at one end side;
a neutral line that is electrically conductive and is connected to one end side of the plurality of U-phase conductive tubes to which neither the plurality of U-phase connectors nor the plurality of U-phase lines is connected at one end side, one end side of the plurality of V-phase conductive tubes to which neither the plurality of V-phase connectors nor the plurality of V-phase lines is connected at one end side, and one end side of the plurality of W-phase conductive tubes to which neither the plurality of W-phase connectors nor the plurality of W-phase lines is connected at one end side;
one heat medium flow member arranged on one side of the stator core so that the heat medium can flow inside the one heat medium flow member while preventing the heat medium flowing through the plurality of U-phase conductive tubes, the plurality of V-phase conductive tubes and the plurality of W-phase conductive tubes from leaking to the outside from locations contacting the stator core; and
the other heat medium flow member arranged on the other side of the stator core so that the heat medium can flow inside the other heat medium flow member while preventing the heat medium flowing through the plurality of U-phase conductive tubes, the plurality of V-phase conductive tubes and the plurality of W-phase conductive tubes from leaking to the outside from the locations contacting the stator core.

3. An electrical energy-mechanical energy converter comprising:
a stator core having a plurality of teeth protruded from a base portion;
a plurality of U-phase conductive tubes that is electrically conductive so that a heat medium can flow through the plurality of U-phase conductive tubes, the plurality of U-phase conductive tubes being arranged in a space between the plurality of teeth and being longer than a thickness of the stator core and protruding on both sides of the stator core;
a plurality of U-phase connectors that is electrically conductive and is connected between one end sides of the plurality of U-phase conductive tubes protruding from the stator core or between other end sides of the plurality of U-phase conductive tubes;
a U-phase line that is electrically conductive and is connected to one end side of one of the plurality of U-phase conductive tubes to which the plurality of U-phase connector is connected at both one end side and the other end side;
a plurality of V-phase conductive tubes that is electrically conductive so that the heat medium can flow through the plurality of V-phase conductive tubes, the plurality of V-phase conductive tubes being arranged in a plurality of spaces between the plurality of teeth and being longer than the thickness of the stator core and protruding on both sides of the stator core;
a plurality of V-phase connectors that is electrically conductive and is connected between one end sides of the plurality of V-phase conductive tubes protruding from the stator core or between other end sides of the plurality of V-phase conductive tubes;
a V-phase line that is electrically conductive and is connected to one end side of one of the plurality of V-phase conductive tubes to which the plurality of V-phase connectors is connected at both one end side and the other end side;
a plurality of W-phase conductive tubes that is electrically conductive so that the heat medium can flow through the plurality of W-phase conductive tubes, the plurality of W-phase conductive tubes being arranged in the plurality of spaces between the plurality of teeth and being longer than the thickness of the stator core and protruding on both sides of the stator core;
a plurality of W-phase connectors that is electrically conductive and is connected between one end sides of the plurality of W-phase conductive tubes protruding from the stator core or between other end sides of the plurality of W-phase conductive tubes;
a W-phase line that is electrically conductive and is connected to one end side of one of the plurality of W-phase conductive tubes to which the plurality of W-phase connectors is connected at both one end side and the other end side;
a neutral line that is electrically conductive and is connected to one end side of the plurality of U-phase conductive tubes to which the plurality of U-phase connectors is connected only at the other end side, one end side of the plurality of V-phase conductive tubes to which the plurality of V-phase connectors is connected only at the other end side and one end side of the plurality of W-phase conductive tubes to which the W-phase connector is connected only at the other end side;
one heat medium flow member arranged on one side of the stator core so that the heat medium can flow inside the one heat medium flow member while preventing the heat medium flowing through the plurality of U-phase conductive tubes, the plurality of V-phase conductive tubes and the plurality of W-phase conductive tubes from leaking to the outside from locations contacting the stator core; and
the other heat medium flow member arranged on the other side of the stator core so that the heat medium can flow inside the other heat medium flow member while preventing the heat medium flowing through the plurality of U-phase conductive tubes, the plurality of V-phase conductive tubes and the plurality of W-phase conductive tubes from leaking to the outside from the locations contacting the stator core.

4. The electrical energy-mechanical energy converter according to claim 1, wherein
the one heat medium flow member includes a plurality of conductive tube insertion one-side holes formed in a surface facing the stator core, and
one end of any one of the first U-phase conductive tube, the second U-phase conductive tube, the first V-phase conductive tube, the second V-phase conductive tube, the first W-phase conductive tube and the second W-phase conductive tube is inserted into each of the plurality of conductive tube insertion one-side holes.

5. The electrical energy-mechanical energy converter according to claim 1, wherein
the other heat medium flow member includes a plurality of conductive tube insertion other-side holes formed in a surface facing the stator core, and
the other end of any one of the first U-phase conductive tube, the second U-phase conductive tube, the first V-phase conductive tube, the second V-phase conductive tube, the first W-phase conductive tube and the second W-phase conductive tube is inserted into each of the plurality of conductive tube insertion other-side holes.

6. The electrical energy-mechanical energy converter according to claim 2, wherein
the one heat medium flow member includes a plurality of conductive tube insertion one-side holes formed in a surface facing the stator core, and
one end of any one of the plurality of U-phase conductive tubes, the plurality of V-phase conductive tubes and the plurality of W-phase conductive tubes is inserted into each of the plurality of conductive tube insertion one-side holes.

7. The electrical energy-mechanical energy converter according to claim 2, wherein
the other heat medium flow member includes a plurality of conductive tube insertion other-side holes formed in a surface facing the stator core, and
the other end of any one of the plurality of U-phase conductive tubes, the plurality of V-phase conductive tubes and the plurality of W-phase conductive tubes is inserted into each of the plurality of conductive tube insertion other-side holes.

8. The electrical energy-mechanical energy converter according to claim 1, wherein
one flow tube through which the heat medium flows is connected to the one heat medium flow member, and
the other flow tube through which the heat medium flows is connected to the other heat medium flow member.

9. The electrical energy-mechanical energy converter according to claim 1, wherein
the one heat medium flow member has an inside divided into two by a pair of partition portions,
one flow tube through which the heat medium flows is connected to one compartment,
the other flow tube through which the heat medium flows is connected to the other compartment,
a part of a plurality of conductive tube insertion one-side holes is formed on the one compartment, and
the other of the plurality of conductive tube insertion one-side holes are formed on the other compartment.

10. The electrical energy-mechanical energy converter according to claim 1, wherein
the one heat medium flow member includes:
a first main body portion;
a second main body portion that is liquid-tightly fixed to the first main body portion so that the heat medium flowing through a flow path of the first main body portion does not leak to the outside; and
a lid portion that is liquid-tightly fixed to the second main body portion so that the heat medium flowing through the flow path of the second main body portion does not leak to the outside,
one flow tube through which the heat medium flows is connected to one compartment on the first main body portion side,
the other flow tube through which the heat medium flows is connected to the other compartment on the second main body portion side,
a part of a plurality of conductive tube insertion one-side holes is formed on the one compartment, and
the other of the plurality of conductive tube insertion one-side holes are formed on the other compartment.
